(19) United States
(12) Patent Application Publication
(10) Pub. No.: US 2014/0003489 A1
(43) Pub. Date: Jan. 2, 2014

(54) METHOD AND APPARATUS FOR VIDEO CODING

(71) Applicant: Nokia Corporation, Espoo (FI)

(72) Inventor: Miksa HANNUKSELA, Tampere (FI)

(21) Appl. No.: 13/928,713

(22) Filed: Jun. 27, 2013

Related U.S. Application Data
(60) Provisional application No. 61/667,085, filed on Jul. 2, 2012.

(51) Int. Cl. H04N 7/26

(52) U.S. Cl. CPC H04N 19/00321
USPC 375/240.02

(57) ABSTRACT

A method, apparatus and computer program product are provided that permit values of certain parameters or syntax elements, such as the HRD parameters and/or a level indicator, to be taken from a syntax structure, such as a sequence parameter set. In this regard, values of certain parameters or syntax elements, such as the HRD parameters and/or a level indicator, may be taken from a syntax structure of a certain other layer, such as the highest layer, present in an access unit, coded video sequence and/or bitstream even if the other layer, such as the highest layer, were not decoded. The syntax element values from the other layer, such as the highest layer, may be semantically valid and may be used for conformance checking, while the values of the respective syntax elements from other respective syntax structures, such as sequence parameter sets, may be active or valid otherwise.

### TECHNICAL FIELD

The present application relates generally to an apparatus, a method and a computer program product for video coding and decoding.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Typical audio and video coding standards specify “profiles” and “levels.” A “profile” may be defined as a subset of algorithmic features of the standard and a “level” may be defined as a set of limits to the coding parameters that impose a set of constraints in decoder resource consumption. Indicated profile and level can be used to signal properties of a media stream and to signal the capability of a media decoder.

In many video coding standards the syntax structures may be arranged in different layers, where a layer may be defined as one of a set of syntactical structures in a non-branching hierarchical relationship. Generally, higher layers may contain lower layers. The coding layers may consist for example of the coded video sequence, picture, slice, and treeblock layers. Some video coding standards introduce a concept of a parameter set. An instance of a parameter set may include all picture, group of pictures (GOP), and sequence level data such as picture size, display window, optional coding modes employed, macroblock allocation map, and others. Each parameter set instance may include a unique identifier. Each slice header may include a reference to a parameter set identifier, and the parameter values of the referred parameter set may be used when decoding the slice. Parameter sets may be used to decouple the transmission and decoding order of infrequently changing picture, GOP, and sequence level data from sequence, GOP, and picture boundaries. Parameter sets can be transmitted out-of-band using a reliable transmission protocol as long as they are decoded before they are referred. If parameter sets are transmitted in-band, they can be repeated multiple times to improve error resilience compared to conventional video coding schemes. The parameter sets may be transmitted at a session set-up time. However, in some systems, mainly broadcast ones, reliable out-of-band transmission of parameter sets may not be feasible, but rather parameter sets are conveyed in-band in Parameter Set NAL units.

### SUMMARY

A method, apparatus and computer program product are provided according to example embodiments of the present invention that permit values of certain parameters or syntax elements, such as the HRD parameters and/or a level indicator, to be taken from a syntax structure, such as a sequence parameter set. In this regard, values of certain parameters or syntax elements, such as the HRD parameters and/or a level indicator, may be taken from a syntax structure of a certain other layer, such as the highest layer, present in an access unit, coded video sequence and/or bitstream even if the other layer, such as the highest layer, were not decoded. The syntax element values from the other layer, such as the highest layer, may be semantically valid and may be used for conformance checking, while the values of the respective syntax elements from other respective syntax structures, such as sequence parameter sets, may be active or valid otherwise.

In one embodiment, a method is provided that includes producing, with a processor, two or more scalability layers of a scalable data stream. Each of the two or more scalability layers may have a different coding property, is associated with a scalability layer identifier and is characterized by a first set of syntax elements that includes at least a profile and a second set of syntax elements that includes at least one of a level or hypothetical reference decoder (HRD) parameters. The method of this embodiment also inserts a first scalability layer identifier value in a first elementary unit including data from a first of two or more scalability layers. The method may also cause the first of the two or more scalability layers to be signaled with the first and second set of syntax elements in a first parameter set elementary unit such that the first parameter set elementary unit is readable by a decoder to determine the values of the first and second set of syntax elements without decoding a scalability layer of the scalable data stream. The method of this embodiment also inserts a first scalability layer identifier value in the first parameter set elementary unit and inserts a second scalability layer identifier value in the second elementary unit including data from a first of two or more scalability layers. The method of this embodiment also causes the second of the two or more scalability layers to be signaled with the first and second set of syntax elements in a second parameter set elementary units such that the second parameter set elementary unit is readable by a decoder to determine the coding property without decoding the scalability layer of the data stream. The method may also insert the second scalability layer identifier value in the second parameter set elementary unit.

In this embodiment, the values of the first set of syntax elements in the first parameter set elementary unit are valid in an instance in which the first elementary unit is processed and the second elementary unit is ignored or removed. Additionally, the values of the second set of syntax elements in the first parameter set elementary unit may be valid in an instance in which the first elementary unit is processed and the second elementary unit is removed. The values of the first set of syntax elements in the second parameter set elementary unit may be valid in an instance in which the second elementary unit is processed and the values of the second set of syntax elements in the second parameter set elementary unit may be valid in an instance in which the second elementary unit is ignored or processed.

In another embodiment, an apparatus is provided that includes at least one processor and at least one memory including computer program code with the memory and the computer program code configured to, with the at least one processor, cause the apparatus to produce two or more scalability layers of a scalable data stream. Each of the two or more scalability layers may have a different coding property, is associated with a scalability layer identifier and is characterized by a first set of syntax elements that includes at least a profile and a second set of syntax elements that includes at least one of a level or hypothetical reference decoder (HRD) parameters. The memory and the computer program code are also configured to, with the at least one processor, cause the apparatus to insert a first scalability layer identifier value in a first elementary unit including data from a first of two or more scalability layers. The memory and the computer program code may also be configured to, with the at least one processor, cause the apparatus to also cause the first of the two or more scalability layers to be signaled with the first and second set of syntax elements in a first parameter set elementary unit such that the first parameter set elementary unit is readable by a decoder to determine the values of the first and second set of syntax elements without decoding a scalability layer of the scalable data stream. The memory and the computer program code may be configured to, with the at least one processor, cause the apparatus to insert a first scalability layer identifier value in the first parameter set elementary unit and insert a second scalability layer identifier value in the second elementary unit including data from a first of two or more scalability layers. The memory and the computer program code are also configured to, with the at least one processor, cause the apparatus to cause the second of the two or more scalability layers to be signaled with the first and second set of syntax elements in a second parameter set elementary units such that the second parameter set elementary unit is readable by a decoder to determine the coding property without decoding the scalability layer of the data stream. The memory and the computer program code may also be configured to, with the at least one processor, cause the apparatus to insert the second scalability layer identifier value in the second parameter set elementary unit.

In this embodiment, the values of the first set of syntax elements in the first parameter set elementary unit are valid in an instance in which the first elementary unit is processed and the second elementary unit is ignored or removed. Additionally, the values of the second set of syntax elements in the first parameter set elementary unit may be valid in an instance in which the first elementary unit is processed and the second elementary unit is removed. The values of the first set of syntax elements in the second parameter set elementary unit may be valid in an instance in which the second elementary unit is processed and the values of the second set of syntax elements in the second parameter set elementary unit may be valid in an instance in which the second elementary unit is ignored or processed.

In a further embodiment, a computer program product is provided that includes at least one non-transitory computer-readable storage medium having computer-executable program code portions stored therein with the computer-executable program code portions including program code instructions for producing two or more scalability layers of a scalable data stream. Each of the two or more scalability layers may have a different coding property, is associated with a scalability layer identifier and is characterized by a first set of syntax elements that includes at least a profile and a second set of syntax elements that includes at least one of a level or hypothetical reference decoder (HRD) parameters. The computer-executable program code portions of one embodiment may also include program code instructions for inserting a first scalability layer identifier value in a first elementary unit including data from a first of two or more scalability layers. The computer-executable program code portions of one embodiment may also include program code instructions for causing the first of the two or more scalability layers to be signaled with the first and second set of syntax elements in a first parameter set elementary unit such that the first parameter set elementary unit is readable by a decoder to determine the values of the first and second set of syntax elements without decoding a scalability layer of the scalable data stream. The computer-executable program code portions of one embodiment may also include program code instructions for inserting a first scalability layer identifier value in the first parameter set elementary unit and inserting a second scalability layer identifier value in the second elementary unit including data from a first of two or more scalability layers. The computer-executable program code portions of one embodiment may also include program code instructions for the second of the two or more scalability layers to be signaled with the first and second set of syntax elements in a second parameter set elementary units such that the second parameter set elementary unit is readable by a decoder to determine the coding property without decoding the scalability layer of the data stream. The computer-executable program code portions of one embodiment may also include program code instructions for inserting the second scalability layer identifier value in the second parameter set elementary unit.

In this embodiment, the values of the first set of syntax elements in the first parameter set elementary unit are valid in an instance in which the first elementary unit is processed and the second elementary unit is ignored or removed. Additionally, the values of the second set of syntax elements in the first parameter set elementary unit may be valid in an instance in which the first elementary unit is processed and the second elementary unit is removed. The values of the first set of syntax elements in the second parameter set elementary unit may be valid in an instance in which the second elementary unit is processed and the values of the second set of syntax elements in the second parameter set elementary unit may be valid in an instance in which the second elementary unit is ignored or processed.

In yet another embodiment, an apparatus is provided that includes means for producing two or more scalability layers of a scalable data stream. Each of the two or more scalability layers may have a different coding property, is associated with a scalability layer identifier and is characterized by a first set of syntax elements that includes at least a profile and a second set of syntax elements that includes at least one of a level or hypothetical reference decoder (HRD) parameters. The apparatus of this embodiment also includes means for inserting a first scalability layer identifier value in a first elementary unit including data from a first of two or more scalability layers. The apparatus may also include means for causing the first of the two or more scalability layers to be signaled with the first and second set of syntax elements in a first parameter set elementary unit such that the first parameter set elementary unit is readable by a decoder to determine the values of the first and second set of syntax elements without decoding a scalability layer of the scalable data stream. The apparatus of this embodiment also includes means for inserting a first scalability layer identifier value in the first parameter set elementary unit and means for inserting a second scalability layer identifier value in the second elementary unit including data from a first of two or more scalability layers. The apparatus of this embodiment also includes means for causing the second of the two or more scalability layers to be signaled with the first and second set of syntax elements in a second parameter set elementary units such that the second parameter set elementary unit is readable by a decoder to determine the coding property without decoding the scalability layer of the data stream. The apparatus may also include means for inserting the second scalability layer identifier value in the second parameter set elementary unit.

In this embodiment, the values of the first set of syntax elements in the first parameter set elementary unit are valid in an instance in which the first elementary unit is processed and the second elementary unit is ignored or removed. Additionally, the values of the second set of syntax elements in the first parameter set elementary unit may be valid in an instance in which the first elementary unit is processed and the second elementary unit is removed. The values of the first set of syntax elements in the second parameter set elementary unit may be valid in an instance in which the second elementary unit is processed and the values of the second set of syntax elements in the second parameter set elementary unit may be valid in an instance in which the second elementary unit is ignored or processed.

In one embodiment, a method is provided that includes receiving a first scalable data stream including scalability layers having different coding properties. Each of the two or more scalability layers is associated with a scalability layer identifier and is characterized by a first of syntax elements comprising at least a profile and a second set of syntax elements including at least one of a level or Hypothetical Reference Decoder (HRD) parameters. A first scalability layer identifier value may reside in a first elementary unit including data from the first of two or more scalability layers. A first and second set of syntax elements may be signaled in a first parameter set elementary unit for the first of the two or more scalability layers such that a first parameter set is readable by a decoder to determine the values of the first and second set of syntax elements without decoding a scalability layer of the scalable data stream. The first scalability layer identifier value may reside in the first parameter set elementary unit. A second scalability layer identifier value may reside in a second elementary unit including data from a second of two or more scalability layers. The first and second set of syntax elements may be signaled in a second parameter set elementary unit for the second of the two or more scalability layers such that a second parameter set is readable by the decoder to determine the coding property without decoding the scalability layer of the scalable data stream. The second scalability layer identifier value may reside in the second parameter set elementary unit. The method of this embodiment may also include removing, with a processor, from the first scalable data stream the second elementary unit and the second parameter set elementary unit on the basis of the second elementary unit and the second parameter set elementary unit including the second scalability layer identifier value.

In another embodiment, an apparatus is provided that includes at least one processor and at least one memory including computer program code with the memory and the computer program code configured to, with the at least one processor, cause the apparatus to receive a first scalable data stream including scalability layers having different coding properties. Each of the two or more scalability layers is associated with a scalability layer identifier and is characterized by a first of syntax elements comprising at least a profile and a second set of syntax elements including at least one of a level or Hypothetical Reference Decoder (HRD) parameters. A first scalability layer identifier value may reside in a first elementary unit including data from the first of two or more scalability layers. A first and second set of syntax elements may be signaled in a first parameter set elementary unit for the first of the two or more scalability layers such that a first parameter set is readable by a decoder to determine the values of the first and second set of syntax elements without decoding a scalability layer of the scalable data stream. The first scalability layer identifier value may reside in the first parameter set elementary unit. A second scalability layer identifier value may reside in a second elementary unit including data from a second of two or more scalability layers. The first and second set of syntax elements may be signaled in a second parameter set elementary unit for the second of the two or more scalability layers such that a second parameter set is readable by the decoder to determine the coding property without decoding the scalability layer of the scalable data stream. The second scalability layer identifier value may reside in the second parameter set elementary unit. The apparatus of this embodiment may also include the memory and the computer program code configured to, with the at least one processor, cause the apparatus to remove from the first scalable data stream the second elementary unit and the second parameter set elementary unit on the basis of the second elementary unit and the second parameter set elementary unit including the second scalability layer identifier value.

In a further embodiment, a computer program product is provided that includes at least one non-transitory computer-readable storage medium having computer-executable program code portions stored therein with the computer-executable program code portions including program code instructions for receiving a first scalable data stream including scalability layers having different coding properties. Each of the two or more scalability layers is associated with a scalability layer identifier and is characterized by a first of syntax elements comprising at least a profile and a second set of syntax elements including at least one of a level or Hypothetical Reference Decoder (HRD) parameters. A first scalability layer identifier value may reside in a first elementary unit including data from the first of two or more scalability layers. A first and second set of syntax elements may be signaled in a first parameter set elementary unit for the first of the two or more scalability layers such that a first parameter set is readable by a decoder to determine the values of the first and second set of syntax elements without decoding a scalability layer of the scalable data stream. The first scalability layer identifier value may reside in the first parameter set elementary unit. A second scalability layer identifier value may reside in a second elementary unit including data from a second of two or more scalability layers. The first and second set of syntax elements may be signaled in a second parameter set elementary unit for the second of the two or more scalability layers such that a second parameter set is readable by the decoder to determine the coding property without decoding the scalability layer of the scalable data stream. The second scalability layer identifier value may reside in the second parameter set elementary unit. The computer-executable program code portions of this embodiment may also include program code instructions for removing from the first scalable data stream the second elementary unit and the second parameter set elementary unit on the basis of the second elementary unit and the second parameter set elementary unit including the second scalability layer identifier value.

In yet another embodiment, an apparatus is provided that includes means for receiving a first scalable data stream including scalability layers having different coding properties. Each of the two or more scalability layers is associated with a scalability layer identifier and is characterized by a first of syntax elements comprising at least a profile and a second set of syntax elements including at least one of a level or Hypothetical Reference Decoder (HRD) parameters. A first scalability layer identifier value may reside in a first elementary unit including data from the first of two or more scalability layers. A first and second set of syntax elements may be signaled in a first parameter set elementary unit for the first of the two or more scalability layers such that a first parameter set is readable by a decoder to determine the values of the first and second set of syntax elements without decoding a scalability layer of the scalable data stream. The first scalability layer identifier value may reside in the first parameter set elementary unit. A second scalability layer identifier value may reside in a second elementary unit including data from a second of two or more scalability layers. The first and second set of syntax elements may be signaled in a second parameter set elementary unit for the second of the two or more scalability layers such that a second parameter set is readable by the decoder to determine the coding property without decoding the scalability layer of the scalable data stream. The second scalability layer identifier value may reside in the second parameter set elementary unit. The apparatus of this embodiment may also include means for removing from the first scalable data stream the second elementary unit and the second parameter set elementary unit on the basis of the second elementary unit and the second parameter set elementary unit including the second scalability layer identifier value.

In one embodiment, a method is provided that includes receiving a first scalable data stream including scalability layers having different coding properties. Each of the two or more scalability layers is associated with a scalability layer identifier and is characterized by a coding property. A first scalability layer identifier value may reside in a first elementary unit including data from a first of two or more scalability layers. The first of the two or more scalability layers with decoding properties are signals in a first parameter set elementary unit such that the coding property is readable by a decoder to determine the coding property without decoding a scalability layer of a scalable data stream. The first scalability layer identifier value may reside in the first parameter set elementary unit. A second scalability layer identifier value may reside in a second elementary unit including data from a second of two or more scalability layers. The first and second sets of syntax elements may be signaled in a second parameter set elementary unit for the second of the two or more scalability layers such that a first parameter set is readable by a decoder to determine the values of first and second sets of syntax elements without decoding the scalability layer of the scalable data stream. The second scalability layer identifier value may reside in the second parameter set elementary unit. The method of this embodiment may also receive a set of scalability layer identifier values indicating scalability layers to be decoded and may remove from the received first scalable data stream, with the processor, the second elementary unit and the second parameter set elementary unit on the basis of the second elementary unit and the second parameter set elementary unit including the second scalability layer identifier value not being among the set of scalability layer identifier values.

In another embodiment, an apparatus is provided that includes at least one processor and at least one memory including computer program code with the memory and computer program code configured to, with the at least one processor, cause the apparatus to receive a first scalable data stream including scalability layers having different coding properties. Each of the two or more scalability layers is associated with a scalability layer identifier and is characterized by a coding property. A first scalability layer identifier value may reside in a first elementary unit including data from a first of two or more scalability layers. The first of the two or more scalability layers with decoding properties are signals in a first parameter set elementary unit such that the coding property is readable by a decoder to determine the coding property without decoding a scalability layer of a scalable data stream. The first scalability layer identifier value may reside in the first parameter set elementary unit. A second scalability layer identifier value may reside in a second elementary unit including data from a second of two or more scalability layers. The first and second sets of syntax elements may be signaled in a second parameter set elementary unit for the second of the two or more scalability layers such that a first parameter set is readable by a decoder to determine the values of first and second sets of syntax elements without decoding the scalability layer of the scalable data stream. The second scalability layer identifier value may reside in the second parameter set elementary unit. The memory and computer program code may also be configured to, with the at least one processor, cause the apparatus to receive a set of scalability layer identifier values indicating scalability layers to be decoded and to remove from the received first scalable data stream the second elementary unit and the second parameter set elementary unit on the basis of the second elementary unit and the second parameter set elementary unit including the second scalability layer identifier value not being among the set of scalability layer identifier values.

In a further embodiment, a computer program product is provided that includes at least one non-transitory computer-readable storage medium having computer-executable program code portions stored therein with the computer-executable program code portions including program code instructions for receiving a first scalable data stream including scalability layers having different coding properties. Each of the two or more scalability layers is associated with a scalability layer identifier and is characterized by a coding property. A first scalability layer identifier value may reside in a first elementary unit including data from a first of two or more scalability layers. The first of the two or more scalability layers with decoding properties are signals in a first parameter set elementary unit such that the coding property is readable by a decoder to determine the coding property without decoding a scalability layer of a scalable data stream. The first scalability layer identifier value may reside in the first parameter set elementary unit. A second scalability layer identifier value may reside in a second elementary unit including data from a second of two or more scalability layers. The first and second sets of syntax elements may be signaled in a second parameter set elementary unit for the second of the two or more scalability layers such that a first parameter set is readable by a decoder to determine the values of first and second sets of syntax elements without decoding the scalability layer of the scalable data stream. The second scalability layer identifier value may reside in the second parameter set elementary unit. The computer-executable program code portions may also include program code instructions for receiving a set of scalability layer identifier values indicating scalability layers to be decoded and program code instructions for removing from the received first scalable data stream the second elementary unit and the second parameter set elementary unit on the basis of the second elementary unit and the second parameter set elementary unit including the second scalability layer identifier value not being among the set of scalability layer identifier values.

In yet another embodiment, an apparatus is provided that includes means for receiving a first scalable data stream including scalability layers having different coding properties. Each of the two or more scalability layers is associated with a scalability layer identifier and is characterized by a coding property. A first scalability layer identifier value may reside in a first elementary unit including data from a first of two or more scalability layers. The first of the two or more scalability layers with decoding properties are signals in a first parameter set elementary unit such that the coding property is readable by a decoder to determine the coding property without decoding a scalability layer of a scalable data stream. The first scalability layer identifier value may reside in the first parameter set elementary unit. A second scalability layer identifier value may reside in a second elementary unit including data from a second of two or more scalability layers. The first and second sets of syntax elements may be signaled in a second parameter set elementary unit for the second of the two or more scalability layers such that a first parameter set is readable by a decoder to determine the values of first and second sets of syntax elements without decoding the scalability layer of the scalable data stream. The second scalability layer identifier value may reside in the second parameter set elementary unit. The apparatus may also include means for receiving a set of scalability layer identifier values indicating scalability layers to be decoded and means for removing from the received first scalable data stream the second elementary unit and the second parameter set elementary unit on the basis of the second elementary unit and the second parameter set elementary unit including the second scalability layer identifier value not being among the set of scalability layer identifier values.

### BRIEF DESCRIPTION OF THE DRAWINGS

For a more complete understanding of example embodiments of the present invention, reference is now made to the following descriptions taken in connection with the accompanying drawings in which:

FIG. 1 shows schematically an electronic device employing some embodiments of the invention;

FIG. 2 shows schematically a user equipment suitable for employing some embodiments of the invention;

FIG. 3 further shows schematically electronic devices employing embodiments of the invention connected using wireless and wired network connections;

FIG. 4a shows schematically an embodiment of the invention as incorporated within an encoder;

FIG. 4b shows schematically an embodiment of an inter predictor according to some embodiments of the invention;

FIG. 5 shows a simplified model of a DIBR-based 3DV system;

FIG. 6 shows a simplified 2D model of a stereoscopic camera setup;

FIG. 7 shows an example of definition and coding order of access units;

FIG. 8 shows a high level flow chart of an embodiment of an encoder capable of encoding texture views and depth views;

FIG. 9 shows a high level flow chart of an embodiment of a decoder capable of decoding texture views and depth views; and

FIGS. 10-12 are flow charts illustrating operations performed in accordance with an example embodiment of the present invention.

### DETAILED DESCRIPTION OF SOME EXAMPLE EMBODIMENTS

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory, physical storage medium (e.g., volatile or non-volatile memory device), can be differentiated from a “computer-readable transmission medium,” which refers to an electromagnetic signal.

In the following, several embodiments of the invention will be described in the context of one video coding arrangement. It is to be noted, however, that the invention is not limited to this particular arrangement. In fact, the different embodiments have applications widely in any environment where improvement of reference picture handling is required. For example, the invention may be applicable to video coding systems like streaming systems, DVD players, digital television receivers, personal video recorders, systems and computer programs on personal computers, handheld computers and communication devices, as well as network elements such as transcoders and cloud computing arrangements where video data is handled.

The H.264/AVC standard was developed by the Joint Video Team (JVT) of the Video Coding Experts Group (VCEG) of the Telecommunications Standardization Sector of International Telecommunication Union (ITU-T) and the Moving Picture Experts Group (MPEG) of International Organisation for Standardization (ISO)/International Electrotechnical Commission (IEC). The H.264/AVC standard is published by both parent standardization organizations, and it is referred to as ITU-T Recommendation H.264 and ISO/IEC International Standard 14496-10, also known as MPEG-4 Part 10 Advanced Video Coding (AVC). There have been multiple versions of the H.264/AVC standard, each integrating new extensions or features to the specification. These extensions include Scalable Video Coding (SVC) and Multiview Video Coding (MVC).

There is a currently ongoing standardization project of High Efficiency Video Coding (HEVC) by the Joint Collaborative Team-Video Coding (JCT-VC) of VCEG and MPEG.

Some key definitions, bitstream and coding structures, and concepts of H.264/AVC and HEVC are described in this section as an example of a video encoder, decoder, encoding method, decoding method, and a bitstream structure, wherein the embodiments may be implemented. Some of the key definitions, bitstream and coding structures, and concepts of H.264/AVC are the same as in a draft HEVC standard—hence, they are described below jointly. The aspects of the invention are not limited to H.264/AVC or HEVC, but rather the description is given for one possible basis on top of which the invention may be partly or fully realized.

Similarly to many earlier video coding standards, the bitstream syntax and semantics as well as the decoding process for error-free bitstreams are specified in H.264/AVC and HEVC. The encoding process is not specified, but encoders must generate conforming bitstreams. Bitstream and decoder conformance can be verified with the Hypothetical Reference Decoder (HRD). The standards contain coding tools that help in coping with transmission errors and losses, but the use of the tools in encoding is optional and no decoding process has been specified for erroneous bitstreams.

Common notation for arithmetic operators, logical operators, relational operators, bit-wise operators, assignment operators, and range notation e.g. as specified in H.264/AVC or a draft HEVC may be used. Furthermore, common mathematical functions e.g. as specified in H.264/AVC or a draft HEVC may be used and a common order of precedence and execution order (from left to right or from right to left) of operators e.g. as specified in H.264/AVC or a draft HEVC may be used.

In the description of existing standards as well as in the description of example embodiments, a syntax element may be defined as an element of data represented in the bitstream. A syntax structure may be defined as zero or more syntax elements present together in the bitstream in a specified order. The following descriptors may be used to specify the parsing process of each syntax element.
b(8): byte having any pattern of bit string (8 bits).
se(v): signed integer Exp-Golomb-coded syntax element with the left bit first.
u(n): unsigned integer using n bits. When n is “v” in the syntax table, the number of bits varies in a manner dependent on the value of other syntax elements. The parsing process for this descriptor is specified by n next bits from the bitstream interpreted as a binary representation of an unsigned integer with the most significant bit written first.
ue(v): unsigned integer Exp-Golomb-coded syntax element with the left bit first.

An Exp-Golomb bit string may be converted to a code number (codeNum) for example using the following table:

| Bit string | codeNum |
|---|---|
| 1 | 0 |
| 0 1 0 | 1 |
| 0 1 1 | 2 |
| 0 0 1 0 0 | 3 |
| 0 0 1 0 1 | 4 |
| 0 0 1 1 0 | 5 |
| 0 0 1 1 1 | 6 |
| 0 0 0 1 0 0 0 | 7 |
| 0 0 0 1 0 0 1 | 8 |
| 0 0 0 1 0 1 0 | 9 |
| . . . | . . . |

A code number corresponding to an Exp-Golomb bit string may be converted to se(v) for example using the following table:

| codeNum | syntax element value |
|---|---|
| 0 | 0 |
| 1 | 1 |
| 2 | −1 |
| 3 | 2 |
| 4 | −2 |
| 5 | 3 |
| 6 | −3 |
| . . . | . . . |

Syntax structures, semantics of syntax elements, and decoding process may be specified as follows. Syntax elements in the bitstream are represented in bold type. Each syntax element is described by its name (all lower case letters with underscore characters), optionally its one or two syntax categories, and one or two descriptors for its method of coded representation. The decoding process behaves according to the value of the syntax element and to the values of previously decoded syntax elements. When a value of a syntax element is used in the syntax tables or the text, it appears in regular (i.e., not bold) type. In some cases the syntax tables may use the values of other variables derived from syntax elements values. Such variables appear in the syntax tables, or text, named by a mixture of lower case and upper case letter and without any underscore characters. Variables starting with an upper case letter are derived for the decoding of the current syntax structure and all depending syntax structures. Variables starting with an upper case letter may be used in the decoding process for later syntax structures without mentioning the originating syntax structure of the variable. Variables starting with a lower case letter are only used within the context in which they are derived. In some cases, “mnemonic” names for syntax element values or variable values are used interchangeably with their numerical values. Sometimes “mnemonic” names are used without any associated numerical values. The association of values and names is specified in the text. The names are constructed from one or more groups of letters separated by an underscore character. Each group starts with an upper case letter and may contain more upper case letters.

A syntax structure may be specified using the following. A group of statements enclosed in curly brackets is a compound statement and is treated functionally as a single statement. A “while” structure specifies a test of whether a condition is true, and if true, specifies evaluation of a statement (or compound statement) repeatedly until the condition is no longer true. A “do . . . while” structure specifies evaluation of a statement once, followed by a test of whether a condition is true, and if true, specifies repeated evaluation of the statement until the condition is no longer true. An “if . . . else” structure specifies a test of whether a condition is true, and if the condition is true, specifies evaluation of a primary statement, otherwise, specifies evaluation of an alternative statement. The “else” part of the structure and the associated alternative statement is omitted if no alternative statement evaluation is needed. A “for” structure specifies evaluation of an initial statement, followed by a test of a condition, and if the condition is true, specifies repeated evaluation of a primary statement followed by a subsequent statement until the condition is no longer true.

A profile may be defined as a subset of the entire bitstream syntax that is specified by a decoding/coding standard or specification. Within the bounds imposed by the syntax of a given profile it is still possible to require a very large variation in the performance of encoders and decoders depending upon the values taken by syntax elements in the bitstream such as the specified size of the decoded pictures. In many applications, it might be neither practical nor economic to implement a decoder capable of dealing with all hypothetical uses of the syntax within a particular profile. In order to deal with this issues, levels may be used. A level may be defined as a specified set of constraints imposed on values of the syntax elements in the bitstream and variables specified in a decoding/coding standard or specification. These constraints may be simple limits on values. Alternatively or in addition, they may take the form of constraints on arithmetic combinations of values (e.g., picture width multiplied by picture height multiplied by number of pictures decoded per second). Other means for specifying constraints for levels may also be used. Some of the constraints specified in a level may for example relate to the maximum picture size, maximum bitrate and maximum data rate in terms of coding units, such as macroblocks, per a time period, such as a second. The same set of levels may be defined for all profiles. It may be preferable for example to increase interoperability of terminals implementing different profiles that most or all aspects of the definition of each level may be common across different profiles.

The elementary unit for the input to an H.264/AVC or HEVC encoder and the output of an H.264/AVC or HEVC decoder, respectively, is a picture. In H.264/AVC and HEVC, a picture may either be a frame or a field. A frame comprises a matrix of luma samples and corresponding chroma samples. A field is a set of alternate sample rows of a frame and may be used as encoder input, when the source signal is interlaced. Chroma pictures may be subsampled when compared to luma pictures. For example, in the 4:2:0 sampling pattern the spatial resolution of chroma pictures is half of that of the luma picture along both coordinate axes.

In H.264/AVC, a macroblock is a 16×16 block of luma samples and the corresponding blocks of chroma samples. For example, in the 4:2:0 sampling pattern, a macroblock contains one 8×8 block of chroma samples per each chroma component. In H.264/AVC, a picture is partitioned to one or more slice groups, and a slice group contains one or more slices. In H.264/AVC, a slice consists of an integer number of macroblocks ordered consecutively in the raster scan within a particular slice group.

In a draft HEVC standard, video pictures are divided into coding units (CU) covering the area of the picture. A CU consists of one or more prediction units (PU) defining the prediction process for the samples within the CU and one or more transform units (TU) defining the prediction error coding process for the samples in the CU. Typically, a CU consists of a square block of samples with a size selectable from a predefined set of possible CU sizes. A CU with the maximum allowed size is typically named as LCU (largest coding unit) or a coding tree unit (CTU) and the video picture is divided into non-overlapping LCUs. An LCU can be further split into a combination of smaller CUs, e.g. by recursively splitting the LCU and resultant CUs. Each resulting CU typically has at least one PU and at least one TU associated with it. Each PU and TU can further be split into smaller PUs and TUs in order to increase granularity of the prediction and prediction error coding processes, respectively. The PU splitting can be realized by splitting the CU into four equal size square PUs or splitting the CU into two rectangle PUs vertically or horizontally in a symmetric or asymmetric way. The division of the image into CUs, and division of CUs into PUs and TUs is typically signalled in the bitstream allowing the decoder to reproduce the intended structure of these units.

In a draft HEVC standard, a picture can be partitioned in tiles, which are rectangular and contain an integer number of LCUs. In a draft HEVC standard, the partitioning to tiles forms a regular grid, where heights and widths of tiles differ from each other by one LCU at the maximum. In a draft HEVC, a slice consists of an integer number of CUs. The CUs are scanned in the raster scan order of LCUs within tiles or within a picture, if tiles are not in use. Within an LCU, the CUs have a specific scan order.

In a Working Draft (WD) 5 of HEVC, some key definitions and concepts for picture partitioning are defined as follows. A partitioning is defined as the division of a set into subsets such that each element of the set is in exactly one of the subsets.

A basic coding unit in a HEVC WD5 is a treeblock. A treeblock is an N×N block of luma samples and two corresponding blocks of chroma samples of a picture that has three sample arrays, or an N×N block of samples of a monochrome picture or a picture that is coded using three separate colour planes. A treeblock may be partitioned for different coding and decoding processes. A treeblock partition is a block of luma samples and two corresponding blocks of chroma samples resulting from a partitioning of a treeblock for a picture that has three sample arrays or a block of luma samples resulting from a partitioning of a treeblock for a monochrome picture or a picture that is coded using three separate colour planes. Each treeblock is assigned a partition signalling to identify the block sizes for intra or inter prediction and for transform coding. The partitioning is a recursive quadtree partitioning. The root of the quadtree is associated with the treeblock. The quadtree is split until a leaf is reached, which is referred to as the coding node. The coding node is the root node of two trees, the prediction tree and the transform tree. The prediction tree specifies the position and size of prediction blocks. The prediction tree and associated prediction data are referred to as a prediction unit. The transform tree specifies the position and size of transform blocks. The transform tree and associated transform data are referred to as a transform unit. The splitting information for luma and chroma is identical for the prediction tree and may or may not be identical for the transform tree. The coding node and the associated prediction and transform units form together a coding unit.

In a HEVC WD5, pictures are divided into slices and tiles. A slice may be a sequence of treeblocks but (when referring to a so-called fine granular slice) may also have its boundary within a treeblock at a location where a transform unit and prediction unit coincide. Treeblocks within a slice are coded and decoded in a raster scan order. For the primary coded picture, the division of each picture into slices is a partitioning.

In a HEVC WD5, a tile is defined as an integer number of treeblocks co-occurring in one column and one row, ordered consecutively in the raster scan within the tile. For the primary coded picture, the division of each picture into tiles is a partitioning. Tiles are ordered consecutively in the raster scan within the picture. Although a slice contains treeblocks that are consecutive in the raster scan within a tile, these treeblocks are not necessarily consecutive in the raster scan within the picture. Slices and tiles need not contain the same sequence of treeblocks. A tile may comprise treeblocks contained in more than one slice. Similarly, a slice may comprise treeblocks contained in several tiles.

In H.264/AVC and HEVC, in-picture prediction may be disabled across slice boundaries. Thus, slices can be regarded as a way to split a coded picture into independently decodable pieces, and slices are therefore often regarded as elementary units for transmission. In many cases, encoders may indicate in the bitstream which types of in-picture prediction are turned off across slice boundaries, and the decoder operation takes this information into account for example when concluding which prediction sources are available. For example, samples from a neighboring macroblock or CU may be regarded as unavailable for intra prediction, if the neighboring macroblock or CU resides in a different slice.

The elementary unit for the output of an H.264/AVC or HEVC encoder and the input of an H.264/AVC or HEVC decoder, respectively, is a Network Abstraction Layer (NAL) unit. For transport over packet-oriented networks or storage into structured files, NAL units may be encapsulated into packets or similar structures. A bytestream format has been specified in H.264/AVC and HEVC for transmission or storage environments that do not provide framing structures. The bytestream format separates NAL units from each other by attaching a start code in front of each NAL unit. To avoid false detection of NAL unit boundaries, encoders run a byte-oriented start code emulation prevention algorithm, which adds an emulation prevention byte to the NAL unit payload if a start code would have occurred otherwise. In order to enable straightforward gateway operation between packet- and stream-oriented systems, start code emulation prevention may always be performed regardless of whether the bytestream format is in use or not. A NAL unit may be defined as a syntax structure containing an indication of the type of data to follow and bytes containing that data in the form of an RBSP interspersed as necessary with emulation prevention bytes. A raw byte sequence payload (RBSP) may be defined as a syntax structure containing an integer number of bytes that is encapsulated in a NAL unit. An RBSP is either empty or has the form of a string of data bits containing syntax elements followed by an RB SP stop bit and followed by zero or more subsequent bits equal to 0.

NAL units consist of a header and payload. In H.264/AVC and HEVC, the NAL unit header indicates the type of the NAL unit and whether a coded slice contained in the NAL unit is a part of a reference picture or a non-reference picture.

H.264/AVC NAL unit header includes a 2-bit nal_ref_idc syntax element, which when equal to 0 indicates that a coded slice contained in the NAL unit is a part of a non-reference picture and when greater than 0 indicates that a coded slice contained in the NAL unit is a part of a reference picture. A draft HEVC standard includes a 1-bit nal_ref_idc syntax element, also known as nal_ref_flag, which when equal to 0 indicates that a coded slice contained in the NAL unit is a part of a non-reference picture and when equal to 1 indicates that a coded slice contained in the NAL unit is a part of a reference picture. The header for SVC and MVC NAL units may additionally contain various indications related to the scalability and multiview hierarchy.

In a draft HEVC standard, a two-byte NAL unit header is used for all specified NAL unit types. The first byte of the NAL unit header contains one reserved bit, a one-bit indication nal_ref_flag primarily indicating whether the picture carried in this access unit is a reference picture or a non-reference picture, and a six-bit NAL unit type indication. The second byte of the NAL unit header includes a three-bit temporal_id indication for temporal level and a five-bit reserved field (called reserved_one_{—}5 bits) required to have a value equal to 1 in a draft HEVC standard. The temporal_id syntax element may be regarded as a temporal identifier for the NAL unit.

In a draft HEVC standard, the NAL unit syntax is specified as follows:

| nal_unit( NumBytesInNALunit ) { | Descriptor |
|---|---|
| forbidden_zero_bit | f(1) |
| nal_ref_flag | u(1) |
| nal_unit_type | u(6) |
| temporal_id | u(3) |
| reserved_one_5bits | u(5) |
| NumBytesInRBSP = 0 | |
| for( i = 2; i < NumBytesInNALunit; i++ ) { | |
| if( i + 2 < NumBytesInNALunit && next_bits( 24 ) = = | |
| 0x000003 ) { | |
| rbsp_byte[ NumBytesInRBSP++ ] | b(8) |
| rbsp_byte[ NumBytesInRBSP++ ] | b(8) |
| i += 2 | |
| emulation_prevention_three_byte /* equal to 0x03 */ | f(8) |
| } else | |
| rbsp_byte[ NumBytesInRBSP++ ] | b(8) |
| } | |
| } | |

The five-bit reserved field is expected to be used by extensions such as a future scalable and 3D video extension. It is expected that these five bits would carry information on the scalability hierarchy, such as quality_id or similar, dependency_id or similar, any other type of layer identifier, view order index or similar, view identifier, an identifier similar to priority_id of SVC indicating a valid sub-bitstream extraction if all NAL units greater than a specific identifier value are removed from the bitstream. Without loss of generality, in some example embodiments a variable LayerId is derived from the value of reserved_one_{—}5 bits, which may also be referred to as layer_id_plus1, for example as follows: LayerId=reserved_one_{—}5 bits−1. reserved_one_{—}5 bits may represent a layer identifier in scalable extensions of HEVC, for example using the following syntax:

| nal_unit( NumBytesInNALunit ) { | Descriptor |
|---|---|
| forbidden_zero_bit | f(1) |
| nal_ref_flag | u(1) |
| nal_unit_type | u(6) |
| temporal_id | u(3) |
| layer_id_plus1 | u(5) |
| . . . | |

NAL units can be categorized into Video Coding Layer (VCL) NAL units and non-VCL NAL units. VCL NAL units are typically coded slice NAL units. In H.264/AVC, coded slice NAL units contain syntax elements representing one or more coded macroblocks, each of which corresponds to a block of samples in the uncompressed picture. In HEVC, coded slice NAL units contain syntax elements representing one or more CU. In H.264/AVC and HEVC a coded slice NAL unit can be indicated to be a coded slice in an Instantaneous Decoding Refresh (IDR) picture or coded slice in a non-IDR picture. In HEVC, a coded slice NAL unit can be indicated to be a coded slice in a Clean Decoding Refresh (CDR) picture (which may also be referred to as a Clean Random Access picture or a CRA picture).

A non-VCL NAL unit may be for example one of the following types: a sequence parameter set, a picture parameter set, a supplemental enhancement information (SEI) NAL unit, an access unit delimiter, an end of sequence NAL unit, an end of stream NAL unit, or a filler data NAL unit. Parameter sets may be needed for the reconstruction of decoded pictures, whereas many of the other non-VCL NAL units are not necessary for the reconstruction of decoded sample values.

Parameters that remain unchanged through a coded video sequence may be included in a sequence parameter set. In addition to the parameters that may be needed by the decoding process, the sequence parameter set may optionally contain video usability information (VUI), which includes parameters that may be important for buffering, picture output timing, rendering, and resource reservation. There are three NAL units specified in H.264/AVC to carry sequence parameter sets: the sequence parameter set NAL unit containing all the data for H.264/AVC VCL NAL units in the sequence, the sequence parameter set extension NAL unit containing the data for auxiliary coded pictures, and the subset sequence parameter set for MVC and SVC VCL NAL units. In a draft HEVC standard a sequence parameter set RBSP includes parameters that can be referred to by one or more picture parameter set RBSPs or one or more SEI NAL units containing a buffering period SEI message. A picture parameter set contains such parameters that are likely to be unchanged in several coded pictures. A picture parameter set RBSP may include parameters that can be referred to by the coded slice NAL units of one or more coded pictures.

In a draft HEVC, there is also a third type of parameter sets, here referred to as an Adaptation Parameter Set (APS), which includes parameters that are likely to be unchanged in several coded slices but may change for example for each picture or each few pictures. In a draft HEVC, the APS syntax structure includes parameters or syntax elements related to quantization matrices (QM), adaptive sample offset (SAO), adaptive loop filtering (ALF), and deblocking filtering. In a draft HEVC, an APS is a NAL unit and coded without reference or prediction from any other NAL unit. An identifier, referred to as aps_id syntax element, is included in APS NAL unit, and included and used in the slice header to refer to a particular APS. In another draft HEVC standard, an APS syntax structure only contains ALF parameters. In a draft HEVC standard, an adaptation parameter set RBSP includes parameters that can be referred to by the coded slice NAL units of one or more coded pictures when at least one of sample_adaptive_offset_enabled_flag or adaptive_loop_filter_enabled_flag are equal to 1.

A draft HEVC standard also includes a fourth type of a parameter set, called a video parameter set (VPS), which was proposed for example in document JCTVC-H0388 (http://phenix.int-evry.fr/jct/doc_end_user/documents/8_San %20Jose/wg11/JCTVC-H0388-v4.zip). A video parameter set RBSP may include parameters that can be referred to by one or more sequence parameter set RBSPs.

The relationship and hierarchy between VPS, SPS, and PPS may be described as follows. VPS resides one level above SPS in the parameter set hierarchy and in the context of scalability and/or 3DV. VPS may include parameters that are common for all slices across all (scalability or view) layers in the entire coded video sequence. SPS includes the parameters that are common for all slices in a particular (scalability or view) layer in the entire coded video sequence, and may be shared by multiple (scalability or view) layers. PPS includes the parameters that are common for all slices in a particular layer representation (the representation of one scalability or view layer in one access unit) and are likely to be shared by all slices in multiple layer representations.

VPS may provide information about the dependency relationships of the layers in a bitstream, as well as many other information that are applicable to all slices across all (scalability or view) layers in the entire coded video sequence. In a scalable extension of HEVC, VPS may for example include a mapping of the LayerId value derived from the NAL unit header to one or more scalability dimension values, for example correspond to dependency_id, quality_id, view_id, and depth_flag for the layer defined similarly to SVC and MVC. VPS may include profile and level information for one or more layers as well as the profile and/or level for one or more temporal sub-layers (consisting of VCL NAL units at and below certain temporal_id values) of a layer representation.

H.264/AVC and HEVC syntax allows many instances of parameter sets, and each instance is identified with a unique identifier. In order to limit the memory usage needed for parameter sets, the value range for parameter set identifiers has been limited. In H.264/AVC and a draft HEVC standard, each slice header includes the identifier of the picture parameter set that is active for the decoding of the picture that contains the slice, and each picture parameter set contains the identifier of the active sequence parameter set. In a HEVC standard, a slice header additionally contains an APS identifier. Consequently, the transmission of picture and sequence parameter sets does not have to be accurately synchronized with the transmission of slices. Instead, it is sufficient that the active sequence and picture parameter sets are received at any moment before they are referenced, which allows transmission of parameter sets “out-of-band” using a more reliable transmission mechanism compared to the protocols used for the slice data. For example, parameter sets can be included as a parameter in the session description for Real-time Transport Protocol (RTP) sessions. If parameter sets are transmitted in-band, they can be repeated to improve error robustness.

A parameter sets may be activated by a reference from a slice or from another active parameter set or in some cases from another syntax structure such as a buffering period SEI message. In the following, non-limiting examples of activation of parameter sets in a draft HEVC standard are given.

Each adaptation parameter set RBSP is initially considered not active at the start of the operation of the decoding process. At most one adaptation parameter set RBSP is considered active at any given moment during the operation of the decoding process, and the activation of any particular adaptation parameter set RBSP results in the deactivation of the previously-active adaptation parameter set RBSP (if any).

When an adaptation parameter set RB SP (with a particular value of aps_id) is not active and it is referred to by a coded slice NAL unit (using that value of aps_id), it is activated. This adaptation parameter set RBSP is called the active adaptation parameter set RBSP until it is deactivated by the activation of another adaptation parameter set RBSP. An adaptation parameter set RBSP, with that particular value of aps_id, is available to the decoding process prior to its activation, included in at least one access unit with temporal_id equal to or less than the temporal_id of the adaptation parameter set NAL unit, unless the adaptation parameter set is provided through external means.

Each picture parameter set RBSP is initially considered not active at the start of the operation of the decoding process. At most one picture parameter set RBSP is considered active at any given moment during the operation of the decoding process, and the activation of any particular picture parameter set RB SP results in the deactivation of the previously-active picture parameter set RB SP (if any).

When a picture parameter set RBSP (with a particular value of pic_parameter_set_id) is not active and it is referred to by a coded slice NAL unit or coded slice data partition A NAL unit (using that value of pic_parameter_set_id), it is activated. This picture parameter set RBSP is called the active picture parameter set RBSP until it is deactivated by the activation of another picture parameter set RBSP. A picture parameter set RBSP, with that particular value of pic_parameter_set_id, is available to the decoding process prior to its activation, included in at least one access unit with temporal_id equal to or less than the temporal_id of the picture parameter set NAL unit, unless the picture parameter set is provided through external means.

Each sequence parameter set RBSP is initially considered not active at the start of the operation of the decoding process. At most one sequence parameter set RBSP is considered active at any given moment during the operation of the decoding process, and the activation of any particular sequence parameter set RBSP results in the deactivation of the previously-active sequence parameter set RBSP (if any).

When a sequence parameter set RBSP (with a particular value of seq_parameter_set_id) is not already active and it is referred to by activation of a picture parameter set RBSP (using that value of seq_parameter_set_id) or is referred to by an SEI NAL unit containing a buffering period SEI message (using that value of seq_parameter_set_id), it is activated. This sequence parameter set RBSP is called the active sequence parameter set RBSP until it is deactivated by the activation of another sequence parameter set RBSP. A sequence parameter set RBSP, with that particular value of seq_parameter_set_id is available to the decoding process prior to its activation, included in at least one access unit with temporal_id equal to 0, unless the sequence parameter set is provided through external means. An activated sequence parameter set RBSP remains active for the entire coded video sequence.

Each video parameter set RBSP is initially considered not active at the start of the operation of the decoding process. At most one video parameter set RBSP is considered active at any given moment during the operation of the decoding process, and the activation of any particular video parameter set RBSP results in the deactivation of the previously-active video parameter set RBSP (if any).

When a video parameter set RBSP (with a particular value of video_parameter_set_id) is not already active and it is referred to by activation of a sequence parameter set RBSP (using that value of video_parameter_set_id), it is activated. This video parameter set RBSP is called the active video parameter set RBSP until it is deactivated by the activation of another video parameter set RBSP. A video parameter set RBSP, with that particular value of video_parameter_set_id is available to the decoding process prior to its activation, included in at least one access unit with temporal_id equal to 0, unless the video parameter set is provided through external means. An activated video parameter set RBSP remains active for the entire coded video sequence.

During operation of the decoding process in a draft HEVC standard, the values of parameters of the active video parameter set, the active sequence parameter set, the active picture parameter set RBSP and the active adaptation parameter set RBSP are considered in effect. For interpretation of SEI messages, the values of the active video parameter set, the active sequence parameter set, the active picture parameter set RB SP and the active adaptation parameter set RB SP for the operation of the decoding process for the VCL NAL units of the coded picture in the same access unit are considered in effect unless otherwise specified in the SEI message semantics.

A SEI NAL unit may contain one or more SEI messages, which are not required for the decoding of output pictures but may assist in related processes, such as picture output timing, rendering, error detection, error concealment, and resource reservation. Several SEI messages are specified in H.264/AVC and HEVC, and the user data SEI messages enable organizations and companies to specify SEI messages for their own use. H.264/AVC and HEVC contain the syntax and semantics for the specified SEI messages but no process for handling the messages in the recipient is defined. Consequently, encoders are required to follow the H.264/AVC standard or the HEVC standard when they create SEI messages, and decoders conforming to the H.264/AVC standard or the HEVC standard, respectively, are not required to process SEI messages for output order conformance. One of the reasons to include the syntax and semantics of SEI messages in H.264/AVC and HEVC is to allow different system specifications to interpret the supplemental information identically and hence interoperate. It is intended that system specifications can require the use of particular SEI messages both in the encoding end and in the decoding end, and additionally the process for handling particular SEI messages in the recipient can be specified.

In H.264/AVC, the following NAL unit types and their categorization to VCL and non-VCL NAL units have been specified:

| | | | | Annex G |
|---|---|---|---|---|
| | | | | and |
| | | | Annex A | Annex H |
| | | | NAL unit | NAL unit |
| nal_unit_type | Content of NAL unit and RBSP syntax structure | C | type class | type class |
| 0 | Unspecified | | non-VCL | non-VCL |
| 1 | Coded slice of a non-IDR picture | 2, 3, 4 | VCL | VCL |
| | slice_layer_without_partitioning_rbsp( ) | | | |
| 2 | Coded slice data partition A | 2 | VCL | not |
| | slice_data_partition_a_layer_rbsp( ) | | | applicable |
| 3 | Coded slice data partition B | 3 | VCL | not |
| | slice_data_partition_b_layer_rbsp( ) | | | applicable |
| 4 | Coded slice data partition C | 4 | VCL | not |
| | slice_data_partition_c_layer_rbsp( ) | | | applicable |
| 5 | Coded slice of an IDR picture | 2, 3 | VCL | VCL |
| | slice_layer_without_partitioning_rbsp( ) | | | |
| 6 | Supplemental enhancement information (SEI) | 5 | non-VCL | non-VCL |
| | sei_rbsp( ) | | | |
| 7 | Sequence parameter set | 0 | non-VCL | non-VCL |
| | seq_parameter_set_rbsp( ) | | | |
| 8 | Picture parameter set | 1 | non-VCL | non-VCL |
| | pic_parameter_set_rbsp( ) | | | |
| 9 | Access unit delimiter | 6 | non-VCL | non-VCL |
| | access_unit_delimiter_rbsp( ) | | | |
| 10 | End of sequence | 7 | non-VCL | non-VCL |
| | end_of_seq_rbsp( ) | | | |
| 11 | End of stream | 8 | non-VCL | non-VCL |
| | end_of_stream_rbsp( ) | | | |
| 12 | Filler data | 9 | non-VCL | non-VCL |
| | filler_data_rbsp( ) | | | |
| 13 | Sequence parameter set extension | 10 | non-VCL | non-VCL |
| | seq_parameter_set_extension_rbsp( ) | | | |
| 14 | Prefix NAL unit | 2 | non-VCL | suffix |
| | prefix_nal_unit_rbsp( ) | | | dependent |
| 15 | Subset sequence parameter set | 0 | non-VCL | non-VCL |
| | subset_seq_parameter_set_rbsp( ) | | | |
| 16 . . . 18 | Reserved | | non-VCL | non-VCL |
| 19 | Coded slice of an auxiliary coded picture without partitioning | 2, 3, 4 | non-VCL | non-VCL |
| | slice_layer_without_partitioning_rbsp( ) | | | |
| 20 | Coded slice extension | 2, 3, 4 | non-VCL | VCL |
| | slice_layer_extension_rbsp( ) | | | |
| 21 . . . 23 | Reserved | | non-VCL | non-VCL |
| 24 . . . 31 | Unspecified | | non-VCL | non-VCL |

In a draft HEVC standard, the following NAL unit types and their categorization to VCL and non-VCL NAL units have been specified:

| | Content of NAL | NAL unit |
|---|---|---|
| nal_unit_type | unit and RBSP syntax structure | type class |
| 0 | Unspecified | non-VCL |
| 1 | Coded slice of a non-RAP, non-TFD and | VCL |
| | non-TLA picture slice_layer_rbsp( ) | |
| 2 | Coded slice of a TFD picture | VCL |
| | slice_layer_rbsp( ) | |
| 3 | Coded slice of a non-TFD TLA picture | VCL |
| | slice_layer_rbsp( ) | |
| 4, 5 | Coded slice of a CRA picture | VCL |
| | slice_layer_rbsp( ) | |
| 6, 7 | Coded slice of a BLA picture | VCL |
| | slice_layer_rbsp( ) | |
| 8 | Coded slice of an IDR picture | VCL |
| | slice_layer_rbsp( ) | |
| 9 . . . 24 | Reserved | n/a |
| 25 | Video parameter set | non-VCL |
| | video_parameter_set_rbsp( ) | |
| 26 | Sequence parameter set | non-VCL |
| | seq_parameter_set_rbsp( ) | |
| 27 | Picture parameter set | non-VCL |
| | pic_parameter_set_rbsp( ) | |
| 28 | Adaptation parameter set | non-VCL |
| | aps_rbsp( ) | |
| 29 | Access unit delimiter | non-VCL |
| | access_unit_delimiter_rbsp( ) | |
| 30 | Filler data | non-VCL |
| | filler_data_rbsp( ) | |
| 31 | Supplemental enhancement | non-VCL |
| | information (SEI) sei_rbsp( ) | |
| 32 . . . 47 | Reserved | n/a |
| 48 . . . 63 | Unspecified | non-VCL |

A coded picture is a coded representation of a picture. A coded picture in H.264/AVC comprises the VCL NAL units that are required for the decoding of the picture. In H.264/AVC, a coded picture can be a primary coded picture or a redundant coded picture. A primary coded picture is used in the decoding process of valid bitstreams, whereas a redundant coded picture is a redundant representation that should only be decoded when the primary coded picture cannot be successfully decoded. In a draft HEVC, no redundant coded picture has been specified.

In H.264/AVC and HEVC, an access unit comprises a primary coded picture and those NAL units that are associated with it. In H.264/AVC, the appearance order of NAL units within an access unit is constrained as follows. An optional access unit delimiter NAL unit may indicate the start of an access unit. It is followed by zero or more SEI NAL units. The coded slices of the primary coded picture appear next. In H.264/AVC, the coded slice of the primary coded picture may be followed by coded slices for zero or more redundant coded pictures. A redundant coded picture is a coded representation of a picture or a part of a picture. A redundant coded picture may be decoded if the primary coded picture is not received by the decoder for example due to a loss in transmission or a corruption in physical storage medium.

In H.264/AVC, an access unit may also include an auxiliary coded picture, which is a picture that supplements the primary coded picture and may be used for example in the display process. An auxiliary coded picture may for example be used as an alpha channel or alpha plane specifying the transparency level of the samples in the decoded pictures. An alpha channel or plane may be used in a layered composition or rendering system, where the output picture is formed by overlaying pictures being at least partly transparent on top of each other. An auxiliary coded picture has the same syntactic and semantic restrictions as a monochrome redundant coded picture. In H.264/AVC, an auxiliary coded picture contains the same number of macroblocks as the primary coded picture.

A coded video sequence is defined to be a sequence of consecutive access units in decoding order from an IDR access unit, inclusive, to the next IDR access unit, exclusive, or to the end of the bitstream, whichever appears earlier.

A group of pictures (GOP) and its characteristics may be defined as follows. A GOP can be decoded regardless of whether any previous pictures were decoded. An open GOP is such a group of pictures in which pictures preceding the initial intra picture in output order might not be correctly decodable when the decoding starts from the initial intra picture of the open GOP. In other words, pictures of an open GOP may refer (in inter prediction) to pictures belonging to a previous GOP. An H.264/AVC decoder can recognize an intra picture starting an open GOP from the recovery point SEI message in an H.264/AVC bitstream. An HEVC decoder can recognize an intra picture starting an open GOP, because a specific NAL unit type, CRA NAL unit type, is used for its coded slices. A closed GOP is such a group of pictures in which all pictures can be correctly decoded when the decoding starts from the initial intra picture of the closed GOP. In other words, no picture in a closed GOP refers to any pictures in previous GOPs. In H.264/AVC and HEVC, a closed GOP starts from an IDR access unit. As a result, closed GOP structure has more error resilience potential in comparison to the open GOP structure, however at the cost of possible reduction in the compression efficiency. Open GOP coding structure is potentially more efficient in the compression, due to a larger flexibility in selection of reference pictures.

The bitstream syntax of H.264/AVC and HEVC indicates whether a particular picture is a reference picture for inter prediction of any other picture. Pictures of any coding type (I, P, B) can be reference pictures or non-reference pictures in H.264/AVC and HEVC. The NAL unit header indicates the type of the NAL unit and whether a coded slice contained in the NAL unit is a part of a reference picture or a non-reference picture.

Many hybrid video codecs, including H.264/AVC and HEVC, encode video information in two phases. In the first phase, pixel or sample values in a certain picture area or “block” are predicted. These pixel or sample values can be predicted, for example, by motion compensation mechanisms, which involve finding and indicating an area in one of the previously encoded video frames that corresponds closely to the block being coded. Additionally, pixel or sample values can be predicted by spatial mechanisms which involve finding and indicating a spatial region relationship.

Prediction approaches using image information from a previously coded image can also be called as inter prediction methods which may also be referred to as temporal prediction and motion compensation. Prediction approaches using image information within the same image can also be called as intra prediction methods.

The second phase is one of coding the error between the predicted block of pixels or samples and the original block of pixels or samples. This may be accomplished by transforming the difference in pixel or sample values using a specified transform. This transform may be a Discrete Cosine Transform (DCT) or a variant thereof. After transforming the difference, the transformed difference is quantized and entropy encoded.

By varying the fidelity of the quantization process, the encoder can control the balance between the accuracy of the pixel or sample representation (i.e. the visual quality of the picture) and the size of the resulting encoded video representation (i.e. the file size or transmission bit rate).

The decoder reconstructs the output video by applying a prediction mechanism similar to that used by the encoder in order to form a predicted representation of the pixel or sample blocks (using the motion or spatial information created by the encoder and stored in the compressed representation of the image) and prediction error decoding (the inverse operation of the prediction error coding to recover the quantized prediction error signal in the spatial domain).

After applying pixel or sample prediction and error decoding processes the decoder combines the prediction and the prediction error signals (the pixel or sample values) to form the output video frame.

The decoder (and encoder) may also apply additional filtering processes in order to improve the quality of the output video before passing it for display and/or storing as a prediction reference for the forthcoming pictures in the video sequence.

In many video codecs, including H.264/AVC and HEVC, motion information is indicated by motion vectors associated with each motion compensated image block. Each of these motion vectors represents the displacement of the image block in the picture to be coded (in the encoder) or decoded (at the decoder) and the prediction source block in one of the previously coded or decoded images (or pictures). H.264/AVC and HEVC, as many other video compression standards, divide a picture into a mesh of rectangles, for each of which a similar block in one of the reference pictures is indicated for inter prediction. The location of the prediction block is coded as a motion vector that indicates the position of the prediction block relative to the block being coded.

Inter prediction process may be characterized using one or more of the following factors.

The Accuracy of Motion Vector Representation.

For example, motion vectors may be of quarter-pixel accuracy, and sample values in fractional-pixel positions may be obtained using a finite impulse response (FIR) filter.

Block Partitioning for Inter Prediction.

Many coding standards, including H.264/AVC and HEVC, allow selection of the size and shape of the block for which a motion vector is applied for motion-compensated prediction in the encoder, and indicating the selected size and shape in the bitstream so that decoders can reproduce the motion-compensated prediction done in the encoder.

Number of Reference Pictures for Inter Prediction.

The sources of inter prediction are previously decoded pictures. Many coding standards, including H.264/AVC and HEVC, enable storage of multiple reference pictures for inter prediction and selection of the used reference picture on a block basis. For example, reference pictures may be selected on macroblock or macroblock partition basis in H.264/AVC and on PU or CU basis in HEVC. Many coding standards, such as H.264/AVC and HEVC, include syntax structures in the bitstream that enable decoders to create one or more reference picture lists. A reference picture index to a reference picture list may be used to indicate which one of the multiple reference pictures is used for inter prediction for a particular block. A reference picture index may be coded by an encoder into the bitstream is some inter coding modes or it may be derived (by an encoder and a decoder) for example using neighboring blocks in some other inter coding modes.

Motion Vector Prediction.

In order to represent motion vectors efficiently in bitstreams, motion vectors may be coded differentially with respect to a block-specific predicted motion vector. In many video codecs, the predicted motion vectors are created in a predefined way, for example by calculating the median of the encoded or decoded motion vectors of the adjacent blocks. Another way to create motion vector predictions is to generate a list of candidate predictions from adjacent blocks and/or co-located blocks in temporal reference pictures and signalling the chosen candidate as the motion vector predictor. In addition to predicting the motion vector values, the reference index of previously coded/decoded picture can be predicted. The reference index is typically predicted from adjacent blocks and/or co-located blocks in temporal reference picture. Differential coding of motion vectors is typically disabled across slice boundaries.

Multi-Hypothesis Motion-Compensated Prediction.

H.264/AVC and HEVC enable the use of a single prediction block in P slices (herein referred to as uni-predictive slices) or a linear combination of two motion-compensated prediction blocks for bi-predictive slices, which are also referred to as B slices. Individual blocks in B slices may be bi-predicted, uni-predicted, or intra-predicted, and individual blocks in P slices may be uni-predicted or intra-predicted. The reference pictures for a bi-predictive picture may not be limited to be the subsequent picture and the previous picture in output order, but rather any reference pictures may be used. In many coding standards, such as H.264/AVC and HEVC, one reference picture list, referred to as reference picture list 0, is constructed for P slices, and two reference picture lists, list 0 and list 1, are constructed for B slices. For B slices, when prediction in forward direction may refer to prediction from a reference picture in reference picture list 0, and prediction in backward direction may refer to prediction from a reference picture in reference picture list 1, even though the reference pictures for prediction may have any decoding or output order relation to each other or to the current picture.

Weighted Prediction.

Many coding standards use a prediction weight of 1 for prediction blocks of inter (P) pictures and 0.5 for each prediction block of a B picture (resulting into averaging). H.264/AVC allows weighted prediction for both P and B slices. In implicit weighted prediction, the weights are proportional to picture order counts, while in explicit weighted prediction, prediction weights are explicitly indicated.

In many video codecs, the prediction residual after motion compensation is first transformed with a transform kernel (like DCT) and then coded. The reason for this is that often there still exists some correlation among the residual and transform can in many cases help reduce this correlation and provide more efficient coding.

In a draft HEVC, each PU has prediction information associated with it defining what kind of a prediction is to be applied for the pixels within that PU (e.g. motion vector information for inter predicted PUs and intra prediction directionality information for intra predicted PUs). Similarly each TU is associated with information describing the prediction error decoding process for the samples within the TU (including e.g. DCT coefficient information). It may be signalled at CU level whether prediction error coding is applied or not for each CU. In the case there is no prediction error residual associated with the CU, it can be considered there are no TUs for the CU.

In some coding formats and codecs, a distinction is made between so-called short-term and long-term reference pictures. This distinction may affect some decoding processes such as motion vector scaling in the temporal direct mode or implicit weighted prediction. If both of the reference pictures used for the temporal direct mode are short-term reference pictures, the motion vector used in the prediction may be scaled according to the picture order count (POC) difference between the current picture and each of the reference pictures. However, if at least one reference picture for the temporal direct mode is a long-term reference picture, default scaling of the motion vector may be used, for example scaling the motion to half may be used. Similarly, if a short-term reference picture is used for implicit weighted prediction, the prediction weight may be scaled according to the POC difference between the POC of the current picture and the POC of the reference picture. However, if a long-term reference picture is used for implicit weighted prediction, a default prediction weight may be used, such as 0.5 in implicit weighted prediction for bi-predicted blocks.

Some video coding formats, such as H.264/AVC, include the frame_num syntax element, which is used for various decoding processes related to multiple reference pictures. In H.264/AVC, the value of frame_num for IDR pictures is 0. The value of frame_num for non-IDR pictures is equal to the frame_num of the previous reference picture in decoding order incremented by 1 (in modulo arithmetic, i.e., the value of frame_num wrap over to 0 after a maximum value of frame_num).

H.264/AVC and HEVC include a concept of picture order count (POC). A value of POC is derived for each picture and is non-decreasing with increasing picture position in output order. POC therefore indicates the output order of pictures. POC may be used in the decoding process for example for implicit scaling of motion vectors in the temporal direct mode of bi-predictive slices, for implicitly derived weights in weighted prediction, and for reference picture list initialization. Furthermore, POC may be used in the verification of output order conformance. In H.264/AVC, POC is specified relative to the previous IDR picture or a picture containing a memory management control operation marking all pictures as “unused for reference”.

H.264/AVC specifies the process for decoded reference picture marking in order to control the memory consumption in the decoder. The maximum number of reference pictures used for inter prediction, referred to as M, is determined in the sequence parameter set. When a reference picture is decoded, it is marked as “used for reference”. If the decoding of the reference picture caused more than M pictures marked as “used for reference”, at least one picture is marked as “unused for reference”. There are two types of operation for decoded reference picture marking: adaptive memory control and sliding window. The operation mode for decoded reference picture marking is selected on picture basis. The adaptive memory control enables explicit signaling which pictures are marked as “unused for reference” and may also assign long-term indices to short-term reference pictures. The adaptive memory control may require the presence of memory management control operation (MMCO) parameters in the bitstream. MMCO parameters may be included in a decoded reference picture marking syntax structure. If the sliding window operation mode is in use and there are M pictures marked as “used for reference”, the short-term reference picture that was the first decoded picture among those short-term reference pictures that are marked as “used for reference” is marked as “unused for reference”. In other words, the sliding window operation mode results into first-in-first-out buffering operation among short-term reference pictures.

One of the memory management control operations in H.264/AVC causes all reference pictures except for the current picture to be marked as “unused for reference”. An instantaneous decoding refresh (IDR) picture contains only intra-coded slices and causes a similar “reset” of reference pictures.

In a draft HEVC standard, reference picture marking syntax structures and related decoding processes are not used, but instead a reference picture set (RPS) syntax structure and decoding process are used instead for a similar purpose. A reference picture set valid or active for a picture includes all the reference pictures used as reference for the picture and all the reference pictures that are kept marked as “used for reference” for any subsequent pictures in decoding order. There are six subsets of the reference picture set, which are referred to as namely RefPicSetStCurr0, RefPicSetStCurr1, RefPicSetStFoll0, RefPicSetStFoll1, RefPicSetLtCurr, and RefPicSetLtFoll. The notation of the six subsets is as follows. “Curr” refers to reference pictures that are included in the reference picture lists of the current picture and hence may be used as inter prediction reference for the current picture. “Foll” refers to reference pictures that are not included in the reference picture lists of the current picture but may be used in subsequent pictures in decoding order as reference pictures. “St” refers to short-term reference pictures, which may generally be identified through a certain number of least significant bits of their POC value. “Lt” refers to long-term reference pictures, which are specifically identified and generally have a greater difference of POC values relative to the current picture than what can be represented by the mentioned certain number of least significant bits. “0” refers to those reference pictures that have a smaller POC value than that of the current picture. “1” refers to those reference pictures that have a greater POC value than that of the current picture. RefPicSetStCurr0, RefPicSetStCurr1, RefPicSetStFoll0 and RefPicSetStFoll1 are collectively referred to as the short-term subset of the reference picture set. RefPicSetLtCurr and RefPicSetLtFoll are collectively referred to as the long-term subset of the reference picture set.

In a draft HEVC standard, a reference picture set may be specified in a sequence parameter set and taken into use in the slice header through an index to the reference picture set. A reference picture set may also be specified in a slice header. A long-term subset of a reference picture set is generally specified only in a slice header, while the short-term subsets of the same reference picture set may be specified in the picture parameter set or slice header. A reference picture set may be coded independently or may be predicted from another reference picture set (known as inter-RPS prediction). When a reference picture set is independently coded, the syntax structure includes up to three loops iterating over different types of reference pictures; short-term reference pictures with lower POC value than the current picture, short-term reference pictures with higher POC value than the current picture and long-term reference pictures. Each loop entry specifies a picture to be marked as “used for reference”. In general, the picture is specified with a differential POC value. The inter-RPS prediction exploits the fact that the reference picture set of the current picture can be predicted from the reference picture set of a previously decoded picture. This is because all the reference pictures of the current picture are either reference pictures of the previous picture or the previously decoded picture itself. It is only necessary to indicate which of these pictures should be reference pictures and be used for the prediction of the current picture. In both types of reference picture set coding, a flag (used_by_curr_pic_X_flag) is additionally sent for each reference picture indicating whether the reference picture is used for reference by the current picture (included in a *Curr list) or not (included in a *Foll list). Pictures that are included in the reference picture set used by the current slice are marked as “used for reference”, and pictures that are not in the reference picture set used by the current slice are marked as “unused for reference”. If the current picture is an IDR picture, RefPicSetStCurr0, RefPicSetStCurr1, RefPicSetStFoll0, RefPicSetStFoll1, RefPicSetLtCurr, and RefPicSetLtFoll are all set to empty.

A Decoded Picture Buffer (DPB) may be used in the encoder and/or in the decoder. There are two reasons to buffer decoded pictures, for references in inter prediction and for reordering decoded pictures into output order. As H.264/AVC and HEVC provide a great deal of flexibility for both reference picture marking and output reordering, separate buffers for reference picture buffering and output picture buffering may waste memory resources. Hence, the DPB may include a unified decoded picture buffering process for reference pictures and output reordering. A decoded picture may be removed from the DPB when it is no longer used as a reference and is not needed for output.

In many coding modes of H.264/AVC and HEVC, the reference picture for inter prediction is indicated with an index to a reference picture list. The index may be coded with variable length coding, which usually causes a smaller index to have a shorter value for the corresponding syntax element. In H.264/AVC and HEVC, two reference picture lists (reference picture list 0 and reference picture list 1) are generated for each bi-predictive (B) slice, and one reference picture list (reference picture list 0) is formed for each inter-coded (P) slice. In addition, for a B slice in HEVC, a combined list (List C) is constructed after the final reference picture lists (List 0 and List 1) have been constructed. The combined list may be used for uni-prediction (also known as uni-directional prediction) within B slices.

A reference picture list, such as reference picture list 0 and reference picture list 1, is typically constructed in two steps: First, an initial reference picture list is generated. The initial reference picture list may be generated for example on the basis of frame_num, POC, temporal_id, or information on the prediction hierarchy such as GOP structure, or any combination thereof. Second, the initial reference picture list may be reordered by reference picture list reordering (RPLR) commands, also known as reference picture list modification syntax structure, which may be contained in slice headers. The RPLR commands indicate the pictures that are ordered to the beginning of the respective reference picture list. This second step may also be referred to as the reference picture list modification process, and the RPLR commands may be included in a reference picture list modification syntax structure. If reference picture sets are used, the reference picture list 0 may be initialized to contain RefPicSetStCurr0 first, followed by RefPicSetStCurr1, followed by RefPicSetLtCurr. Reference picture list 1 may be initialized to contain RefPicSetStCurr1 first, followed by RefPicSetStCurr0. The initial reference picture lists may be modified through the reference picture list modification syntax structure, where pictures in the initial reference picture lists may be identified through an entry index to the list.

Many high efficiency video codecs such as a draft HEVC codec employ an additional motion information coding/decoding mechanism, often called merging/merge mode/process/mechanism, where all the motion information of a block/PU is predicted and used without any modification/correction. The aforementioned motion information for a PU may comprise 1) The information whether ‘the PU is uni-predicted using only reference picture list0’ or ‘the PU is uni-predicted using only reference picture list1’ or ‘the PU is bi-predicted using both reference picture list0 and list1’; 2) Motion vector value corresponding to the reference picture list0; 3) Reference picture index in the reference picture list0; 4) Motion vector value corresponding to the reference picture list1; and 5) Reference picture index in the reference picture list1. Similarly, predicting the motion information is carried out using the motion information of adjacent blocks and/or co-located blocks in temporal reference pictures. A list, often called as a merge list, may be constructed by including motion prediction candidates associated with available adjacent/co-located blocks and the index of selected motion prediction candidate in the list is signalled and the motion information of the selected candidate is copied to the motion information of the current PU. When the merge mechanism is employed for a whole CU and the prediction signal for the CU is used as the reconstruction signal, i.e. prediction residual is not processed, this type of coding/decoding the CU is typically named as skip mode or merge based skip mode. In addition to the skip mode, the merge mechanism may also be employed for individual PUs (not necessarily the whole CU as in skip mode) and in this case, prediction residual may be utilized to improve prediction quality. This type of prediction mode is typically named as an inter-merge mode.

The merge list may be generated on the basis of reference picture list 0 and/or reference picture list 1 for example using the reference picture lists combination syntax structure included in the slice header syntax. There may be a reference picture lists combination syntax structure, created into the bitstream by an encoder and decoded from the bitstream by a decoder, which indicates the contents of the merge list. The syntax structure may indicate that the reference picture list 0 and the reference picture list 1 are combined to be an additional reference picture lists combination used for the prediction units being uni-directional predicted. The syntax structure may include a flag which, when equal to a certain value, indicates that the reference picture list 0 and reference picture list 1 are identical thus reference picture list 0 is used as the reference picture lists combination. The syntax structure may include a list of entries, each specifying a reference picture list (list 0 or list 1) and a reference index to the specified list, where an entry specifies a reference picture to be included in the merge list.

A syntax structure for decoded reference picture marking may exist in a video coding system. For example, when the decoding of the picture has been completed, the decoded reference picture marking syntax structure, if present, may be used to adaptively mark pictures as “unused for reference” or “used for long-term reference”. If the decoded reference picture marking syntax structure is not present and the number of pictures marked as “used for reference” can no longer increase, a sliding window reference picture marking may be used, which basically marks the earliest (in decoding order) decoded reference picture as unused for reference.

In scalable video coding, a video signal can be encoded into a base layer and one or more enhancement layers. An enhancement layer may enhance the temporal resolution (i.e., the frame rate), the spatial resolution, or simply the quality of the video content represented by another layer or part thereof. Each layer together with all its dependent layers is one representation of the video signal at a certain spatial resolution, temporal resolution and quality level. In this document, we refer to a scalable layer together with all of its dependent layers as a “scalable layer representation”. The portion of a scalable bitstream corresponding to a scalable layer representation can be extracted and decoded to produce a representation of the original signal at certain fidelity.

Some coding standards allow creation of scalable bit streams. A meaningful decoded representation can be produced by decoding only certain parts of a scalable bit stream. Scalable bit streams can be used for example for rate adaptation of pre-encoded unicast streams in a streaming server and for transmission of a single bit stream to terminals having different capabilities and/or with different network conditions. A list of some other use cases for scalable video coding can be found in the ISO/IEC JTC1 SC29 WG11 (MPEG) output document N5540, “Applications and Requirements for Scalable Video Coding”, the 64^{th} MPEG meeting, Mar. 10 to 14, 2003, Pattaya, Thailand.

In some cases, data in an enhancement layer can be truncated after a certain location, or even at arbitrary positions, where each truncation position may include additional data representing increasingly enhanced visual quality. Such scalability is referred to as fine-grained (granularity) scalability (FGS). FGS was included in some draft versions of the SVC standard, but it was eventually excluded from the final SVC standard. FGS is subsequently discussed in the context of some draft versions of the SVC standard. The scalability provided by those enhancement layers that cannot be truncated is referred to as coarse-grained (granularity) scalability (CGS). It collectively includes the traditional quality (SNR) scalability and spatial scalability. The SVC standard supports the so-called medium-grained scalability (MGS), where quality enhancement pictures are coded similarly to SNR scalable layer pictures but indicated by high-level syntax elements similarly to FGS layer pictures, by having the quality_id syntax element greater than 0.

SVC uses an inter-layer prediction mechanism, wherein certain information can be predicted from layers other than the currently reconstructed layer or the next lower layer. Information that could be inter-layer predicted includes intra texture, motion and residual data. Inter-layer motion prediction includes the prediction of block coding mode, header information, etc., wherein motion from the lower layer may be used for prediction of the higher layer. In case of intra coding, a prediction from surrounding macroblocks or from co-located macroblocks of lower layers is possible. These prediction techniques do not employ information from earlier coded access units and hence, are referred to as intra prediction techniques. Furthermore, residual data from lower layers can also be employed for prediction of the current layer.

SVC specifies a concept known as single-loop decoding. It is enabled by using a constrained intra texture prediction mode, whereby the inter-layer intra texture prediction can be applied to macroblocks (MBs) for which the corresponding block of the base layer is located inside intra-MBs. At the same time, those intra-MBs in the base layer use constrained intra-prediction (e.g., having the syntax element “constrained_intra_pred_flag” equal to 1). In single-loop decoding, the decoder performs motion compensation and full picture reconstruction only for the scalable layer desired for playback (called the “desired layer” or the “target layer”), thereby greatly reducing decoding complexity. All of the layers other than the desired layer do not need to be fully decoded because all or part of the data of the MBs not used for inter-layer prediction (be it inter-layer intra texture prediction, inter-layer motion prediction or inter-layer residual prediction) is not needed for reconstruction of the desired layer.

A single decoding loop is needed for decoding of most pictures, while a second decoding loop is selectively applied to reconstruct the base representations, which are needed as prediction references but not for output or display, and are reconstructed only for the so called key pictures (for which “store_ref base_pic_flag” is equal to 1).

The scalability structure in the SVC draft is characterized by three syntax elements: “temporal_id,” “dependency_id” and “quality_id.” The syntax element “temporal_id” is used to indicate the temporal scalability hierarchy or, indirectly, the frame rate. A scalable layer representation comprising pictures of a smaller maximum “temporal_id” value has a smaller frame rate than a scalable layer representation comprising pictures of a greater maximum “temporal_id”. A given temporal layer typically depends on the lower temporal layers (i.e., the temporal layers with smaller “temporal_id” values) but does not depend on any higher temporal layer. The syntax element “dependency_id” is used to indicate the CGS inter-layer coding dependency hierarchy (which, as mentioned earlier, includes both SNR and spatial scalability). At any temporal level location, a picture of a smaller “dependency_id” value may be used for inter-layer prediction for coding of a picture with a greater “dependency_id” value. The syntax element “quality_id” is used to indicate the quality level hierarchy of a FGS or MGS layer. At any temporal location, and with an identical “dependency_id” value, a picture with “quality_id” equal to QL uses the picture with “quality_id” equal to QL−1 for inter-layer prediction. A coded slice with “quality_id” larger than 0 may be coded as either a truncatable FGS slice or a non-truncatable MGS slice.

For simplicity, all the data units (e.g., Network Abstraction Layer units or NAL units in the SVC context) in one access unit having identical value of “dependency_id” are referred to as a dependency unit or a dependency representation. Within one dependency unit, all the data units having identical value of “quality_id” are referred to as a quality unit or layer representation.

A base representation, also known as a decoded base picture, is a decoded picture resulting from decoding the Video Coding Layer (VCL) NAL units of a dependency unit having “quality_id” equal to 0 and for which the “store_ref base_pic_flag” is set equal to 1. An enhancement representation, also referred to as a decoded picture, results from the regular decoding process in which all the layer representations that are present for the highest dependency representation are decoded.

As mentioned earlier, CGS includes both spatial scalability and SNR scalability. Spatial scalability is initially designed to support representations of video with different resolutions. For each time instance, VCL NAL units are coded in the same access unit and these VCL NAL units can correspond to different resolutions. During the decoding, a low resolution VCL NAL unit provides the motion field and residual which can be optionally inherited by the final decoding and reconstruction of the high resolution picture. When compared to older video compression standards, SVC's spatial scalability has been generalized to enable the base layer to be a cropped and zoomed version of the enhancement layer.

MGS quality layers are indicated with “quality_id” similarly as FGS quality layers. For each dependency unit (with the same “dependency_id”), there is a layer with “quality_id” equal to 0 and there can be other layers with “quality_id” greater than 0. These layers with “quality_id” greater than 0 are either MGS layers or FGS layers, depending on whether the slices are coded as truncatable slices.

In the basic form of FGS enhancement layers, only inter-layer prediction is used. Therefore, FGS enhancement layers can be truncated freely without causing any error propagation in the decoded sequence. However, the basic form of FGS suffers from low compression efficiency. This issue arises because only low-quality pictures are used for inter prediction references. It has therefore been proposed that FGS-enhanced pictures be used as inter prediction references. However, this may cause encoding-decoding mismatch, also referred to as drift, when some FGS data are discarded.

One feature of a draft SVC standard is that the FGS NAL units can be freely dropped or truncated, and a feature of the SVCV standard is that MGS NAL units can be freely dropped (but cannot be truncated) without affecting the conformance of the bitstream. As discussed above, when those FGS or MGS data have been used for inter prediction reference during encoding, dropping or truncation of the data would result in a mismatch between the decoded pictures in the decoder side and in the encoder side. This mismatch is also referred to as drift.

To control drift due to the dropping or truncation of FGS or MGS data, SVC applied the following solution: In a certain dependency unit, a base representation (by decoding only the CGS picture with “quality_id” equal to 0 and all the dependent-on lower layer data) is stored in the decoded picture buffer. When encoding a subsequent dependency unit with the same value of “dependency_id,” all of the NAL units, including FGS or MGS NAL units, use the base representation for inter prediction reference. Consequently, all drift due to dropping or truncation of FGS or MGS NAL units in an earlier access unit is stopped at this access unit. For other dependency units with the same value of “dependency_id,” all of the NAL units use the decoded pictures for inter prediction reference, for high coding efficiency.

Each NAL unit includes in the NAL unit header a syntax element “use_ref base_pic_flag.” When the value of this element is equal to 1, decoding of the NAL unit uses the base representations of the reference pictures during the inter prediction process. The syntax element “store_ref base_pic_flag” specifies whether (when equal to 1) or not (when equal to 0) to store the base representation of the current picture for future pictures to use for inter prediction.

NAL units with “quality_id” greater than 0 do not contain syntax elements related to reference picture lists construction and weighted prediction, i.e., the syntax elements “num_refactive_lx_minus1” (x=0 or 1), the reference picture list reordering syntax table, and the weighted prediction syntax table are not present. Consequently, the MGS or FGS layers have to inherit these syntax elements from the NAL units with “quality_id” equal to 0 of the same dependency unit when needed.

In SVC, a reference picture list consists of either only base representations (when “use_ref base_pic_flag” is equal to 1) or only decoded pictures not marked as “base representation” (when “use_ref base_pic_flag” is equal to 0), but never both at the same time.

The value of variable DQId for the decoding process of SVC may be set equal to dependency_id×16+quality_id, or equivalently (dependency_id<<4)+quality_id, where << is the bit-shift operation to left. The value of variable DQIdMax in SVC may be set equal to greatest DQId value for any VCL NAL unit in the access unit being decoded. The variable DependencyIdMax may be set equal to (DQIdMax>>4) where >> is the bit-shift operation to right. In conforming SVC coded video sequences, DependencyIdMax is the same for all access units of the coded video sequence.

A scalable nesting SEI message has been specified in SVC. The scalable nesting SEI message provides a mechanism for associating SEI messages with subsets of a bitstream. A scalable nesting SEI message contains one or more SEI messages that are not scalable nesting SEI messages themselves. An SEI message contained in a scalable nesting SEI message is referred to as a nested SEI message. An SEI message not contained in a scalable nesting SEI message is referred to as a non-nested SEI message. The scope to which the nested SEI message applies is indicated by the syntax elements all_layer_representations_in_au_flag, num_layer_representations_minus1, sei_dependency_id[i], sei_quality_id[i], and sei_temporal_id, when present in the scalable nesting SEI message. all_layer_representations_in_au_flag equal to 1 specifies that the nested SEI message applies to all layer representations of the access unit. all_layer_representations_in_au_flag equal to 0 specifies that the scope of the nested SEI message is specified by the syntax elements num_layer_representations_minus1, sei_dependency_id[i], sei_quality_id[i], and sei_temporal_id. num_layer_representations_minus1 plus 1 specifies, when num_layer_representations_minus1 is present, the number of syntax element pairs sei_dependency_id[i] and sei_quality_id[i] that are present in the scalable nesting SEI message. When num_layer_representations_minus1 is not present, it is inferred to be equal to (numSVCLayers−1) with numSVCLayers being the number of layer representations that are present in the primary coded picture of the access unit. sei_dependency_id[i] and sei_quality_id[i] indicate the dependency_id and the quality_id values, respectively, of the layer representations to which the nested SEI message applies. The access unit may or may not contain layer representations with dependency_id equal to sei_dependency_id[i] and quality_id equal to sei_quality_id[i]. When num_layer_representations_minus1 is not present, the values of sei_dependency_id[i] and sei_quality_id[i] for i in the range of 0 to num_layer_representations_minus 1 (with num_layer_representations_minus 1 being the inferred value), inclusive, are inferred as specified in the following:
1. Let setDQId be the set of the values DQId for all layer representations that are present in the primary coded picture of the access unit.
2. For i proceeding from 0 to num_layer_representations_minus1, inclusive, the following applies:
   a. sei_dependency_id[i] and sei_quality_id[i] are inferred to be equal to (minDQId>>4) and (minDQId & 15), respectively, with minDQId being the smallest value (smallest value of DQId) in the set setDQId.
   b. The smallest value (smallest value of DQId) of the set setDQId is removed from setDQId and thus the number of elements in the set setDQId is decreased by 1.

sei_temporal_id indicates the temporal_id value of the bitstream subset to which the nested SEI message applies. When sei_temporal_id is not present, it shall be inferred to be equal to temporal_id of the access unit.

In SVC, in addition to the active picture parameter set RBSP, zero or more picture parameter set RBSPs may be specifically active for layer representations (with a particular value of DQId less than DQIdMax) that may be referred to through inter-layer prediction in decoding the target layer representation. Such a picture parameter set RBSP is referred to as active layer picture parameter set RBSP for the particular value of DQId (less than DQIdMax). The restrictions on active picture parameter set RBSPs also apply to active layer picture parameter set RBSPs with a particular value of DQId.

In SVC, when a picture parameter set RBSP (with a particular value of pic_parameter_set_id) is not the active picture parameter set RBSP and it is referred to by a coded slice NAL unit with DQId equal to DQIdMax (using that value of pic_parameter_set_id), it is activated. This picture parameter set RBSP is called the active picture parameter set RBSP until it is deactivated when another picture parameter set RBSP becomes the active picture parameter set RBSP. A picture parameter set RBSP, with that particular value of pic_parameter_set_id, is available to the decoding process prior to its activation.

In SVC, when a picture parameter set RBSP (with a particular value of pic_parameter_set_id) is not the active layer picture parameter set for a particular value of DQId less than DQIdMax and it is referred to by a coded slice NAL unit with the particular value of DQId (using that value of pic_parameter_set_id), it is activated for layer representations with the particular value of DQId. This picture parameter set RBSP is called the active layer picture parameter set RBSP for the particular value of DQId until it is deactivated when another picture parameter set RBSP becomes the active layer picture parameter set RBSP for the particular value of DQId or when decoding an access unit with DQIdMax less than or equal to the particular value of DQId. A picture parameter set RBSP, with that particular value of pic_parameter_set_id, is available to the decoding process prior to its activation.

In SVC, an SVC sequence parameter set RBSP may be defined as a collective term for sequence parameter set RBSP or subset sequence parameter set RBSP.

In SVC, when an SVC sequence parameter set RBSP with a particular value of seq_parameter_set_id is not already the active SVC sequence parameter set RBSP and it is referred to by activation of a picture parameter set RB SP (using that value of seq_parameter_set_id) as an active picture parameter set RBSP, the SVC sequence parameter set RBSP is activated. The active SVC sequence parameter set RBSP remains active until it is deactivated when another SVC sequence parameter set RBSP becomes the active SVC sequence parameter set RBSP. A sequence parameter set RBSP, with that particular value of seq_parameter_set_id, is available to the decoding process prior to its activation.

In SVC, profile_idc and level_idc in an SVC sequence parameter set RBSP indicate the profile and level to which the coded video sequence conforms when the SVC sequence parameter set RB SP is the active SVC sequence parameter set RBSP.

In addition to the active SVC sequence parameter set RBSP, zero or more SVC sequence parameter set RBSPs may be specifically active for layer representations (with a particular value of DQId less than DQIdMax) that may be referred to through inter-layer prediction in decoding the target layer representation. Such an SVC sequence parameter set RBSP is referred to as active layer SVC sequence parameter set RBSP for the particular value of DQId (less than DQIdMax). The restrictions on active SVC sequence parameter set RBSPs also apply to active layer SVC sequence parameter set RBSPs with a particular value of DQId.

In SVC, when a sequence parameter set RBSP with a particular value of seq_parameter_set_id is not already the active layer SVC sequence parameter set RBSP for DQId equal to 0 and it is referred to by activation of a picture parameter set RBSP (using that value of seq_parameter_set_id) and the picture parameter set RBSP is activated by a base-layer coded slice NAL unit or buffering period SEI message and DQIdMax is greater than 0 (the picture parameter set RBSP becomes the active layer picture parameter set RBSP for DQId equal to 0), the sequence parameter set RBSP is activated for layer representations with DQId equal to 0. This sequence parameter set RBSP is called the active layer SVC sequence parameter set RBSP for DQId equal to 0 until it is deactivated when another SVC sequence parameter set RBSP becomes the active layer SVC sequence parameter set RBSP for DQId equal to 0 or when decoding an access unit with DQIdMax equal to 0. A sequence parameter set RBSP, with that particular value of seq_parameter_set_id, is available to the decoding process prior to its activation.

In SVC, when a subset sequence parameter set RBSP with a particular value of seq_parameter_set_id is not already the active layer SVC sequence parameter set RBSP for a particular value of DQId less than DQIdMax and it is referred to by an activating layer buffering period SEI message for the particular value of DQId (using that value of seq_parameter_set_id) that is included in a scalable nesting SEI message, the subset sequence parameter set RBSP is activated for layer representations with the particular value of DQId. This subset sequence parameter set RBSP is called the active layer SVC sequence parameter set RBSP for the particular value of DQId until it is deactivated when another SVC sequence parameter set RBSP becomes the active layer SVC sequence parameter set RBSP for the particular value of DQId or when decoding an access unit with DQIdMax less than or equal to the particular value of DQId. A subset sequence parameter set RBSP, with that particular value of seq_parameter_set_id, is available to the decoding process prior to its activation.

Let spsA and spsB be two SVC sequence parameter set RBSPs with one of the following properties:
spsA is the SVC sequence parameter set RBSP that is referred to by the coded slice NAL units (via the picture parameter set) of a layer representation with a particular value of dependency_id and quality_id equal to 0 and spsB is the SVC sequence parameter set RBSP that is referred to by the coded slice NAL units (via the picture parameter set) of another layer representation, in the same access unit, with the same value of dependency_id and quality_id greater than 0,
spsA is the active SVC sequence parameter set RBSP for an access unit and spsB is the SVC sequence parameter set RBSP that is referred to by the coded slice NAL units (via the picture parameter set) of the layer representation with DQId equal to DQIdMax,
spsA is the active SVC sequence parameter set RBSP for an IDR access unit and spsB is the active SVC sequence parameter set RBSP for any non-IDR access unit of the same coded video sequence.

The SVC sequence parameter set RBSPs spsA and spsB are restricted with regards to their contents as specified in the following.
The values of the syntax elements in the sequence parameter set data syntax structure of spsA and spsB may only differ for the following syntax elements and is the same otherwise: profile_idc, constraint_setX_flag (with X being equal to 0 to 5, inclusive), reserved_zero_{—}2 bits, level_idc, seq_parameter_set_id, timing_info_present_flag, num_units_in_tick, time_scale, fixed_frame_rate_flag, nal_hrd_parameters_present_flag, vcl_hrd_parameters_present_flag, low_delay_hrd_flag, pic_struct_present_flag, and the hrd_parameters( ) syntax structures. In summary, only the profile and level related indications, profile compatibility indications, HRD parameters, and picture timing related indications may differ.
When spsA is the active SVC sequence parameter set RBSP and spsB is the SVC sequence parameter set RBSP that is referred to by the coded slice NAL units of the layer representation with DQId equal to DQIdMax, the level specified by level_idc (or level_idc and constraint_set3_flag) in spsA is not less than the level specified by level_idc (or level_idc and constraint_set3_flag) in spsB.
When the seq_parameter_set_svc_extension( ) syntax structure is present in both spsA and spsB, the values of all syntax elements in the seq_parameter_set_svc_extension( ) syntax structure are the same.

In SVC, the scalability information SEI message provides scalability information for subsets of the bitstream. A scalability information SEI message is not be included in a scalable nesting SEI message. A scalability information SEI message may be present in an access unit where all dependency representations are IDR dependency representations. The set of access units consisting of the access unit associated with the scalability information SEI message and all succeeding access units in decoding order until, but excluding, the next access unit where all dependency representations are IDR dependency representations (if present) or the end of the bitstream (otherwise) is referred to as the target access unit set. The scalability information SEI message applies to the target access unit set. The scalability information SEI message provides information for subsets of the target access unit set. These subsets are referred to as scalable layers. A scalable layer represents a set of NAL units, inside the target access unit set, that consists of VCL NAL units with the same values of dependency_id, quality_id, and temporal_id, as indicated by the scalability information SEI message, and associated non-VCL NAL units. The representation of a particular scalable layer is the set of NAL units that represents the set union of the particular scalable layer and all scalable layers on which the particular scalable layer directly or indirectly depends. The representation of a scalable layer is also referred to as scalable layer representation. Terms representation of a scalable layer and scalable layer representation may also be used for referring to the access unit set that can be constructed from the NAL units of the scalable layer representation. A scalable layer representation can be decoded independently of all NAL units that do not belong to the scalable layer representation. The decoding result of a scalable layer representation is the set of decoded pictures that are obtained by decoding the access unit set of the scalable layer representation.

Among other things, the scalability information SEI message in SVC may specify one or more scalable layers through a set of dependency_id, quality_id, and temporal_id values. Specifically, the scalability information SEI message may include for each scalable layer i the syntax elements dependency_id[i], quality_id[i], and temporal_id[i] that are equal to the values of dependency_id, quality_id, and temporal_id, respectively, of the VCL NAL units of the scalable layer. All VCL NAL units of a scalable layer have the same values of dependency_id, quality_id, and temporal_id.

Among other things, the scalability information SEI message in SVC may include layer_profile_level_idc[i] for scalable layer i that indicates the conformance point of the representation of the scalable layer. layer_profile_level_idc[i] is the exact copy of the three bytes comprised of profile_idc, constraint_set0_flag, constraint_set1_flag, constraint_set2_flag, constraint_set3_flag, constraint_set4_flag, constraint_set5_flag, reserved_zero_{—}2 bits and level_idc, as if these syntax elements were used to specify the profile and level conformance of the representation of the current scalable layer.

As indicated earlier, MVC is an extension of H.264/AVC. Many of the definitions, concepts, syntax structures, semantics, and decoding processes of H.264/AVC apply also to MVC as such or with certain generalizations or constraints. Some definitions, concepts, syntax structures, semantics, and decoding processes of MVC are described in the following.

An access unit in MVC is defined to be a set of NAL units that are consecutive in decoding order and contain exactly one primary coded picture consisting of one or more view components. In addition to the primary coded picture, an access unit may also contain one or more redundant coded pictures, one auxiliary coded picture, or other NAL units not containing slices or slice data partitions of a coded picture. The decoding of an access unit results in one decoded picture consisting of one or more decoded view components, when decoding errors, bitstream errors or other errors which may affect the decoding do not occur. In other words, an access unit in MVC contains the view components of the views for one output time instance.

A view component in MVC is referred to as a coded representation of a view in a single access unit.

Inter-view prediction may be used in MVC and refers to prediction of a view component from decoded samples of different view components of the same access unit. In MVC, inter-view prediction is realized similarly to inter prediction. For example, inter-view reference pictures are placed in the same reference picture list(s) as reference pictures for inter prediction, and a reference index as well as a motion vector are coded or inferred similarly for inter-view and inter reference pictures.

An anchor picture is a coded picture in which all slices may reference only slices within the same access unit, i.e., inter-view prediction may be used, but no inter prediction is used, and all following coded pictures in output order do not use inter prediction from any picture prior to the coded picture in decoding order. Inter-view prediction may be used for IDR view components that are part of a non-base view. A base view in MVC is a view that has the minimum value of view order index in a coded video sequence. The base view can be decoded independently of other views and does not use inter-view prediction. The base view can be decoded by H.264/AVC decoders supporting only the single-view profiles, such as the Baseline Profile or the High Profile of H.264/AVC.

In the MVC standard, many of the sub-processes of the MVC decoding process use the respective sub-processes of the H.264/AVC standard by replacing term “picture”, “frame”, and “field” in the sub-process specification of the H.264/AVC standard by “view component”, “frame view component”, and “field view component”, respectively. Likewise, terms “picture”, “frame”, and “field” are often used in the following to mean “view component”, “frame view component”, and “field view component”, respectively.

In scalable multiview coding, the same bitstream may contain coded view components of multiple views and at least some coded view components may be coded using quality and/or spatial scalability.

A texture view refers to a view that represents ordinary video content, for example has been captured using an ordinary camera, and is usually suitable for rendering on a display. A texture view typically comprises pictures having three components, one luma component and two chroma components. In the following, a texture picture typically comprises all its component pictures or color components unless otherwise indicated for example with terms luma texture picture and chroma texture picture.

Depth-enhanced video refers to texture video having one or more views associated with depth video having one or more depth views. A number of approaches may be used for representing of depth-enhanced video, including the use of video plus depth (V+D), multiview video plus depth (MVD), and layered depth video (LDV). In the video plus depth (V+D) representation, a single view of texture and the respective view of depth are represented as sequences of texture picture and depth pictures, respectively. The MVD representation contains a number of texture views and respective depth views. In the LDV representation, the texture and depth of the central view are represented conventionally, while the texture and depth of the other views are partially represented and cover only the dis-occluded areas required for correct view synthesis of intermediate views.

Depth-enhanced video may be coded in a manner where texture and depth are coded independently of each other. For example, texture views may be coded as one MVC bitstream and depth views may be coded as another MVC bitstream. Alternatively depth-enhanced video may be coded in a manner where texture and depth are jointly coded. When joint coding texture and depth views is applied for a depth-enhanced video representation, some decoded samples of a texture picture or data elements for decoding of a texture picture are predicted or derived from some decoded samples of a depth picture or data elements obtained in the decoding process of a depth picture. Alternatively or in addition, some decoded samples of a depth picture or data elements for decoding of a depth picture are predicted or derived from some decoded samples of a texture picture or data elements obtained in the decoding process of a texture picture.

It has been found that a solution for some multiview 3D video (3DV) applications is to have a limited number of input views, e.g. a mono or a stereo view plus some supplementary data, and to render (i.e. synthesize) all required views locally at the decoder side. From several available technologies for view rendering, depth image-based rendering (DIBR) has shown to be a competitive alternative.

A simplified model of a DIBR-based 3DV system is shown in FIG. 5. The input of a 3D video codec comprises a stereoscopic video and corresponding depth information with stereoscopic baseline b0. Then the 3D video codec synthesizes a number of virtual views between two input views with baseline (bi<b0). DIBR algorithms may also enable extrapolation of views that are outside the two input views and not in between them. Similarly, DIBR algorithms may enable view synthesis from a single view of texture and the respective depth view. However, in order to enable DIBR-based multiview rendering, texture data should be available at the decoder side along with the corresponding depth data.

In such 3DV system, depth information is produced at the encoder side in a form of depth pictures (also known as depth maps) for each video frame. A depth map is an image with per-pixel depth information. Each sample in a depth map represents the distance of the respective texture sample from the plane on which the camera lies. In other words, if the z axis is along the shooting axis of the cameras (and hence orthogonal to the plane on which the cameras lie), a sample in a depth map represents the value on the z axis.

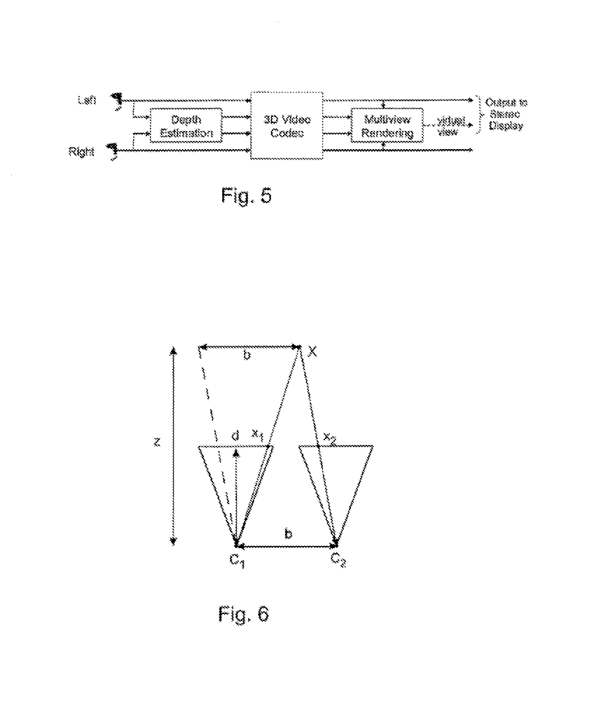

Depth information can be obtained by various means. For example, depth of the 3D scene may be computed from the disparity registered by capturing cameras. A depth estimation algorithm takes a stereoscopic view as an input and computes local disparities between the two offset images of the view. Each image is processed pixel by pixel in overlapping blocks, and for each block of pixels a horizontally localized search for a matching block in the offset image is performed. Once a pixel-wise disparity is computed, the corresponding depth value z is calculated by equation (1):

$$z = \frac{f \cdot b}{d + Δ d} , \qquad ( 1 )$$

where f is the focal length of the camera and b is the baseline distance between cameras, as shown in FIG. 6. Further, d refers to the disparity observed between the two cameras, and the camera offset Δd reflects a possible horizontal misplacement of the optical centers of the two cameras. However, since the algorithm is based on block matching, the quality of a depth-through-disparity estimation is content dependent and very often not accurate. For example, no straightforward solution for depth estimation is possible for image fragments that are featuring very smooth areas with no textures or large level of noise.

Disparity or parallax maps, such as parallax maps specified in ISO/IEC International Standard 23002-3, may be processed similarly to depth maps. Depth and disparity have a straightforward correspondence and they can be computed from each other through mathematical equation.

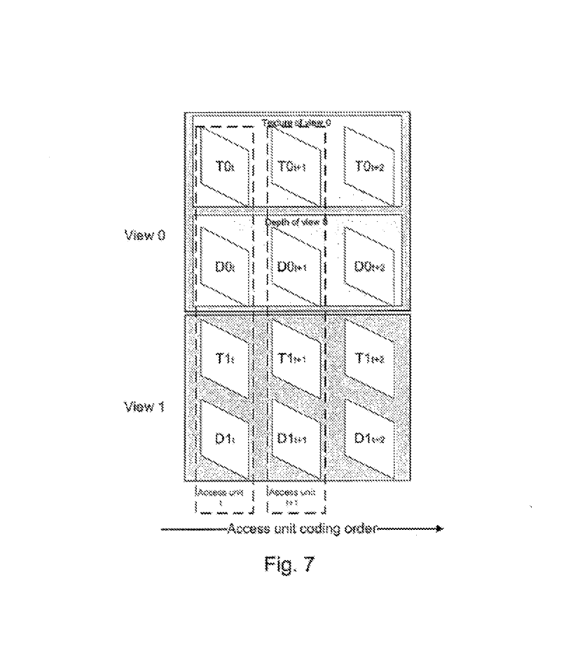

The coding and decoding order of texture and depth view components within an access unit is typically such that the data of a coded view component is not interleaved by any other coded view component, and the data for an access unit is not interleaved by any other access unit in the bitstream/decoding order. For example, there may be two texture and depth views (T0ₜ, T1ₜ, T0ₜ₊₁, T1ₜ₊₁, T0ₜ₊₂, T1ₜ₊₂, D0ₜ, D1ₜ, D0ₜ₊₁, D1ₜ₊₁, D0ₜ₊₂, D1ₜ₊₂) in different access units (t, t+1, t+2), as illustrated in FIG. 7, where the access unit t consisting of texture and depth view components (T0ₜ,T1ₜ, D0ₜ,D1ₜ) precedes in bitstream and decoding order the access unit t+1 consisting of texture and depth view components (T0ₜ₊₁, T1ₜ₊₁, D0ₜ₊₁, D1ₜ₊₁).

The coding and decoding order of view components within an access unit may be governed by the coding format or determined by the encoder. A texture view component may be coded before the respective depth view component of the same view, and hence such depth view components may be predicted from the texture view components of the same view. Such texture view components may be coded for example by MVC encoder and decoder by MVC decoder. An enhanced texture view component refers herein to a texture view component that is coded after the respective depth view component of the same view and may be predicted from the respective depth view component. The texture and depth view components of the same access units are typically coded in view dependency order. Texture and depth view components can be ordered in any order with respect to each other as long as the ordering obeys the mentioned constraints.

Texture views and depth views may be coded into a single bitstream where some of the texture views may be compatible with one or more video standards such as H.264/AVC and/or MVC. In other words, a decoder may be able to decode some of the texture views of such a bitstream and can omit the remaining texture views and depth views.

In this context an encoder that encodes one or more texture and depth views into a single H.264/AVC and/or MVC compatible bitstream is also called as a 3DV-ATM encoder. Bitstreams generated by such an encoder can be referred to as 3DV-ATM bitstreams. The 3DV-ATM bitstreams may include some of the texture views that H.264/AVC and/or MVC decoder cannot decode, and depth views. A decoder capable of decoding all views from 3DV-ATM bitstreams may also be called as a 3DV-ATM decoder.

3DV-ATM bitstreams can include a selected number of AVC/MVC compatible texture views. The depth views for the AVC/MVC compatible texture views may be predicted from the texture views. The remaining texture views may utilize enhanced texture coding and depth views may utilize depth coding.

Many video coding standards specify buffering models and buffering parameters for the bit streams. Such buffering models may be called Hypothetical Reference Decoder (HRD) or Video Buffer Verifier (VBV). A standard compliant bit stream complies with the buffering model with a set of buffering parameters specified in the corresponding standard. Such buffering parameters for a bit stream may be explicitly or implicitly signaled. ‘Implicitly signaled’ means that the default buffering parameter values according to the profile and level apply. The HRD/VBV parameters are used, among other things, to impose constraints on the bit rate variations of compliant bit streams.

HRD conformance checking may concern for example the following two types of bitstreams: The first such type of bitstream, called Type I bitstream, is a NAL unit stream containing only the VCL NAL units and filler data NAL units for all access units in the bitstream. The second type of bitstream, called a Type II bitstream, may contain, in addition to the VCL NAL units and filler data NAL units for all access units in the bitstream, additional non-VCL NAL units other than filler data NAL units and/or syntax elements such as leading_zero_{—}8 bits, zero_byte, start_code_prefix_one_{—}3 bytes, and trailing_zero_{—}8 bits that form a byte stream from the NAL unit stream.

Two types of HRD parameters (NAL HRD parameters and VCL HRD parameters) may be used. The HRD parameter may be indicated through video usability information included in the sequence parameter set syntax structure.

Sequence parameter sets and picture parameter sets referred to in the VCL NAL units, and corresponding buffering period and picture timing SEI messages may be conveyed to the HRD, in a timely manner, either in the bitstream (by non-VCL NAL units), or by out-of-band means externally from the bitstream e.g. using a signalling mechanism, such as media parameters included in the media line of a session description formatted e.g. according to the Session Description Protocol (SDP). For the purpose of counting bits in the HRD, only the appropriate bits that are actually present in the bitstream may be counted. When the content of a non-VCL NAL unit is conveyed for the application by some means other than presence within the bitstream, the representation of the content of the non-VCL NAL unit may or may not use the same syntax as would be used if the non-VCL NAL unit were in the bitstream.

The HRD may contain a coded picture buffer (CPB), an instantaneous decoding process, a decoded picture buffer (DPB), and output cropping.

The CPB may operate on decoding unit basis. A decoding unit may be an access unit or it may be a subset of an access unit, such as an integer number of NAL units. The selection of the decoding unit may be indicated by an encoder in the bitstream.

The HRD may operate as follows. Data associated with decoding units that flow into the CPB according to a specified arrival schedule may be delivered by the Hypothetical Stream Scheduler (HSS). The arrival schedule may be determined by the encoder and indicated for example through picture timing SEI messages, and/or the arrival schedule may be derived for example based on a bitrate which may be indicated for example as part of HRD parameters in video usability information. The HRD parameter in video usability information may contain many sets of parameters, each for different bitrate or delivery schedule. The data associated with each decoding unit may be removed and decoded instantaneously by the instantaneous decoding process at CPB removal times. A CPB removal time may be determined for example using an initial CPB buffering delay, which may be determined by the encoder and indicated for example through a buffering period SEI message, and differential removal delays indicated for each picture for example though picture timing SEI messages. Each decoded picture is placed in the DPB. A decoded picture may be removed from the DPB at the later of the DPB output time or the time that it becomes no longer needed for inter-prediction reference. Thus, the operation of the CPB of the HRD may comprise timing of bitstream arrival, timing of decoding unit removal and decoding of decoding unit, whereas the operation of the DPB of the HRD may comprise removal of pictures from the DPB, picture output, and current decoded picture marking and storage.

The HRD may be used to check conformance of bitstreams and decoders.

Bitstream conformance requirements of the HRD may comprise for example the following and/or alike. The CPB is required not to overflow (relative to the size which may be indicated for example within HRD parameters of video usability information) or underflow (i.e. the removal time of a decoding unit cannot be smaller than the arrival time of the last bit of that decoding unit). The number of pictures in the DPB may be required to be smaller than or equal to a certain maximum number, which may be indicated for example in the sequence parameter set. All pictures used as prediction references may be required to be present in the DPB. It may be required that the interval for outputting consecutive pictures from the DPB is not smaller than a certain minimum.

Decoder conformance requirements of the HRD may comprise for example the following and/or alike. A decoder claiming conformance to a specific profile and level may be required to decode successfully all conforming bitstreams specified for decoder conformance provided that all sequence parameter sets and picture parameter sets referred to in the VCL NAL units, and appropriate buffering period and picture timing SEI messages are conveyed to the decoder, in a timely manner, either in the bitstream (by non-VCL NAL units), or by external means. There may be two types of conformance that can be claimed by a decoder: output timing conformance and output order conformance.

To check conformance of a decoder, test bitstreams conforming to the claimed profile and level may be delivered by a hypothetical stream scheduler (HSS) both to the HRD and to the decoder under test (DUT). All pictures output by the HRD may also be required to be output by the DUT and, for each picture output by the HRD, the values of all samples that are output by the DUT for the corresponding picture may also be required to be equal to the values of the samples output by the HRD.

For output timing decoder conformance, the HSS may operate e.g. with delivery schedules selected from those indicated in the HRD parameters of video usability information, or with “interpolated” delivery schedules. The same delivery schedule may be used for both the HRD and DUT. For output timing decoder conformance, the timing (relative to the delivery time of the first bit) of picture output may be required to be the same for both HRD and the DUT up to a fixed delay.

For output order decoder conformance, the HSS may deliver the bitstream to the DUT “by demand” from the DUT, meaning that the HSS delivers bits (in decoding order) only when the DUT requires more bits to proceed with its processing. The HSS may deliver the bitstream to the HRD by one of the schedules specified in the bitstream such that the bit rate and CPB size are restricted. The order of pictures output may be required to be the same for both HRD and the DUT.

In SVC, a buffering period SEI message that initiates the HRD is chosen as follows. When an access unit contains one or more buffering period SEI messages that are included in scalable nesting SEI messages and are associated with values of DQId in the range of ((DQIdMax>>4)<<4) to (((DQIdMax>>4)<<4)+15), inclusive, the last of these buffering period SEI messages in decoding order is the buffering period SEI message that initialises the HRD. Let hrdDQId be the largest value of 16*sei_dependency_id[i]+sei_quality_id[i] that is associated with the scalable nesting SEI message containing the buffering period SEI message that initialises the HRD, let hrdDId and hrdQId be equal to hrdDQId>>4 and hrdDQId & 15, respectively, and let hrdTId be the value of sei_temporal_id that is associated with the scalable nesting SEI message containing the buffering period SEI message that initialises the HRD. In SVC, the picture timing SEI messages that specify the removal timing of access units from the CPB and output timing from the DPB are the picture timing SEI messages that are included in scalable nesting SEI messages associated with values of sei_dependency_id[i], sei_quality_id[i], and sei_temporal_id equal to hrdDId, hrdQId, and hrdTId, respectively. In SVC, the HRD parameter sets that are used for conformance checking are the HRD parameter sets included in the SVC video usability information extension of the active SVC sequence parameter set that are associated with values of vui_ext_dependency_id[i], vui_ext_quality_id[i], and vui_ext_temporal_id[i] equal to hrdDId, hrdQId, and hrdTId, respectively.

In SVC, the video usability information is extended to selectively include timing information, HRD parameter sets, and the presence of picture structure information for bitstream subsets of coded video sequences (including the complete coded video sequences). Any number of bitstream subsets for which the extended VUI is provided may be selected by the encoder and indicated in the VUI parameters extension. Each such bitstream subset is characterized by values of dependency_id, quality_id and temporal_id, which are included in the vui_ext_dependency_id[i], vui_ext_quality[i] and vui_ext_temporal_id[i] syntax elements, respectively, where i is an index for a bitstream subset. The bitstream subset with index i for which the timing information, HRD parameter sets, and the presence of picture structure information may be given can be obtained by applying the sub-bitstream extraction process with vui_ext_dependency_id[i], vui_ext_quality[i] and vui_ext_temporal_id[i] as inputs.

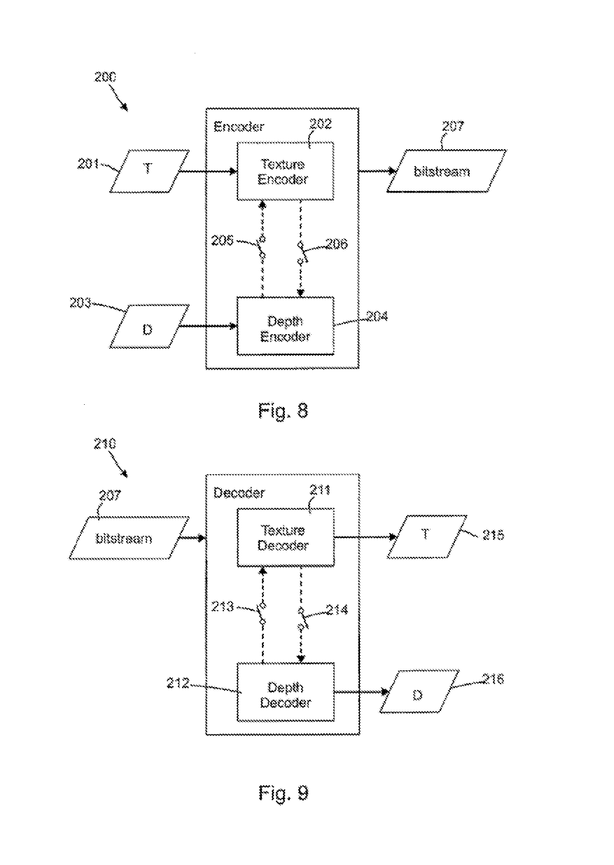

A high level flow chart of an embodiment of an encoder 200 capable of encoding texture views and depth views is presented in FIG. 8 and a decoder 210 capable of decoding texture views and depth views is presented in FIG. 9. On these figures solid lines depict general data flow and dashed lines show control information signaling. The encoder 200 may receive texture components 201 to be encoded by a texture encoder 202 and depth map components 203 to be encoded by a depth encoder 204. When the encoder 200 is encoding texture components according to AVC/MVC a first switch 205 may be switched off. When the encoder 200 is encoding enhanced texture components the first switch 205 may be switched on so that information generated by the depth encoder 204 may be provided to the texture encoder 202. The encoder of this example also comprises a second switch 206 which may be operated as follows. The second switch 206 is switched on when the encoder is encoding depth information of AVC/MVC views, and the second switch 206 is switched off when the encoder is encoding depth information of enhanced texture views. The encoder 200 may output a bitstream 207 containing encoded video information.

The decoder 210 may operate in a similar manner but at least partly in a reversed order. The decoder 210 may receive the bitstream 207 containing encoded video information. The decoder 210 comprises a texture decoder 211 for decoding texture information and a depth decoder 212 for decoding depth information. A third switch 213 may be provided to control information delivery from the depth decoder 212 to the texture decoder 211, and a fourth switch 214 may be provided to control information delivery from the texture decoder 211 to the depth decoder 212. When the decoder 210 is to decode AVC/MVC texture views the third switch 213 may be switched off and when the decoder 210 is to decode enhanced texture views the third switch 213 may be switched on. When the decoder 210 is to decode depth of AVC/MVC texture views the fourth switch 214 may be switched on and when the decoder 210 is to decode depth of enhanced texture views the fourth switch 214 may be switched off. The Decoder 210 may output reconstructed texture components 215 and reconstructed depth map components 216.

Many video encoders utilize the Lagrangian cost function to find rate-distortion optimal coding modes, for example the desired macroblock mode and associated motion vectors. This type of cost function uses a weighting factor or 2 to tie together the exact or estimated image distortion due to lossy coding methods and the exact or estimated amount of information required to represent the pixel/sample values in an image area. The Lagrangian cost function may be represented by the equation:

C=D+λR

where C is the Lagrangian cost to be minimised, D is the image distortion (for example, the mean-squared error between the pixel/sample values in original image block and in coded image block) with the mode and motion vectors currently considered, λ is a Lagrangian coefficient and R is the number of bits needed to represent the required data to reconstruct the image block in the decoder (including the amount of data to represent the candidate motion vectors).

A coding standard or specification may include a sub-bitstream extraction process, and such is specified for example in SVC, MVC, and HEVC. The sub-bitstream extraction process relates to converting a bitstream by removing NAL units to a sub-bitstream. The sub-bitstream still remains conforming to the standard. For example, in a draft HEVC standard, the bitstream created by excluding all VCL NAL units having a temporal_id greater than or equal to a selected value and including all other VCL NAL units remains conforming. Consequently, a picture having temporal_id equal to TID does not use any picture having a temporal_id greater than TID as inter prediction reference.

A first profile of a coding standard or specification, such as the Baseline Profile of H.264/AVC, may be specified to include only certain types of pictures or coding modes, such as intra (I) and inter (P) pictures or coding modes. A second profile of the coding standard or specification, such as the High Profile of H.264/AVC, may be specified to include a greater variety of types of pictures or coding modes, such as intra, inter, and bi-predictive (B) pictures or coding modes. A bitstream conform to the second profile, while a bitstream comprising a subset of the pictures may also conform to the first profile. For example, a common group of pictures pattern is IBBP, i.e., between each intra (I) or inter (P) reference frame, there are two non-reference (B) frames. The base layer in this case may consist of reference frames. The entire bit stream may comply with the High Profile (which includes the B picture feature), whereas the base layer bit stream may also comply with the Baseline Profile (which excludes the B picture feature).

A sub-bitstream extraction process may be used for multiple purposes, some of which are described as examples below. In the first example, a multimedia message is created for which the entire bit stream complies to particular profile and level and the bitstream subset consisting of the base layer complies with another profile and level. At the time of creation, the originating terminal does not know the capability of the receiving terminal. A Multimedia Messaging Service Center (MMSC) or alike, in contrast, knows the capability of the receiving terminal and is responsible of adapting the message accordingly. In this example, the receiving terminal is capable of decoding the bitstream subset consisting of the base layer but not the entire bitstream. Consequently, the adaptation process using the present invention requires merely stripping off or removing the NAL units with a scalability layer identifier indicating a higher layer than the base layer according to a sub-bitstream extraction process.

In a second example, a scalable bit stream is coded and stored in a streaming server. Profile and level and possibly also the HRD/VBV parameters of each layer are signaled in the stored file. When describing the available session, the server can create a description e.g. according to the Session Description Protocol (SDP) or Media Presentation Description (MPD) or alike for each layer or alternative of the scalable bit stream in the same file such that a streaming client can conclude whether there is an ideal layer and choose an ideal layer for streaming playback according to the SDP descriptions or alike. If the server has no prior knowledge on receiver capabilities, it is advantageous to create multiple SDP descriptions or alike from the same content, and these descriptions are then called alternate. The client can then pick the description that suits its capabilities the best. If the server knows the receiver capabilities (e.g., using the UAProf mechanism specified in 3GPP TS 26.234), the server preferably chooses the most suitable profile and level for the receiver among the profiles and levels of the entire bit stream and all substreams. A sub-bitstream extraction process may be carried out to conclude data to be transmitted such that it matches the chosen SDP description or alike.

In a third example, a stream such as that described in the second example, is multicast or broadcast to multiple terminals. The multicast/broadcast server can announce all the available layers or decoding and playback alternatives, each of which is characterized by a combination of profile and level and possibly also HRD/VBV parameters. The client can then know from the broadcast/multicast session announcement whether there is an ideal layer for it and choose an ideal layer for playback. A sub-bitstream extraction process can be used to conclude the elementary data units, such as NAL units, to be transmitted within each multicast group or alike.

In a fourth example of the use of the present invention, for local playback applications, even though the entire signaled stream cannot be decoded, it is still possible to decode and enjoy part of the stream. Typically if the player gets to know that the entire stream is of a set of profile and level and HRD/VBV parameters it is not capable to decode, it just gives up the decoding and playback. Alternatively or in addition, a user may have selected a fast-forward or fast-backward play operation, and the player may choose a level such that it can decode the data faster than real-time. A sub-bitstream extraction process may be carried out when the player has chosen a layer that is not the highest layer of the bitstream.

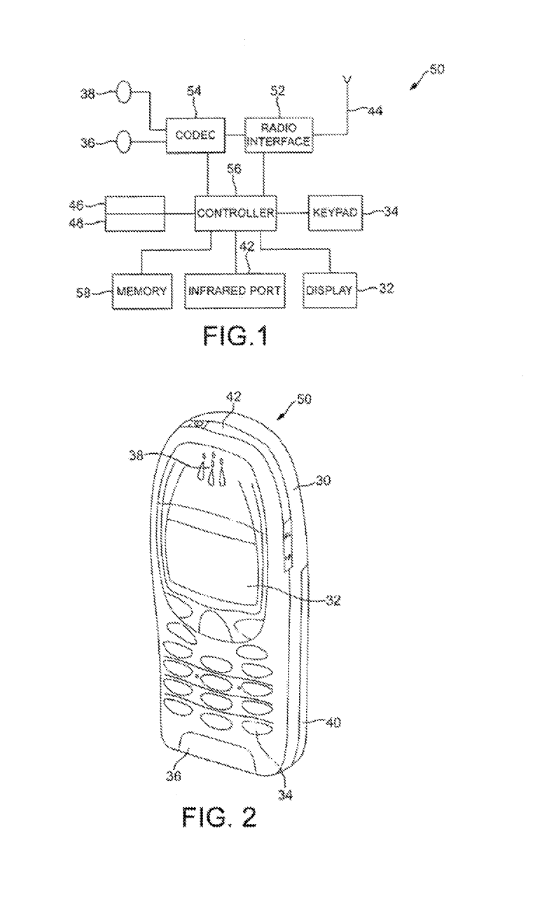

FIG. 1 shows a block diagram of a video coding system according to an example embodiment as a schematic block diagram of an exemplary apparatus or electronic device 50, which may incorporate a codec according to an embodiment of the invention. FIG. 2 shows a layout of an apparatus according to an example embodiment. The elements of FIGS. 1 and 2 will be explained next.

The electronic device 50 may for example be a mobile terminal or user equipment of a wireless communication system. However, it would be appreciated that embodiments of the invention may be implemented within any electronic device or apparatus which may require encoding and decoding or encoding or decoding video images. For example, in some embodiments, the apparatus may be embodied as a chip or chip set (which may in turn be employed at one of the devices mentioned above). In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry comprised thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The apparatus 50 may comprise a housing 30 for incorporating and protecting the device. The apparatus 50 further may comprise a display 32 in the form of a liquid crystal display. In other embodiments of the invention the display may be any suitable display technology suitable to display an image or video. The apparatus 50 may further comprise a keypad 34. In other embodiments of the invention any suitable data or user interface mechanism may be employed. For example the user interface may be implemented as a virtual keyboard or data entry system as part of a touch-sensitive display. The apparatus may comprise a microphone 36 or any suitable audio input which may be a digital or analogue signal input. The apparatus 50 may further comprise an audio output device which in embodiments of the invention may be any one of: an earpiece 38, speaker, or an analogue audio or digital audio output connection. The apparatus 50 may also comprise a battery 40 (or in other embodiments of the invention the device may be powered by any suitable mobile energy device such as solar cell, fuel cell or clockwork generator). The apparatus may further comprise an infrared port 42 for short range line of sight communication to other devices. In other embodiments the apparatus 50 may further comprise any suitable short range communication solution such as for example a Bluetooth wireless connection or a USB/firewire wired connection.

The apparatus 50 may comprise a controller or processor (with controller and processor being used synonomously herein with either or both being designated as 56) for controlling the apparatus 50. The controller 56 may be connected to memory 58 which in embodiments of the invention may store both data in the form of image and audio data and/or may also store instructions for implementation on the controller 56. The controller 56 may further be connected to codec circuitry 54 suitable for carrying out coding and decoding of audio and/or video data or assisting in coding and decoding carried out by the controller 56.

The processor 56 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may comprise one or more processing cores configured to perform independently. A multi-core processor may enable multiprocessing within a single physical package. Additionally or alternatively, the processor may comprise one or more processors configured in tandem via the bus to enable independent execution of instructions, pipelining and/or multithreading.

In an example embodiment, the processor 56 may be configured to execute instructions stored in the memory device 58 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a computing device) adapted for employing an embodiment of the present invention by further configuration of the processor by instructions for performing the algorithms and/or operations described herein. The processor may comprise, among other things, a clock, an arithmetic logic unit (ALU) and logic gates configured to support operation of the processor.

The memory 58 may comprise, for example, a non-transitory memory, such as one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, applications, instructions or the like for enabling the apparatus to carry out various functions in accordance with example embodiments of the present invention. For example, the memory device could be configured to buffer input data for processing by the processor. Additionally or alternatively, the memory device could be configured to store instructions for execution by the processor 56. The apparatus 50 may further comprise a card reader 48 and a smart card 46, for example a UICC and UICC reader for providing user information and being suitable for providing authentication information for authentication and authorization of the user at a network.

The apparatus 50 may comprise a communication interface which may be any means such as a device or circuitry embodied in either hardware or a combination of hardware and software that is configured to receive and/or transmit data from/to the apparatus. In this regard, the communication interface may comprise, for example, radio interface circuitry 52 connected to the controller 56 and suitable for generating wireless communication signals for example for communication with a cellular communications network, a wireless communications system or a wireless local area network. The communication interface of the apparatus 50 may further comprise an antenna 44 connected to the radio interface circuitry 52 for transmitting radio frequency signals generated at the radio interface circuitry 52 to other apparatus(es) and for receiving radio frequency signals from other apparatus(es). In some environments, the communication interface may alternatively or also support wired communication. As such, for example, the communication interface may comprise a communication modem and/or other hardware/software for supporting communication via cable, digital subscriber line (DSL), USB or other mechanisms.

In some embodiments of the invention, the apparatus 50 comprises a camera capable of recording or detecting individual frames which are then passed to the codec 54 or controller for processing. In some embodiments of the invention, the apparatus may receive the video image data for processing from another device prior to transmission and/or storage. In some embodiments of the invention, the apparatus 50 may receive either wirelessly or by a wired connection the image for coding/decoding.

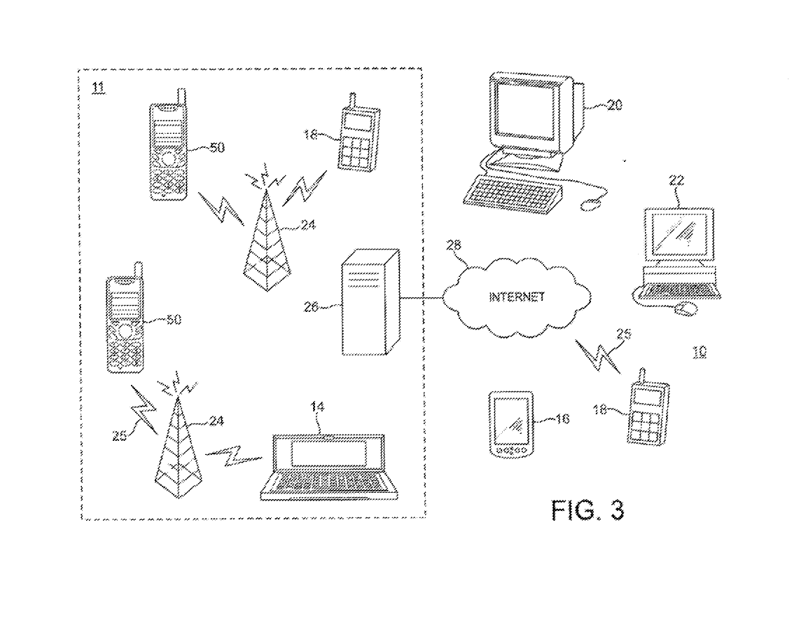

FIG. 3 shows an arrangement for video coding comprising a plurality of apparatuses, networks and network elements according to an example embodiment. With respect to FIG. 3, an example of a system within which embodiments of the present invention can be utilized is shown. The system 10 comprises multiple communication devices which can communicate through one or more networks. The system 10 may comprise any combination of wired or wireless networks including, but not limited to a wireless cellular telephone network (such as a GSM, UMTS, CDMA network etc), a wireless local area network (WLAN) such as defined by any of the IEEE 802.x standards, a Bluetooth personal area network, an Ethernet local area network, a token ring local area network, a wide area network, and the Internet.

The system 10 may include both wired and wireless communication devices or apparatus 50 suitable for implementing embodiments of the invention. For example, the system shown in FIG. 3 shows a mobile telephone network 11 and a representation of the internet 28. Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an electronic device or apparatus 50, a combination of a personal digital assistant (PDA) and a mobile telephone 14, a PDA 16, an integrated messaging device (IMD) 18, a desktop computer 20, a notebook computer 22. The apparatus 50 may be stationary or mobile when carried by an individual who is moving. The apparatus 50 may also be located in a mode of transport including, but not limited to, a car, a truck, a taxi, a bus, a train, a boat, an airplane, a bicycle, a motorcycle or any similar suitable mode of transport.

Some or further apparatuses may send and receive calls and messages and communicate with service providers through a wireless connection 25 to a base station 24. The base station 24 may be connected to a network server 26 that allows communication between the mobile telephone network 11 and the internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11 and any similar wireless communication technology. A communications device involved in implementing various embodiments of the present invention may communicate using various media including, but not limited to, radio, infrared, laser, cable connections, and any suitable connection.

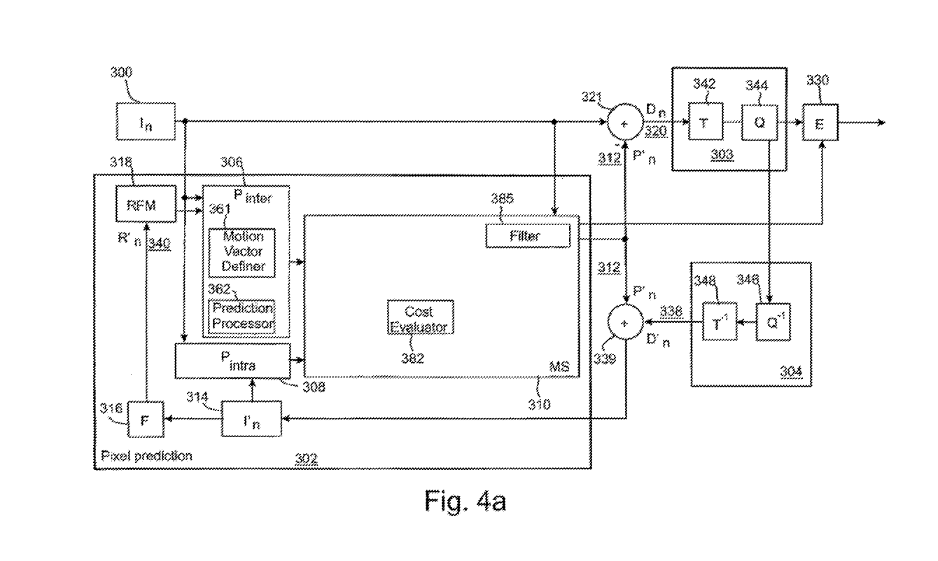

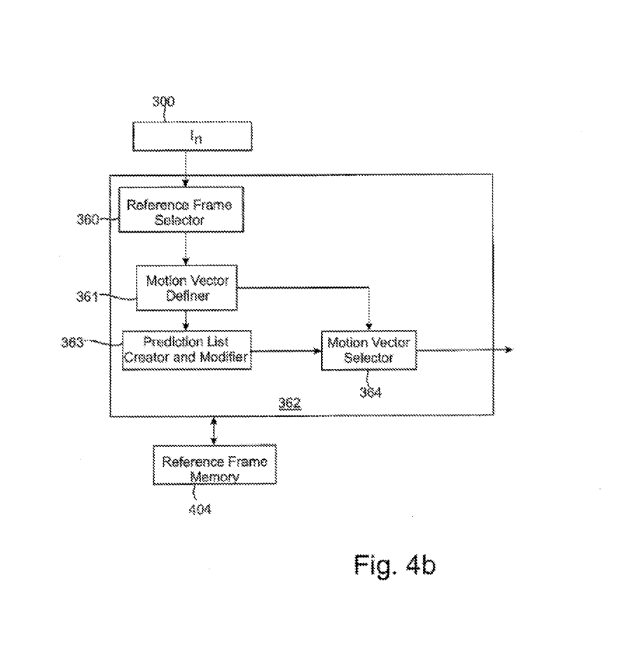

FIGS. 4a and 4b show block diagrams for video encoding and decoding according to an example embodiment.

FIG. 4a shows the encoder as comprising a pixel predictor 302, prediction error encoder 303 and prediction error decoder 304. FIG. 4a also shows an embodiment of the pixel predictor 302 as comprising an inter-predictor 306, an intra-predictor 308, a mode selector 310, a filter 316, and a reference frame memory 318. In this embodiment the mode selector 310 comprises a block processor 381 and a cost evaluator 382. The encoder may further comprise an entropy encoder 330 for entropy encoding the bit stream.

FIG. 4b depicts an embodiment of the inter predictor 306. The inter predictor 306 comprises a reference frame selector 360 for selecting reference frame or frames, a motion vector definer 361, a prediction list former 363 and a motion vector selector 364. These elements or some of them may be part of a prediction processor 362 or they may be implemented by using other means.

The pixel predictor 302 receives the image 300 to be encoded at both the inter-predictor 306 (which determines the difference between the image and a motion compensated reference frame 318) and the intra-predictor 308 (which determines a prediction for an image block based only on the already processed parts of a current frame or picture). The output of both the inter-predictor and the intra-predictor are passed to the mode selector 310. Both the inter-predictor 306 and the intra-predictor 308 may have more than one intra-prediction modes. Hence, the inter-prediction and the intra-prediction may be performed for each mode and the predicted signal may be provided to the mode selector 310. The mode selector 310 also receives a copy of the image 300.

The mode selector 310 determines which encoding mode to use to encode the current block. If the mode selector 310 decides to use an inter-prediction mode it will pass the output of the inter-predictor 306 to the output of the mode selector 310. If the mode selector 310 decides to use an intra-prediction mode it will pass the output of one of the intra-predictor modes to the output of the mode selector 310.

The mode selector 310 may use, in the cost evaluator block 382, for example Lagrangian cost functions to choose between coding modes and their parameter values, such as motion vectors, reference indexes, and intra prediction direction, typically on block basis. This kind of cost function uses a weighting factor lambda to tie together the (exact or estimated) image distortion due to lossy coding methods and the (exact or estimated) amount of information that is required to represent the pixel values in an image area: C=D+lambda×R, where C is the Lagrangian cost to be minimized, D is the image distortion (e.g. Mean Squared Error) with the mode and their parameters, and R the number of bits needed to represent the required data to reconstruct the image block in the decoder (e.g. including the amount of data to represent the candidate motion vectors).

The output of the mode selector is passed to a first summing device 321. The first summing device may subtract the pixel predictor 302 output from the image 300 to produce a first prediction error signal 320 which is input to the prediction error encoder 303.

The pixel predictor 302 further receives from a preliminary reconstructor 339 the combination of the prediction representation of the image block 312 and the output 338 of the prediction error decoder 304. The preliminary reconstructed image 314 may be passed to the intra-predictor 308 and to a filter 316. The filter 316 receiving the preliminary representation may filter the preliminary representation and output a final reconstructed image 340 which may be saved in a reference frame memory 318. The reference frame memory 318 may be connected to the inter-predictor 306 to be used as the reference image against which the future image 300 is compared in inter-prediction operations. In many embodiments the reference frame memory 318 may be capable of storing more than one decoded picture, and one or more of them may be used by the inter-predictor 306 as reference pictures against which the future images 300 are compared in inter prediction operations. The reference frame memory 318 may in some cases be also referred to as the Decoded Picture Buffer.

The operation of the pixel predictor 302 may be configured to carry out any known pixel prediction algorithm known in the art.

The pixel predictor 302 may also comprise a filter 385 to filter the predicted values before outputting them from the pixel predictor 302.

The operation of the prediction error encoder 302 and prediction error decoder 304 will be described hereafter in further detail. In the following examples the encoder generates images in terms of 16×16 pixel macroblocks which go to form the full image or picture. However, it is noted that FIG. 4a is not limited to block size 16×16, but any block size and shape can be used generally, and likewise FIG. 4a is not limited to partitioning of a picture to macroblocks but any other picture partitioning to blocks, such as coding units, may be used. Thus, for the following examples the pixel predictor 302 outputs a series of predicted macroblocks of size 16×16 pixels and the first summing device 321 outputs a series of 16×16 pixel residual data macroblocks which may represent the difference between a first macroblock in the image 300 against a predicted macroblock (output of pixel predictor 302).

The prediction error encoder 303 comprises a transform block 342 and a quantizer 344. The transform block 342 transforms the first prediction error signal 320 to a transform domain. The transform is, for example, the DCT transform or its variant. The quantizer 344 quantizes the transform domain signal, e.g. the DCT coefficients, to form quantized coefficients.

The prediction error decoder 304 receives the output from the prediction error encoder 303 and produces a decoded prediction error signal 338 which when combined with the prediction representation of the image block 312 at the second summing device 339 produces the preliminary reconstructed image 314. The prediction error decoder may be considered to comprise a dequantizer 346, which dequantizes the quantized coefficient values, e.g. DCT coefficients, to reconstruct the transform signal approximately and an inverse transformation block 348, which performs the inverse transformation to the reconstructed transform signal wherein the output of the inverse transformation block 348 contains reconstructed block(s). The prediction error decoder may also comprise a macroblock filter (not shown) which may filter the reconstructed macroblock according to further decoded information and filter parameters.

In the following the operation of an example embodiment of the inter predictor 306 will be described in more detail. The inter predictor 306 receives the current block for inter prediction. It is assumed that for the current block there already exists one or more neighboring blocks which have been encoded and motion vectors have been defined for them. For example, the block on the left side and/or the block above the current block may be such blocks. Spatial motion vector predictions for the current block can be formed e.g. by using the motion vectors of the encoded neighboring blocks and/or of non-neighbor blocks in the same slice or frame, using linear or non-linear functions of spatial motion vector predictions, using a combination of various spatial motion vector predictors with linear or non-linear operations, or by any other appropriate means that do not make use of temporal reference information. It may also be possible to obtain motion vector predictors by combining both spatial and temporal prediction information of one or more encoded blocks. These kinds of motion vector predictors may also be called as spatio-temporal motion vector predictors.

Reference frames used in encoding may be stored to the reference frame memory. Each reference frame may be included in one or more of the reference picture lists, within a reference picture list, each entry has a reference index which identifies the reference frame. When a reference frame is no longer used as a reference frame it may be removed from the reference frame memory or marked as “unused for reference” or a non-reference frame wherein the storage location of that reference frame may be occupied for a new reference frame.

As described above, an access unit may contain slices of different component types (e.g. primary texture component, redundant texture component, auxiliary component, depth/disparity component), of different views, and of different scalable layers.

It has been proposed that at least a subset of syntax elements that have conventionally been included in a slice header are included in a GOS (Group of Slices) parameter set by an encoder. An encoder may code a GOS parameter set as a NAL unit. GOS parameter set NAL units may be included in the bitstream together with for example coded slice NAL units, but may also be carried out-of-band as described earlier in the context of other parameter sets.

The GOS parameter set syntax structure may include an identifier, which may be used when referring to a particular GOS parameter set instance for example from a slice header or another GOS parameter set. Alternatively, the GOS parameter set syntax structure does not include an identifier but an identifier may be inferred by both the encoder and decoder for example using the bitstream order of GOS parameter set syntax structures and a pre-defined numbering scheme.

The encoder and the decoder may infer the contents or the instance of GOS parameter set from other syntax structures already encoded or decoded or present in the bitstream. For example, the slice header of the texture view component of the base view may implicitly form a GOS parameter set. The encoder and decoder may infer an identifier value for such inferred GOS parameter sets. For example, the GOS parameter set formed from the slice header of the texture view component of the base view may be inferred to have identifier value equal to 0.

A GOS parameter set may be valid within a particular access unit associated with it. For example, if a GOS parameter set syntax structure is included in the NAL unit sequence for a particular access unit, where the sequence is in decoding or bitstream order, the GOS parameter set may be valid from its appearance location until the end of the access unit. Alternatively, a GOS parameter set may be valid for many access units.

The encoder may encode many GOS parameter sets for an access unit. The encoder may determine to encode a GOS parameter set if it is known, expected, or estimated that at least a subset of syntax element values in a slice header to be coded would be the same in a subsequent slice header.

A limited numbering space may be used for the GOS parameter set identifier. For example, a fixed-length code may be used and may be interpreted as an unsigned integer value of a certain range. The encoder may use a GOS parameter set identifier value for a first GOS parameter set and subsequently for a second GOS parameter set, if the first GOS parameter set is subsequently not referred to for example by any slice header or GOS parameter set. The encoder may repeat a GOS parameter set syntax structure within the bitstream for example to achieve a better robustness against transmission errors.

In many embodiments, syntax elements which may be included in a GOS parameter set are conceptually collected in sets of syntax elements. A set of syntax elements for a GOS parameter set may be formed for example on one or more of the following basis:
Syntax elements indicating a scalable layer and/or other scalability features
Syntax elements indicating a view and/or other multiview features
Syntax elements related to a particular component type, such as depth/disparity
Syntax elements related to access unit identification, decoding order and/or output order and/or other syntax elements which may stay unchanged for all slices of an access unit
Syntax elements which may stay unchanged in all slices of a view component
Syntax elements related to reference picture list modification
Syntax elements related to the reference picture set used
Syntax elements related to decoding reference picture marking
Syntax elements related to prediction weight tables for weighted prediction
Syntax elements for controlling deblocking filtering
Syntax elements for controlling adaptive loop filtering
Syntax elements for controlling sample adaptive offset
Any combination of sets above

For each syntax element set, the encoder may have one or more of the following options when coding a GOS parameter set:

The syntax element set may be coded into a GOS parameter set syntax structure, i.e. coded syntax element values of the syntax element set may be included in the GOS parameter set syntax structure.
The syntax element set may be included by reference into a GOS parameter set. The reference may be given as an identifier to another GOS parameter set. The encoder may use a different reference GOS parameter set for different syntax element sets.
The syntax element set may be indicated or inferred to be absent from the GOS parameter set.

The options from which the encoder is able to choose for a particular syntax element set when coding a GOS parameter set may depend on the type of the syntax element set. For example, a syntax element set related to scalable layers may always be present in a GOS parameter set, while the set of syntax elements which may stay unchanged in all slices of a view component may not be available for inclusion by reference but may be optionally present in the GOS parameter set and the syntax elements related to reference picture list modification may be included by reference in, included as such in, or be absent from a GOS parameter set syntax structure. The encoder may encode indications in the bitstream, for example in a GOS parameter set syntax structure, which option was used in encoding. The code table and/or entropy coding may depend on the type of the syntax element set. The decoder may use, based on the type of the syntax element set being decoded, the code table and/or entropy decoding that is matched with the code table and/or entropy encoding used by the encoder.

The encoder may have multiple means to indicate the association between a syntax element set and the GOS parameter set used as the source for the values of the syntax element set. For example, the encoder may encode a loop of syntax elements where each loop entry is encoded as syntax elements indicating a GOS parameter set identifier value used as a reference and identifying the syntax element sets copied from the reference GOP parameter set. In another example, the encoder may encode a number of syntax elements, each indicating a GOS parameter set. The last GOS parameter set in the loop containing a particular syntax element set is the reference for that syntax element set in the GOS parameter set the encoder is currently encoding into the bitstream. The decoder parses the encoded GOS parameter sets from the bitstream accordingly so as to reproduce the same GOS parameter sets as the encoder.

It has been proposed to have a partial updating mechanism for the Adaptation Parameter Set in order to reduce the size of APS NAL units and hence to spend a smaller bitrate for conveying APS NAL units. Although the APS provides an effective approach to share picture-adaptive information common at the slice level, coding of APS NAL units independently may be suboptimal when only a part of the APS parameters changes compared to one or more earlier Adaptation Parameter Sets.

In document JCTVC-H0069 (http://phenix.int-evry.fr/jct/doc_end_user/documents/8_San %20Jose/wg11/JCTVC-H0069-v4.zip), the APS syntax structure is subdivided into a number of groups of syntax elements, each associated with a certain coding technology (such as Adaptive In-Loop Filter (ALF), or Sample Adaptive Offset (SAO)). Each of these groups in the APS syntax structure is preceded by a flag indicating their respective presence. The APS syntax structure also includes a conditional reference to another APS. A ref aps_flag signals the presence of a reference ref_aps_id referred to by the current APS. With this link mechanism, a linked list of multiple APSs can be created. The decoding process during APS activation uses the reference in the slice header to address the first APS of the linked list. Those groups of syntax elements for which the associated flag (such as the aps_adaptive_loop_filter_data_present_flag) is set, are decoded from the subject APS. After this decoding, the linked list is followed to the next linked APS (if any—as indicated by ref aps_flag equal to 1). Only those groups which were not signaled as present previously, but are signaled as present in the current APS, are decoded from the current APS. The mechanism continues along the list of linked APSs until one of three conditions are met: (1) all required groups of syntax elements (as indicated by SPS, PPS, or profile/level) have been decoded from the linked APS chain, (2) the end of the list is detected, and (3) a fixed, probably profile-dependent, number of links have been followed—the number could be as small as one. If there are any groups that are not signaled as present in any of the linked APSs, the related decoding tool is not used for this picture. Condition (2) prevents circular referencing loops. The complexity of the referencing mechanism is further limited by the finite size of the APS table. In JCTVC-H0069, the de-referencing, i.e. resolving the source for each group of syntax elements, is proposed to be performed each time an APS is activated, typically once at the beginning of decoding a slice.

It has also been proposed in document JCTVC-H0255 to include multiple APS identifiers in the slice header, each specifying the source APS for certain groups of syntax elements, e.g. one APS being the source for quantization matrices and another APS being the source for ALF parameters. In document JCTVC-H0381, a “copy” flag for each type of APS parameters was proposed, which allows copying that type of APS parameters from another APS. In document JCTVC-H0505, a Group Parameter Set (GPS) was introduced, which collects parameter set identifiers of different types of parameter sets (SPS, PPS, APS) and may contain multiple APS parameter set identifiers. Furthermore, it was proposed in JCTVC-H0505 that a slice header contains a GPS identifier to be used for decoding of the slice instead of individual PPS, and APS identifiers.

An APS partial updating mechanism has been proposed also in document JCTVC-I0070 as outlined in the following. The encoder specifies the value range of aps_id values with the max_aps_id syntax element within the sequence parameter set. In other words, the value of aps_id may be in the range of 0 to max_aps_id, inclusive. The encoder also specifies a range of aps_id values that are considered “used” and indicates that range to the decoder in max_aps_id_diff. The range is relative to the latest received APS NAL unit and hence specifies a kind of a sliding window of valid aps_id values. APS NAL units that have an aps_id value outside the sliding-window range are considered “unused” and a new APS NAL unit with the same aps_id value may be transmitted. Each received APS NAL unit updates the position of the sliding-window range of aps_id values considered “used”. It is recommended that encoders increment aps_id value by 1 relative to that in the previous APS NAL unit in decoding order. As aps_id values may wrap over, modulo arithmetic is used in determining the aps_id values within the sliding-window range. Thanks to the controlled marking which aps_id values can be reused for new APS NAL units, the number of APSes is limited to (max_aps_id_diff+1) and losses of APS NAL units e.g. during transmission can be detected. It has been proposed in JCTVC-I0070 that the APS syntax includes a possibility to copy any group of syntax elements (QM, deblocking filter, SAO, ALF) from either the same APS or from different APSes, indicated by their aps_id value, while the referred APSes are required to be marked as “used”. The partial update references are proposed to be resolved at the time of decoding the APS NAL unit, i.e. the APS is decoded by copying the referenced data from the indicated source APS into the APS being decoded. In other words, the references to other APS NAL units are resolved only once.

While background has been explained above with relation to SVC, for example when it comes to parameter set activation, SEI messages HRD parameters, as well as buffering period and picture timing SEI messages, it should be understood that similar processes and syntax structures exist also for MVC.

We have discovered at least the following challenges and shortcomings in the design of SVC and MVC:
1. In a sequence parameter set RBSP that is referred to by the base layer, the level has to be set to cover also the bitrate caused by the enhancement-layer NAL units, because H.264/AVC decoders without SVC capability will activate that sequence parameter set RBSP and hence the bitrate inferred by the level should cover the bitrate of the entire bitstream. Similarly, in a sequence parameter set RBSP that is referred to by the base view, the level has to be set to cover also the bitrate caused by the non-base-view NAL units, because H.264/AVC decoders without MVC capability will activate that sequence parameter set RBSP. The level may therefore be unnecessarily high for decoders that can access the bitstream fast enough and skip enhancement-layer NAL units or non-base-view NAL units, e.g. typically decoders reading a bitstream from a file. A level for the bitstream subset consisting of the base layer only may be indicated by the scalability information SEI message (for SVC) or view scalability information SEI message (for MVC), but H.264/AVC decoders are unlikely to decode those SEI messages, because they have been specified in the SVC and MVC extensions, respectively.
2. As described above, only the profile and level related indications, profile compatibility indications, HRD parameters, and picture timing related indications may differ in active SVC sequence parameter set RBSP and active layer SVC sequence parameter set RBSPs. Similarly, most but not all syntax elements remain unchanged in active view sequence parameter set RBSPs when compared to active sequence parameter set RBSPs. Thus, sequence parameter set RBSPs duplicate information, i.e. have the same values for respective syntax elements. One approach for reducing this overhead caused by duplicate information in sequence parameter set RBSPs could be to re-use the same sequence parameter set RBSPs across layers or views, i.e. to activate the same sequence parameter set RBSP for more than one layer or view. However, then the level would be suboptimally selected and HRD parameters would be suboptimally selected or not present (and then would not help the decoder in buffer initialization, buffering, picture timing, and so on).
3. Decoder conformance to profiles is limited to a maximum of two profiles in the following sense: the base layer or view may conform to a profile specified in Annex A of the H.264/AVC standard, i.e. one of the profiles for non-scalable (and non-multiview) coding. The other layers may conform to a profile specified in Annex G of the H.264/AVC standard, i.e. one of the profiles for scalable coding. Similarly, the other views may conform to a profile specified in Annex H of the H.264/AVC standard, i.e. one of the profiles for multiview coding. The values of profile_idc and level_idc in an SVC sequence parameter set RBSP are those that would be valid if the SVC sequence parameter set RBSP is the active SVC sequence parameter set. Similarly. the values of profile_idc and level_idc in an MVC sequence parameter set RBSP are those that would be valid if the MVC sequence parameter set RBSP is the active MVC sequence parameter set. However, the bitstream may, in general, contain additional types of scalability, such as coded depth views, which a decoder conforming to Annex G and Annex H would not be able to decode. A decoder conforming to Annex G or Annex H is not aware whether or not NAL units of such additional types of scalability are present in the bitstream, as NAL units of such additional types of scalability would use an extension mechanism, such as previously reserved NAL unit type values, which a decoder conforming to Annex G or Annex H would ignore. However, the NAL units of such additional types of scalability would affect the bitrate of the bitstream and potentially the HRD parameters, such as an initial CPB buffering delay or time. Even if the bitstream contains NAL of such additional type of scalability, a decoder conforming to Annex G or Annex H would still active that SVC or MVC sequence parameter set RBSPs according to the SVC or MVC standard and assume conformance according to the SVC or MVC standard. Consequently, the level_idc should be set sub-optimally to cover also the bitrate of the non-SVC or non-MVC data in the bitstream. Moreover, the HRD parameters should cover the non-SVC or non-MVC data in the bitstream.
4. If sub-bitstream extraction is done according to the process specified in Annex G or Annex H of the H.264/AVC standard for a bitstream containing additional types of scalability that a decoder conforming to Annex G or Annex H of the H.264/AVC standard cannot decode, the NAL units containing data for such additional types of scalability are kept unchanged in the resulting sub-bitstream. However, the data for such additional types of scalability may have some of the same scalability dimensions as present in Annex G or Annex H. For example, in 3DV-ATM, the coded depth views are associated with temporal_id and view_id as texture views coded with MVC. Therefore sub-bitstream extraction based on temporal_id and/or view_id should also concern depth views. However, if a sub-bitstream extraction process using the existing scalability dimensions, such as temporal_id and/or view_id, is used also for NAL units containing such additional types of scalability, such as depth views, the level indicator and HRD parameters present for Annex G or Annex H would be outdated, as they assume a sub-bitstream extraction to be done according to the process specified in Annex G or Annex H, i.e. keeping the NAL units containing such additional types of scalability, such as depth views, present in the resulting sub-bitstream.
5. Decoders conforming to a profile specified in Annex A of the H.264/AVC standard, i.e. one of the profiles for non-scalable (and non-multiview) coding consider coded slices of SVC and MVC (i.e., NAL units of nal_unit_type equal to 20) as non-VCL NAL units, whereas decoders conforming to a profile specified in Annex G or Annex H consider them as VCL NAL units. Therefore, the VCL and NAL HRD parameters differ. For example, the semantics of the MVC video usability information extension and the MVC scalable nesting SEI message used to carry picture timing and buffering period SEI messages rely on the sub-bitstream extraction process specified in subclause H.8.5.3, which treats NAL units of nal_unit_type equal to 21 as non-VCL NAL units and does not perform temporal_id and view_id based extraction for them. Hence, no proper HRD parameters can be conveyed for sub-bitstreams consisting of texture views only

In 3DV-ATM some of the above-mentioned shortcomings can be avoided as follows. It is proposed that in some embodiments the texture sub-bitstream HRD parameters are conveyed for example in a second instance of mvc_vui_parameters_extension( ) for example within a 3DVC sequence parameter set and HRD parameters within or similar to picture timing and buffering period SEI messages are conveyed in a specific data structure that can be limited to be valid or pertain to a sub-bitstream containing only texture views, such as a 3DVC texture sub-bitstream HRD nesting SEI message. If a texture sub-bitstream is extracted using the sub-bitstream extraction process, these nested HRD parameters and SEI messages may replace the respective MVC HRD parameters and SEI messages, which, as stated above, assume the presence of NAL units of nal_unit_type 21 as non-VCL NAL units.

For example, the following subset sequence parameter syntax structure may be used for 3DVC sequence parameter set RBSPs.

| subset_seq_parameter_set_rbsp( ) { | C | Descriptor |
|---|---|---|
| seq_parameter_set_data( ) | 0 | |
| if( profile_idc = = 83 \|\| profile_idc = = 86 ) { | | |
| seq_parameter_set_svc_extension( ) /* specified in Annex G */ | 0 | |
| svc_vui_parameters_present_flag | 0 | u(1) |
| if( svc_vui_parameters_present_flag = = 1 ) | | |
| svc_vui_parameters_extension( ) /* specified in Annex G */ | 0 | |
| } else if( profile_idc = = 118 \|\| profile_idc = = 128 ) { | | |
| bit_equal_to_one /* equal to 1 */ | 0 | f(1) |
| seq_parameter_set_mvc_extension( ) /* specified in Annex H */ | 0 | |
| mvc_vui_parameters_present_flag | 0 | u(1) |
| if( mvc_vui_parameters_present_flag = = 1 ) | | |
| mvc_vui_parameters_extension( ) /* specified in Annex H */ | 0 | |
| } | | |
| if( profile_idc = = 138 ) { | | |
| bit_equal_to_one /* equal to 1 */ | 0 | f(1) |
| seq_parameter_set_mvc_extension( ) /* specified in Annex H */ | 0 | |
| seq_parameter_set_3dvc_extension( ) | 0 | |
| 3dvc_vui_parameters_present_flag | 0 | u(1) |
| if( 3dvc_vui_parameters_present_flag = = 1 ) | | |
| mvc_vui_parameters_extension( ) | 0 | |
| texture_vui_parameters_present_flag | 0 | u(1) |
| if( texture_vui_parameters_present_flag = = 1 ) | | |
| mvc_vui_parameters_extension( ) | 0 | |
| } | | |
| additional_extension3_flag | 0 | u(1) |
| if( additional_extension3_flag = = 1 ) | | |
| while( more_rbsp_data( ) ) | | |
| additional_extension3_data_flag | 0 | u(1) |
| rbsp_trailing_bits( ) | 0 | |
| } | | |

In the presented example syntax structure, certain syntax elements may be specified as follows. 3dvc_vui_parameters_present_flag equal to 0 specifies that the syntax structure mvc_vui_parameters_extension( ) corresponding to 3DVC VUI parameters extension is not present. 3dvc_vui_parameters_present_flag equal to 1 specifies that the syntax structure mvc_vui_parameters_extension( ) is present and referred to as 3DVC VUI parameters extension. texture_vui_parameters_present_flag equal to 0 specifies that the syntax structure mvc_vui_parameters_extension( ) corresponding to 3DVC texture sub-bitstream VUI parameters extension is not present. texture_vui_parameters_present_flag equal to 1 specifies that the syntax structure mvc_vui_parameters_extension( ) is present and referred to as 3DVC texture sub-bitstream VUI parameters extension.

In the HRD for 3DV-ATM, it may be specified that when the coded video sequence conforms to one or more of the profiles specified in 3DV-ATM, the HRD parameter sets are signalled through the 3DVC video usability information extension, which is part of the subset sequence parameter set syntax structure. Furthermore, it may specified that when the coded video sequence conforms to 3DV-ATM and the decoding process 3DV-ATM is applied, the HRD parameters specifically indicated for 3DV-ATM are in use.

The syntax of a 3DVC texture sub-bitstream HRD nesting SEI message may be specified as follows.

| | | De- |
|---|---|---|
| | | scrip- |
| 3dvc_texture_subbitstream_hrd_nesting( payloadSize ) { | C | tor |
| num_texture_subbitstream_view_components_minus1 | 5 | ue(v) |
| for( i = 0; i <= num_view_components_op_minus1; | | |
| i++ ) | | |
| texture_subbitstream_view_id[ i ] | 5 | u(10) |
| texture_subbitstream_temporal_id | 5 | u(3) |
| while( !byte_aligned( ) ) | | |
| sei_nesting_zero_bit /* equal to 0 */ | 5 | f(1) |
| sei_message( ) | 5 | |
| } | | |

The semantics of a 3DVC texture sub-bitstream HRD nesting SEI message may be specified as follows. A 3DVC texture sub-bitstream HRD nesting SEI message may contain for example one SEI message of payload type 0 or 1 (i.e. buffering period or picture timing SEI message) or one and only one MVC scalable nesting SEI message containing one SEI message of payload type 0 or 1. The SEI message included in a 3DVC texture sub-bitstream HRD nesting SEI message and not included in an MVC scalable nesting SEI message is referred to as the nested SEI message. The semantics of the nested SEI message apply for the sub-bitstream obtained with a 3DV-ATM sub-bitstream extraction process with depthPresentFlagTarget equal to 0, tIdTarget equal to texture_subbitstream_temporal_id, and viewIdTargetList consisting of texture_subbitstream_view_id[i] for all values of i in the range of to num_texture_subbitstream_view_components_minus1, inclusive, as inputs. num_texture_subbitstream_view_components_minus1 plus 1 specifies the number of view components of the operation point to which the nested SEI message applies. texture_subbitstream_view_id[i] specifies the view_id of the i-th view component to which the nested SEI message applies. texture_subbitstream_temporal_id specifies the maximum temporal_id of the bitstream subset to which the nested SEI message applies. sei_nesting_zero_bit is equal to 0.

In some embodiments, a 3DV-ATM sub-bitstream extraction process may be specified as follows. Inputs to this process may be: a variable depthPresentFlagTarget (when present), a variable pIdTarget (when present), a variable tIdTarget (when present), a list viewIdTargetList consisting of one or more values of viewIdTarget (when present). Outputs of this process may be a sub-bitstream and a list of VOIdx values VOIdxList. When depthPresentFlagTarget is not present as input, depthPresentFlagTarget may be inferred to be equal to 0. When pIdTarget is not present as input, pIdTarget may be inferred to be equal to 63. When tIdTarget is not present as input, tIdTarget may be inferred to be equal to 7. When viewIdTargetList is not present as input, there may be one value of viewIdTarget inferred in viewIdTargetList and the value of viewIdTarget may be inferred to be equal to view_id of the base view. In the sub-bitstream extraction process, if depthPresentFlagTarget is equal to 0 or a similar indication to remove depth views from the resulting sub-bitstream is input, the HRD parameters specifically indicated for texture sub-bitstreams may be converted to data structures specified in H.264/AVC and/or MVC. For example, one or more of the following operations may be used within a sub-bitstream extraction process to convert HRD related data structures:
Replace an SEI NAL unit in which payloadType indicates a 3DVC texture sub-bitstream HRD nesting SEI message with an SEI NAL unit with payload consisting of the SEI message nested within the 3DVC texture sub-bitstream HRD nesting SEI message.
Replace mvc_vui_parameters_extension( ) syntax structure in an active texture 3DVC sequence parameter set RBSPs with the mvc_vui_parameters_extension( ) syntax structure of the 3DVC texture sub-bitstream VUI parameters extension.

For example, the sub-bitstream may be derived by applying the following operations in sequential order:
1. Derive variable VOIdxList to include all views needed for decoding all views included in viewIdTargetList according to the inter-view dependencies indicated in the active sequence parameter set. If depthPresentFlagTarget is equal to 1, inter-view dependencies of depth views may be taken into account when deriving VOIdxList. Mark all NAL units for all view components that are not in VOIdxList as “to be removed from the bitstream”.
2. Mark all VCL NAL units and filler data NAL units for which any of the following conditions are true as “to be removed from the bitstream”:
   priority_id is greater than pIdTarget,
   temporal_id is greater than tIdTarget,
   anchor_pic_flag is equal to 1 and view_id is not marked as “required for anchor”,
   anchor_pic_flag is equal to 0 and view_id is not marked as “required for non-anchor”,
   nal_ref_idc is equal to 0 and inter_view_flag is equal to 0 and view_id is not equal to any value in the list viewIdTargetList,
   NAL units contains a coded slice for a depth view component and depthPresentFlagTarget is equal to 0.
3. Remove all access units for which all VCL NAL units are marked as “to be removed from the bitstream”.
4. Remove all VCL NAL units and filler data NAL units that are marked as “to be removed from the bitstream”.
5. Remove all NAL units with nal_unit_type equal to 6 in which the first SEI message has payloadType equal to 0 or 1, or the first SEI message has payloadType equal to equal to 37 (MVC scalable nesting SEI message) and operation_point_flag in the first SEI message is equal to 1.
6. When depthPresentFlagTarget is equal to 0, the following applies.
   Replace all NAL units with nal_unit_type equal to 6 in which payloadType indicates a 3DVC texture sub-bitstream HRD nesting SEI message with the nal_unit_type equal to 6 with payload consisting of the SEI message nested within 3DVC texture sub-bitstream HRD nesting SEI message.
   The following applies for each active texture 3DVC sequence parameter set RBSP: Replace mvc_vui_parameters_extension( ) syntax structure in an active texture 3DVC sequence parameter set RBSPs with the mvc_vui_parameters_extension( ) syntax structure of the 3DVC texture sub-bitstream VUI parameters extension, if both mvc_vui_parameters_extension( ) syntax structures apply to the same views. Otherwise, remove mvc_vui_parameters_extension( ) syntax structure in an active texture 3DVC sequence parameter set RBSP.
   Remove all SEI NAL units with specified in 3DV-ATM and not applicable for H.264/AVC or MVC.
7. Let maxTId be the maximum temporal_id of all the remaining VCL NAL units. Remove all NAL units with nal_unit_type equal to 6 that only contain SEI messages that are part of an MVC scalable nesting SEI message or 3DVC scalable nesting SEI message with any of the following properties:
   operation_point_flag is equal to 0 and all_view_components_in_au_flag is equal to 0 and none of sei_view_id[i] for all i in the range of 0 to num_view_components_minus1, inclusive, corresponds to a VOIdx value included in VOIdxList,
   operation_point_flag is equal to 1 and either sei_op_temporal_id is greater than maxTId or the list of sei_op_view_id[i] for all i in the range of 0 to num_view_components_op_minus1, inclusive, is not a subset of viewIdTargetList (i.e., it is not true that sei_op_view_id[i] for any i in the range of 0 to num_view_components_op_minus1, inclusive, is equal to a value in viewIdTargetList).
8. Let maxTId be the maximum temporal_id of all the remaining VCL NAL units. Remove all NAL units with nal_unit_type equal to 6 that only contain SEI messages that are part of a 3DVC texture sub-bitstream HRD nesting SEI message with any of the following properties:
   either texture_subbitstream_temporal_id is greater than maxTId or the list of texture_subbitstream_view_id[i] for all i in the range of 0 to num_texture_subbitstream_view_components_minus1, inclusive, is not a subset of viewIdTargetList (i.e., it is not true that sei_texture_subbitstream_view_id[i] for any i in the range of 0 to num_texture_subbitstream_view_components_minus1, inclusive, is equal to a value in viewIdTargetList).
9. Remove each view scalability information SEI message and each operation point not present SEI message, when present.
10. When VOIdxList does not contain a value of VOIdx equal to minVOIdx, the view with VOIdx equal to the minimum VOIdx value included in VOIdxList is converted to the base view of the extracted sub-bitstream.

In some embodiments, the following may apply for buffering period and picture timing SEI messages, that is SEI messages with payloadType is equal to 0 or 1.

If a buffering period or picture timing SEI message is included in a 3DVC scalable nesting SEI message and not included in an MVC scalable nesting SEI message or a 3DVC texture sub-bitstream HRD nesting SEI message, the following may apply. When the SEI message and all other SEI messages with payloadType equal to 0 or 1 included in a 3DVC scalable nesting SEI message with identical values of sei_op_temporal_id and sei_op_view_id[i] for all i in the range of 0 to num_view_components_op_minus1, inclusive, are used as the buffering period and picture timing SEI messages for checking the bitstream conformance according to the HRD, the bitstream that would be obtained by invoking the 3DV-ATM bitstream extraction process with depthPresentTargetFlag equal to 1, tIdTarget equal to sei_op_temporal_id and viewIdTargetList equal to sei_op_view_id[i] for all i in the range of 0 to num_view_components_op_minus1, inclusive, conforms to 3DV-ATM.

If a buffering period or picture timing SEI message is included in a 3DVC texture sub-bitstream HRD nesting SEI message, the following may apply. When the SEI message and all other SEI messages included in a 3DVC texture sub-bitstream HRD nesting SEI message with identical values of texture_subbitstream_temporal_id and texture_subbitstream_view_id[i] for all i in the range of 0 to num_texture_subbitstream_view_components_minus1, inclusive, are used as the buffering period and picture timing SEI messages for checking the bitstream conformance according to the HRD, the bitstream that would be obtained by invoking the 3DV-ATM bitstream extraction process with depthPresentTargetFlag equal to 0, tIdTarget equal to texture_subbitstream_temporal_id and viewIdTargetList equal to texture_subbitstream_view_id[i] for all i in the range of 0 to num_texture_subbitstream_view_components_minus1, inclusive, conforms to 3DV-ATM.

As can be judged from the descriptions above, extending H.264/AVC, SVC, and MVC with new scalability types, such as depth views, may be complicated due to at least the following reasons:
1. The coded slice NAL units of the new scalability types are VCL NAL units according to the new amendment but non-VCL NAL units according to the “old” versions of the standard. As the HRD makes a difference between the VCL and non-VCL NAL units in its operation, different sets of HRD parameters are needed depending on the interpretation of the NAL unit types to either VCL or non-VCL NAL units.
2. The sub-bitstream extraction process is specified for the NAL units and scalability types of the “old” versions of the standard, e.g. for dependency_id, quality_id, temporal_id and priority_id in Annex G of H.264/AVC and for temporal_id, priority_id and view_id in Annex H of H.264/AVC. However, new NAL unit types are introduced for new types of scalability, such as NAL unit type 21 for coded depth views and potentially for enhanced texture view, as specified in 3DV-ATM, and the existing sub-bitstream extraction process of SVC or MVC leaves those new NAL unit types intact even if they would also contain the “old” scalability dimensions, such as temporal_id and view_id in the case of depth views.

While a draft HEVC standard does not include scalability features beyond temporal scalability, we have identified that the design in the draft HEVC standard could, when extended to support scalable extensions, would have similar problems to the SVC and MVC design. More specifically, we have identified at least the following problems or challenges in the design of a draft HEVC standard:
1. Sequence parameter sets associated with the different layers are likely to be similar regardless of the type of scalability (e.g. quality, spatial, multiview, or depth/disparity extension). For example spatial resolution of pictures in different views may be identical in multiview coding. In another example, the same coding algorithms and parameters may be used across layers and may therefore have the same values for the related syntax elements in the sequence parameter sets. Consequently, the bitrate used for sequence parameter sets and the storage space required for sequence parameter sets in decoders may be unnecessarily high. Sequence parameter sets may be transmitted once per each IDR/CRA/BLA picture e.g. in broadcast applications.
2. No different profile and level can be indicated for each bitstream subset resulting from a sub-bitstream extraction process with a temporal_id value as input. This issue applies more generally too. For example, if a bitstream contains multiview video with associated depth views and a decoder only capable of texture video decoding is processing the bitstream, it activates the sequence parameter sets that apply to the texture views. However, these sequence parameter sets are generated by the encoder to take the bitrate used for coded depth into account in the level and HRD parameters. In general terms, when a bitstream contains NAL units for layers not documented by an active sequence parameter set, the level and HRD parameter indicated in the active sequence parameter set still cover the whole bitstream. There is no mechanism at the moment to indicate the level for the bitstream subset consisting of only certain layers.
3. When a bitstream contains NAL units for non-base layers (i.e. NAL units having reserved_one_{—}5 bits/layer_id_plus1 not equal to 1), the SPS for the base layer indicates the profile of the base layer, while the level and the HRD parameters are valid for the whole bitstream including non-base-layer NAL units. There is no mechanism at the moment to indicate the level for the bitstream subset containing the base-layer NAL units only.

In some embodiments, certain parameters or syntax elements values, such as the HRD parameters and/or level indicator, may be taken from a syntax structure, such as the sequence parameter set, of the highest layer present in an access unit, coded video sequence, and/or bitstream even if the highest layer were not decoded. The highest layer may be defined for example as the greatest value of reserved_one_{—}5 bits or layer_id_plus1 in a scalable extension of HEVC, although other definitions of the highest layer may also be possible. These syntax element values from the highest layer may be semantically valid and may be used for conformance checking e.g. using an HRD, while the values of the respective syntax elements from other respective syntax structures, such as sequence parameter sets, may be active or valid otherwise.

In the following, some example embodiments are described for a draft HEVC standard or similar. It should be understood that similar embodiments would apply for other coding standards and specifications.

Syntax structures, such as sequence parameter sets, may be encapsulated as NAL units, which may include scalability layer identifiers, such as temporal_id and/or layer_id_plus1, for example in a header of the NAL unit.

In some embodiments, the same seq_parameter_set_id may be used for sequence parameter set RBSPs having different syntax element values. The sequence parameter set RBSPs having the same seq_parameter_set_id value may be associated with each other, e.g. such a manner that sequence parameter set RBSPs with the same value of seq_parameter_set_id is referred from different component pictures, such as layer representations or view components, of the same access unit.

In some embodiments, a partial updating mechanism may be enabled in the SPS syntax structure for example as follows. For each group of syntax elements (e.g. profile and level indications, HRD parameters, spatial resolution), the encoder may for example have one or more of the following options when coding an SPS syntax structure:
The group of syntax elements may be coded into an SPS syntax structure, i.e. coded syntax element values of the syntax element set may be included in the sequence parameter set syntax structure.
The group of syntax elements may be included by reference into the SPS. The reference may be given as an identifier to another SPS or it may be implicit. If a reference identifier is used, the encoder may in some embodiments use a different reference APS identifier for different groups syntax elements. If an SPS is implicitly referenced, the referenced SPS may for example have the same seq_parameter_set_id or similar identifier and have a scalability identifier, such as layer_id_plus1, that is immediately preceding in the dependency order between component pictures or layers or views, or be the active SPS for a layer or view from which the layer or view for which the SPS being coded is the active SPS depends on.
The group of syntax elements set may be indicated or inferred to be absent from the SPS.

The options from which the encoder is able to choose for a particular group of syntax elements when coding an SPS may depend on the type of the syntax element group. For example, it may be required that syntax elements of a certain type syntax are always present in the SPS syntax structure, while other groups of syntax elements may be included by reference or be present in the SPS syntax structure. The encoder may encode indications in the bitstream, for example in an SPS syntax structure, which option was used in encoding. The code table and/or entropy coding may depend on the type of the group of syntax elements. The decoder may use, based on the type of the group of syntax elements being decoded, the code table and/or entropy decoding that is matched with the code table and/or entropy encoding used by the encoder.

The encoder may have multiple means to indicate the association between a group of syntax elements and the SPS used as the source for the values of the syntax element set. For example, the encoder may encode a loop of syntax elements where each loop entry is encoded as syntax elements indicating an SPS identifier value used as a reference and identifying the syntax element sets copied from the reference SPS. In another example, the encoder may encode a number of syntax elements, each indicating an SPS. The last SPS in the loop containing a particular group of syntax elements is the reference for that group of syntax elements in SPS the encoder is currently encoding into the bitstream. The decoder parses the encoded adaptation parameter sets from the bitstream accordingly so as to reproduce the same adaptation parameter sets as the encoder.

A partial updating mechanism for the SPS may for example allow copying syntax elements other than profile and level indications and potentially HRD parameters from another sequence parameter set of the same seq_parameter_set_id. In some embodiments, a sequence parameter set RBSP having temporal_id greater than 0 may inherit values of syntax elements other than profile and level indications and selectively also VUI parameters from the sequence parameter set RBSP having the same seq_parameter_set_id and reserved_one_{—}5 bits values. In some embodiments, a sequence parameter set RB SP having reserved_one_{—}5 bits/layer_id_plus1 greater than 1 selectively includes or inherits (as governed e.g. by the short_sps_flag syntax element presented later) values of syntax elements other than profile and level indications from the sequence parameter set RBSP of the same seq_parameter_set_id and reserved_one_{—}5 bits equal to an indicated sequence parameter set (as indicated by src_layer_id_plus1).

In some embodiments, a maximum temporal_id value and a set of reserved_one_{—}5 bits/layer_id_plus1 values to be decoded may be provided to the decoding process for example by the receiving process or the receiver. If not provided to the decoding process, VCL NAL units of all temporal_id values and reserved_one_{—}5 bits/layer_id_plus1 equal to 1 may be decoded while the other VCL NAL units may be ignored. For example, the variable TargetLayerIdPlus1Set may comprise a set of values for reserved_one_{—}5 bits of VCL NAL units to be decoded. TargetLayerIdPlus1 may be provide for the decoding process, or, when not for the decoding process, TargetLayerIdPlus1 contains one value for reserved_one_{—}5 bits, which is equal to 1. The variable TargetTemporalId may be provided for the decoding process, or, when not provided for the decoding process, TargetTemporalId is equal to 7. A sub-bitstream extraction process is applied with TargetLayerIdPlus1Set and TargetTemporalId as inputs and the output assigned to a bitstream referred to as BitstreamToDecode. The decoding process operates for BitstreamToDecode.

In some embodiments, a sub-bitstream extraction process with temporal_id and a set of reserved_one_{—}5 bits values as inputs may be used. Sequence parameter set NAL units may be subject to sub-bitstream extraction based on reserved_one_{—}5 bits/layer_id_plus1 and temporal_id. For example, the inputs to the sub-bitstream extraction process are variables tIdTarget and layerIdPlus1Set, and the output of the process is a sub-bitstream. For example, the sub-bitstream is derived by removing from the bitstream all NAL units for which temporal_id is greater than tIdTarget or for which reserved_one_{—}5 bits is not among the values in layerIdPlus1Set.

In some embodiments, the following syntax for sequence parameter set RBSP may be used:

| seq_parameter_set_rbsp( ) { | Descriptor |
|---|---|
| profile_space | u(3) |
| profile_idc | u(5) |
| constraint_flags | u(16) |
| level_idc | u(8) |
| for( i = 0; i < 32; i++ ) | |
| profile_compatability_flag[ i ] | u(1) |
| seq_parameter_set_id | ue(v) |
| if( reserved_one_5bits != 1 && !temporal_id ) { | |
| short_sps_flag | u(1) |
| if( short_sps_flag ) | |
| src_layer_id_plus1 | u(5) |
| } | |
| if( !short_sps_flag ) { | |
| video_parameter_set_id | ue(v) |
| chroma_format_idc | ue(v) |
| ... | |
| long_term_ref_pics_present_flag | u(1) |
| sps_temporal_mvp_enable_flag | u(1) |
| } | |
| vui_parameters_present_flag | u(1) |
| if( vui_parameters_present_flag ) | |
| vui_parameters( ) | |
| sps_extension_flag | u(1) |
| if( sps_extension_flag ) | |
| while( more_rbsp_data( ) ) | |
| sps_extension_data_flag | u(1) |
| rbsp_trailing_bits( ) | |
| } | |

In the syntax above, short_sps_flag may specify the presence and inference of values for syntax elements of the sequence parameter set RBSP for example as follows. When short_sps_flag is not present and temporal_id is greater than 0, short_sps_flag is inferred to be equal to 1 and variable SrcLayerIdPlus1 is set equal to reserved_one_{—}5 bits. When short_sps_flag is not present and temporal_id is equal to 0, short_sps_flag is inferred to be equal to 0. When short_sps_flag is present, variable SrcLayerIdPlus1 is set equal to src_layer_id_plus1. When short_sps_flag is or is inferred to be equal to 1 and the sequence parameter set RBSP is activated, the values of the syntax elements in seq_parameter_set_rbsp( ) syntax structure other than profile_space, profile_idc, constraint_flags, level_idc, profile_compatibility_flag[i], seq_parameter_set_id, short_sps_flag and src_layer_id_plus1 are inferred to be identical to the values of the respective syntax elements in the seq_parameter_set_rbsp( ) syntax structure having the same value of seq_parameter_set_id and the value of reserved_one_{—}5 bits equal to src_layer_id_plus 1. When short_sps_flag is or is inferred to be equal to 1 and either the sequence parameter set RB SP is activated or used by the hypothetical reference decoder, the values of those syntax elements in video usability information that are not present in the sequence parameter set RBSP are inferred to be identical to the values of the respective syntax elements, if present, in seq_parameter_set_rbsp( ) syntax structure having the same value of seq_parameter_set_id and the value of reserved_one_{—}5 bits equal to src_layer_id_plus 1.

In some embodiments, e.g. when only temporal scalability is in use or allowed, a sequence parameter set RBSP may be activated as follows. When a sequence parameter set RBSP (with a particular value of seq_parameter_set_id) is not already active and it is referred to by activation of a picture parameter set RB SP (using that value of seq_parameter_set_id) or is referred to by an SEI NAL unit containing a buffering period SEI message (using that value of seq_parameter_set_id), a sequence parameter set RBSP is activated as follows:
Let a set of sequence parameter set RBSPs, potentialSPSSet, contain those sequence parameter set RBSPs that have a particular value of seq_parameter_set_id and a value of temporal_id smaller than or equal to TargetTemporalId and a value of reserved_one_{—}5 bits equal to 1.
If there is only one sequence parameter set RBSP among potentialSPSSet, it is activated.
Otherwise, among the set of sequence parameter set RBSPs having the greatest value of reserved_one_{—}5 bits in potentialSPSSet, the sequence parameter set RBSP with the greatest value of temporal_id is activated.

In some embodiments, e.g. when both temporal scalability indicated with temporal_id and at least one other type of scalability indicated with layer_id_plus1, is in use or allowed, sequence parameter set RBSPs may be activated as follows. When a sequence parameter set RBSP (with a particular value of seq_parameter_set_id) is not already active and it is referred to by activation of a picture parameter set RBSP (using that value of seq_parameter_set_id) or is referred to by an SEI NAL unit containing a buffering period SEI message (using that value of seq_parameter_set_id), a sequence parameter set RBSP is activated for a layer having reserved_one_{—}5 bits equal to LIdPlus1, for LIdPlus1 value equal to each value in TargetLayerIdPlus1Set as follows:
Let a set of sequence parameter set RBSPs, potentialSPSSet, contain those sequence parameter set RBSPs that have a particular value of seq_parameter_set_id and a value of temporal_id smaller than or equal to TargetTemporalId and a value of reserved_one_{—}5 bits be among TargerLayerIdPlus1Set and be smaller than or equal to LIdPlus1.
If there is only one sequence parameter set RBSP among potentialSPSSet, it is activated.
Otherwise, if among potentialSPSSet there is only one sequence parameter set RBSP that has a value of reserved_one_{—}5 bits greater than the value of reserved_one_{—}5 bits of any other sequence parameter set RBSP in potentialSPSSet, that sequence parameter set RBSP is activated.
Otherwise, among the set of sequence parameter set RBSPs having the greatest value of reserved_one_{—}5 bits in potentialSPSSet, the sequence parameter set RBSP with the greatest value of temporal_id is activated.

In some embodiments, the sequence parameter set RBSP used for HRD parameter sets for bitstream conformance, conformanceSPS, may be selected as follows:
Let a set of sequence parameter set RBSPs, potentialSPSSet, contain those sequence parameter set RBSPs that have the same seq_parameter_set_id value as that of the active sequence parameter set RBSP and a value of temporal_id smaller than or equal to the greatest temporal_id value among the VCL NAL units of the bitstream and a value of reserved_one_{—}5 bits smaller than or equal to the greatest reserved_one_{—}5 bits value among the VCL NAL units of the bitstream.
If there is only one sequence parameter set RBSP among potentialSPSSet, conformanceSPS is that one sequence parameter set RBSP.
Otherwise, if among potentialSPSSet there is only one sequence parameter set RBSP that has a value of reserved_one_{—}5 bits greater than the value of reserved_one_{—}5 bits of any other sequence parameter set RBSP in potentialSPSSet, conformanceSPS is that sequence parameter set RB SP.
Otherwise, among the set of sequence parameter set RBSPs having the greatest value of reserved_one_{—}5 bits in potentialSPSSet, conformanceSPS is the sequence parameter set RBSP with the greatest value of temporal_id.

In some embodiments, terms component sequence and component picture may be defined and used. A component sequence can be for example a texture view, a depth view, or an enhancement layer of spatial/quality scalability. Each component sequence may refer to a separate sequence parameter set, and several component sequences may refer to the same sequence parameter set. Each component sequence may be uniquely identified by variable CPId or LayerId, which may be, in the context of HEVC, derived from the 5 reserved bits (reserved_one_{—}5 bits) in the second byte of the NAL unit header. Temporal subsets of the coded video sequence might not be considered to be component sequences; instead temporal_id may be regarded as an orthogonal property. Component pictures may appear in ascending order of CPId within the access unit. In general, a coded video sequence may contain one or more component sequences. An access unit may comprise one or more component pictures. In a draft HEVC specification a component picture may be defined as the coded picture of an access unit, and in the future scalable HEVC extensions it would be for example a view component, a depth map, or a layer representation.

In some embodiments, a sequence parameter set or a video parameter set or some other syntax structure or structures may contain syntax elements indicating dependencies, such as prediction relationship, between component sequences. For example, The VPS syntax may include: dependencies between component sequences and the mapping of CPId to specific scalability properties (e.g. dependency_id, quality_id, view order index).

In one example, referred to as cross-layer VPS, dependencies of between layers of the entire coded video sequence and the properties of layers are described in a VPS. A single VPS may be active for all layers. If layers are extracted from the bitstream, the cross-layer VPS may describe layers that are no longer present in the bitstream. A cross-layer VPS may extend the VPS specified in a draft HEVC standard as follows:

| video_parameter_set_rbsp( ) { | Descriptor |
|---|---|
| ... | |
| vps_extension1_flag | u(1) |
| if( vps_extension1_flag ) { | |
| for( i = 1; i <= vps_max_layers_minus1; i++ ) { | |
| num_ref_component_seq[ i ] | ue(v) |
| for( j = 0; j < num_ref_component_seq; j++ ) | |
| ref_component_seq_id[ i ][ j ] | u(5) |
| } | |
| num_component_seq_types | ue(v) |
| for( i = 1; i <= num_component_seq_types; i++ ) { | |
| component_sequence_type[ i ] | ue(v) |
| component_sequence_property_len[ i ] | ue(v) |
| len[ i ] = component_sequence_property_len[ i ] | |
| } | |
| for( i = 1; i <= max_component_sequences_minus1; | |
| i++ ) { | |
| component_sequence_type_idx[ i ] | ue(v) |
| tp = component_sequence_type_idx[ i ] | |
| component_sequence_property[ i ] | u(len[tp]) |
| } | |
| } | |
| vps_extension2_flag | u(1) |
| if( vps_extension_flag ) | |
| while( more_rbsp_data( ) ) | |
| vps_extension_data_flag | u(1) |
| rbsp_trailing_bits( ) | |
| } | |

As the types of scalability and the syntax elements used to represent them might not be known and new types of scalability may be introduced later, the proposed syntax enables parsing of VPS even if the scalability types were unknown for the decoder. The decoder might be able to decode a subset of the bitstream containing those scalability types that it is aware of.

The semantics of the cross-layer VPS may be specified as follows. num_ref component_seq[i] specifies the number of component sequences that the component sequence with CPId equal to i depends on. ref_component_seq_id[i][j] specifies the vps_id values of the component sequences that the component sequence with CPId equal to i depends on. component_sequence_type[i] specifies the type of the component sequence with type index equal to i. component_sequence_type[0] is inferred to indicate HEVC base component sequence. component_sequence_property_len[i] specifies the size in bits of component_sequence_property[ ] syntax element which is preceded by component_sequence_type_idx[ ] syntax element having value equal to i. component_sequence_type_idx[i] specifies the type index for the component sequence with CPId equal to i. The component sequence with CPId equal to i is of type component_sequence_type[component_sequence_type_idx [i]]. component_sequence_property[i] specifies the value or values characterizing the component sequence with CPId equal to i. The semantics of component_sequence_property[i] are specified according to component_sequence_type[component_sequence_type_idx [i]].

In one example, referred to as layered VPS, a VPS NAL unit describes the dependencies and properties of a single layer or component sequence. The layered VPS NAL unit uses reserved_one_{—}5 bits and hence VPS NAL units are extracted along with other layer-specific NAL units in sub-bitstream extraction. A different VPS may be active for each layer, although the same vps_id may be used in all active VPSes. The vps_id in all active (layer/view) sequence parameter sets may be required to be identical. A layered VPS may extend the VPS specified in a draft HEVC standard as follows:

| video_parameter_set_rbsp( ) { | Descriptor |
|---|---|
| ... | |
| vps_extension1_flag | u(1) |
| if( vps_extension1_flag ) { | |
| num_ref_component_seq[ i ] | ue(v) |
| for( j = 0; j < num_ref_component_seq; j++ ) | |
| ref_component_seq_id[ i ][ j ] | u(5) |
| component_sequence_type | ue(v) |
| component_sequence_property_len | ue(v) |
| len = component_sequence_property_len | |
| component_sequence_property | u(len) |
| } | |
| vps_extension2_flag | u(1) |
| if( vps_extension_flag ) | |
| while( more_rbsp_data( ) ) | |
| vps_extension_data_flag | u(1) |
| rbsp_trailing_bits( ) | |
| } | |

The semantics of the layered VPS may be specified as follows. num_ref component_seq specifies the number of component sequences that the component sequence depends on. ref_component_seq_id[j] specifies the vps_id values of the component sequences that the component sequence depends on. component_sequence_type specifies the type of the component sequence. Values of component_sequence_type are reserved. component_sequence_property_len specifies the size in bits of component_sequence_property syntax element. component_sequence_property specifies the value or values characterizing the component sequence. The semantics of component_sequence_property are specified according to component_sequence_type.

In some embodiments, a sub-bitstream extraction process may be specified, where a set of output layers or component sequences is provided as input. The sub-bitstream extraction process may conclude the components sequences required for decoding the output component sequences for example using the dependency information provided in sequence parameter set(s) or video parameter set(s). The output component sequences and the component sequences required for decoding may be referred to as target component sequences and the respective scalability layer identifier values as target scalability layer identifier values. The sub-bitstream extraction process may remove all NAL units, including parameter set NAL units, where the scalability layer identifier value is not among the target scalability layer identifier values.

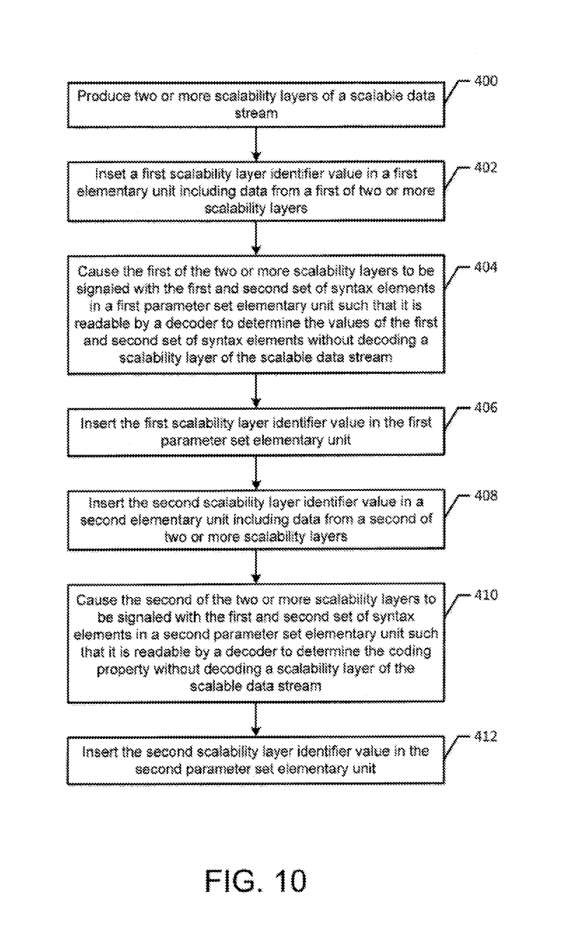

Referring now to FIG. 10, the operations that may be performed by an apparatus 50 specifically configured in accordance with an example embodiment of the present invention are illustrated. In this regard, an apparatus may include means, such as the processor 56 or the like, for producing two or more scalability layers of a scalable data stream. Said means, such as the processor 56 or the like, may for example include blocks implementing an encoding arrangement according to FIG. 4a or the like, potentially also including inter-layer, inter-view, and/or view-synthesis prediction or the like (not illustrated in FIG. 4a). See block 400 of FIG. 10. Each of the two or more scalability layers may have a different coding property, may be associated with a scalability layer identifier and may be characterized by a first set of syntax elements that include at least a profile and a second set of syntax elements including at least one of a level or HRD parameters. As shown in block 402 of FIG. 10, the apparatus of this embodiment may also include means, such as the processor or the like, for inserting a first scalability layer identifier value and a first elementary unit including data from the first of two or more scalability layers. The apparatus of this embodiment may also include means, such as the processor, the communication interface or the like, for causing the first of the two or more scalability layers to be signaled with the first and second set of syntax elements and a first parameter set elementary unit such that the first parameter set elementary unit is readable by a decoder to determine the values of the first and second set of syntax elements without decoding a scalability layer of the scalable data stream. See block 404 of FIG. 10. The first set of syntax elements may for example comprise a profile indicator and the second set of syntax elements may for example comprise a level indicator and HRD parameters. The apparatus of one embodiment may also include means, such as the processor or the like, for inserting the first scalability layer identifier value in the first parameter set elementary unit, and means, such as the processor or the like, for inserting a second scalability layer identifier value in a second elementary unit including data from a second of two or more scalability layers. See blocks 406 and 408 of FIG. 10. The parameter set elementary unit may for example be a NAL unit including a parameter set. The first and second scalability layer identifier may for example be one or more syntax elements, such as reserved_one_{—}5 bits in HEVC, included in a NAL unit header. As shown in block 410 of FIG. 10, the apparatus of one embodiment may also include means, such as the processor, the communication interface or the like, for causing the second of the two or more scalability layers to be signaled with the first and second set of syntax elements and a second parameter set elementary unit such that the second parameter set elementary unit is readable by the decoder to determine the coding property without decoding the scalability layer of the scalable data stream. The apparatus of this embodiment may also include means, such as the processor or the like, for inserting the second scalability layer identifier value in the second parameter set elementary unit. See Block 412 of FIG. 10.

In this embodiment, values of the first set of syntax elements and the first parameter set elementary unit may be valid in an instance in which the first elementary unit is processed and the second elementary unit is ignored or removed. The second elementary unit may be removed in a sub-bitstream extraction process, for example, which may remove the scalable layer or component sequence containing the second elementary unit. In the absence of the second elementary unit or the entire component sequence containing the second elementary unit, the values of the first set of syntax elements, such as a profile indicator, of the first parameter set may be valid. Values of the second set of syntax elements in the first parameter set elementary unit may be valid in an instance in which the first elementary unit is processed and the second elementary unit is removed. For example, HRD parameters and/or a level indicator included in the second set of syntax elements, may be valid for a sub-bitstream that contains the first elementary unit, and in many cases the component sequence containing the first elementary unit, but excluding the second elementary unit, and in many cases the component sequence containing the second elementary unit. Values of the first set of syntax elements in the second parameter set elementary unit may be valid in an instance in which the second elementary unit is processed. For example, if a bitstream including the second elementary unit is decoded, the values of the first set of syntax elements, such as the profile indicator, may be valid and may be used in decoding. Additionally, values of the second set of syntax elements in the second parameter set elementary unit may be valid in an instance in which the second elementary unit is ignored or processed. For example, if a component sequence containing the first elementary unit is decoded but the second elementary unit, and in many cases the component sequence containing the second elementary unit, is ignored, HRD parameters and/or level_idc of the second parameter set may characterize the bitrate of the bitstream and/or buffering of the bitstream and/or other things and hence may be valid and may be used for decoding. In another example, if a bitstream containing both the first and second elementary unit is decoded, HRD parameters and/or level_idc of the second parameter set may characterize the bitrate of the bitstream and/or buffering of the bitstream and/or other things and hence may be valid and may be used for decoding.

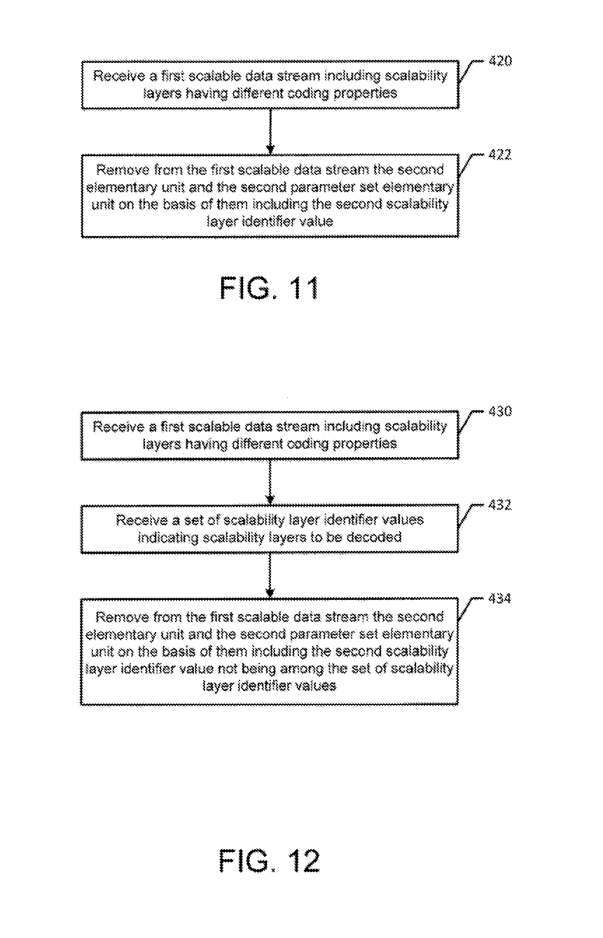

Referring now to FIG. 11, the operations performed by an apparatus 50 specifically configured in accordance with another example embodiment of the present invention are illustrated. In this regard, the apparatus may include means, such as the processor 56, the communication interface or the like, for receiving a first scalable data stream including scalability layers having different coding properties. See block 420 of FIG. 11. Each of the two or more scalability layers may be associated with a scalability layer identifier and may be characterized by a first set of syntax elements that include a least a profile and a second set of syntax elements including at least one of a level or HRD parameters. A first scalability layer identifier value may reside in a first elementary unit including data from a first of two or more scalability layers. The first and second set of syntax elements may be signaled in a first parameter set elementary unit for the first of the two or more scalability layers such that a first parameter set is readable by a decoder to determine the values of the first and second set of syntax elements without decoding a scalability layer of a scalable data stream. The first scalability layer identifier value may reside in the first parameter set elementary unit. A second scalability layer identifier value may reside in a second elementary unit including data from a second of two or more scalability layers. The first and second set of syntax elements may be signaled in a second parameter set elementary unit with a second of the two or more scalability layers such that a second parameter set is readable by the decoder to determine the decoding property without decoding the scalability layer of the scalable data stream. The second scalability layer identifier value may reside in the second parameter set elementary unit. As shown in Block 422 of FIG. 11, the apparatus of this embodiment may also include means, such as the processor or the like, for removing from the received first scalable data stream the second elementary unit and the second parameter set elementary unit. The second elementary unit and the second parameter set elementary unit may be removed on the basis of the second elementary unit and the second parameter set elementary unit including the second scalability layer identifier value.

Referring now to FIG. 12, the operations performed by an apparatus 50 specifically configured in accordance with another example embodiment of the present invention are illustrated. In this regard, the apparatus may include means, such as the processor 56, the communication interface or the like, for receiving a first scalable data stream that includes scalability layers having different coding properties. Each of the two or more scalability layers may be associated with a scalability layer identifier and may be characterized by a coding property. A first scalability layer identifier value may reside in a first elementary unit that includes data from a first of two or more scalability layers. The first of the two or more scalability layers with a coding property may be signaled in a first parameter set elementary unit such that the coding property is readable by a decoder to determine the coding property without decoding a scalability layer of the scalable data stream. The first scalability layer identifier value may reside in the first parameter set elementary unit. A second scalability layer identifier value may reside in a second elementary unit including data from a second of the two or more scalability layers. The first and second sets of syntax elements may be signaled in a second parameter set elementary unit for the second of the two or more scalability layers such that a first parameter set is readable by the decoder to determine the values of the first and second sets of syntax elements without decoding the scalability layer of the scalable data stream. The second scalability layer identifier value may reside in the second parameter set elementary unit. As shown in block 432, the apparatus of this embodiment may include means, such as the processor, the communications interface or the like, for receiving a set of scalability layer identifier values indicating scalability layers to be decoded. The apparatus of this embodiment may also include means, such as the processor or the like, for removing from the received first scalable data stream the second elementary unit and the second parameter set elementary unit. For example, the second elementary unit and the second parameter set elementary unit may be removed on the basis of the second elementary unit and the second parameter set elementary unit including the second scalability layer identifier value not being among the set of scalability layer identifier values. See Block 434 of FIG. 12.

In the above, the example embodiments have been described with the help of syntax of the bitstream. It needs to be understood, however, that the corresponding structure and/or computer program may reside at the encoder for generating the bitstream and/or at the decoder for decoding the bitstream. Likewise, where the example embodiments have been described with reference to an encoder, it needs to be understood that the resulting bitstream and the decoder have corresponding elements in them. Likewise, where the example embodiments have been described with reference to a decoder, it needs to be understood that the encoder has structure and/or computer program for generating the bitstream to be decoded by the decoder.

In the above, embodiments have been described in relation to a sequence parameter set. It needs to be understood, however, that embodiments could be realized with any type of parameter set, such as video parameter set, picture parameter, GOS parameter set, and adaptation parameter set, and other types of syntax structures, such as SEI NAL units and SEI messages.

Technologies involved in multimedia applications include, among others, media coding, storage and transmission. Media types include speech, audio, image, video, graphics and time text. While video coding is described herein as an exemplary application for the present invention, embodiments of the invention are not limited thereby. Those skilled in the art will recognize that embodiments of the present invention can be used with all media types, not only video.

Although the above examples describe embodiments of the invention operating within a codec within an electronic device, it would be appreciated that embodiments of the invention as described below may be implemented as part of any video codec. Thus, for example, embodiments of the invention may be implemented in a video codec which may implement video coding over fixed or wired communication paths.

Thus, user equipment may comprise a video codec such as those described in embodiments of the invention above. It shall be appreciated that the term user equipment is intended to cover any suitable type of wireless user equipment, such as mobile telephones, portable data processing devices or portable web browsers.

Furthermore elements of a public land mobile network (PLMN) may also comprise video codecs as described above.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatuses, systems, techniques or methods described herein may be implemented in, as non-limiting examples, hardware, software, firmware, special purpose circuits or logic, general purpose hardware or controller or other computing devices, or some combination thereof.

The various embodiments of the invention can be implemented with the help of computer program code that resides in a memory and causes the relevant apparatuses to carry out embodiments of the invention. For example, a terminal device may comprise circuitry and electronics for handling, receiving and transmitting data, computer program code in a memory, and a processor that, when running the computer program code, causes the terminal device to carry out the features of an embodiment. Yet further, a network device may comprise circuitry and electronics for handling, receiving and transmitting data, computer program code in a memory, and a processor that, when running the computer program code, causes the network device to carry out the features of an embodiment.

As noted above, the memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs) and processors based on multi-core processor architecture, as non-limiting examples and as further described above.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys Inc., of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

As described above, FIGS. 10-12 are flowcharts of a method, apparatus and program product according to example embodiments of the invention. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device 58 of an apparatus 50 employing an embodiment of the present invention and executed by a processor 56 in the apparatus. As will be appreciated, any such computer program instructions may be loaded onto a computer or other programmable apparatus (e.g., hardware) to produce a machine, such that the resulting computer or other programmable apparatus embody a mechanism for implementing the functions specified in the flowchart blocks. These computer program instructions may also be stored in a non-transitory computer-readable storage memory (as opposed to a transmission medium such as a carrier wave or electromagnetic signal) that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s). As such, the operations of FIGS. 10-12, when executed, convert a computer or processing circuitry into a particular machine configured to perform an example embodiment of the present invention. Accordingly, the operations of FIGS. 10-12 define an algorithm for configuring a computer or processing circuitry (e.g., processor) to perform an example embodiment. In some cases, a general purpose computer may be configured to perform the functions shown in FIGS. 10-12 (e.g., via configuration of the processor), thereby transforming the general purpose computer into a particular machine configured to perform an example embodiment.

Accordingly, blocks of the flowcharts support combinations of means for performing the specified functions, combinations of operations for performing the specified functions and program instructions for performing the specified functions. It will also be understood that one or more blocks of the flowcharts, and combinations of blocks in the flowcharts, can be implemented by special purpose hardware-based computer systems which perform the specified functions or operations, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method comprising:
producing, with a processor, two or more scalability layers of a scalable data stream, wherein each of said two or more scalability layers has a different coding property, is associated with a scalability layer identifier and is characterized by a first set of syntax elements comprising at least a profile and a second set of syntax elements comprising at least one of a level or hypothetical reference decoder (HRD) parameters;
inserting a first scalability layer identifier value in a first elementary unit including data from a first of two or more scalability layers;
causing the first of said two or more scalability layers to be signaled with said first and second set of syntax elements in a first parameter set elementary unit such that the first parameter set elementary unit is readable by a decoder to determine the values of the first and second set of syntax elements without decoding a scalability layer of said scalable data stream;
inserting the first scalability layer identifier value in the first parameter set elementary unit;
inserting a second scalability layer identifier value in a second elementary unit including data from a second of two or more scalability layers;
causing the second of said two or more scalability layers to be signaled with said first and second set of syntax elements in a second parameter set elementary unit such that the second parameter set elementary unit is readable by the decoder to determine the coding property without decoding the scalability layer of said scalable data stream;
inserting the second scalability layer identifier value in the second parameter set elementary unit,
wherein values of the first set of syntax elements in the first parameter set elementary unit are valid in an instance in which the first elementary unit is processed and the second elementary unit is ignored or removed,
wherein values of the second set of syntax elements in the first parameter set elementary unit are valid in an instance in which the first elementary unit is processed and the second elementary unit is removed,
wherein values of the first set of syntax elements in the second parameter set elementary unit are valid in an instance in which the second elementary unit is processed, and
wherein values of the second set of syntax elements in the second parameter set elementary unit are valid in an instance in which the second elementary unit is ignored or processed.

2. A method according to claim 1 wherein the first and second sets of syntax elements are included in a syntax structure of a highest layer that is present in an access unit, a coded video sequence or a bitstream.

3. A method according to claim 1 wherein the level comprises a level indicator.

4. An apparatus comprising at least one processor and at least one memory including computer program code, the memory and the computer program code configured to, with the at least one processor, cause the apparatus to:
produce two or more scalability layers of a scalable data stream, wherein each of said two or more scalability layers has a different coding property, is associated with a scalability layer identifier and is characterized by a first set of syntax elements comprising at least a profile and a second set of syntax elements comprising at least one of a level or hypothetical reference decoder (HRD) parameters;
insert a first scalability layer identifier value in a first elementary unit including data from a first of two or more scalability layers;
cause the first of said two or more scalability layers to be signaled with said first and second set of syntax elements in a first parameter set elementary unit such that the first parameter set elementary unit is readable by a decoder to determine the values of the first and second set of syntax elements without decoding a scalability layer of said scalable data stream;
insert the first scalability layer identifier value in the first parameter set elementary unit;
insert a second scalability layer identifier value in a second elementary unit including data from a second of two or more scalability layers;
cause the second of said two or more scalability layers to be signaled with said first and second set of syntax elements in a second parameter set elementary unit such that the second parameter set elementary unit is readable by the decoder to determine the coding property without decoding the scalability layer of said scalable data stream;
insert the second scalability layer identifier value in the second parameter set elementary unit,
wherein values of the first set of syntax elements in the first parameter set elementary unit are valid in an instance in which the first elementary unit is processed and the second elementary unit is ignored or removed,
wherein values of the second set of syntax elements in the first parameter set elementary unit are valid in an instance in which the first elementary unit is processed and the second elementary unit is removed,
wherein values of the first set of syntax elements in the second parameter set elementary unit are valid in an instance in which the second elementary unit is processed, and
wherein values of the second set of syntax elements in the second parameter set elementary unit are valid in an instance in which the second elementary unit is ignored or processed.

5. An apparatus according to claim 4 wherein the first and second sets of syntax elements are included in a syntax structure of a highest layer that is present in an access unit, a coded video sequence or a bitstream.

6. An apparatus according to claim 4 wherein the level comprises a level indicator.

7. A method comprising:
receiving a first scalable data stream comprising including scalability layers having different coding properties, wherein
each of said two or more scalability layers is associated with a scalability layer identifier and is characterized by a first set of syntax elements comprising at least a profile and a second set of syntax elements comprising at least one of a level or hypothetical reference decoder (HRD) parameters;
a first scalability layer identifier value residing in a first elementary unit including data from a first of two or more scalability layers;
the first and second set of syntax elements being signaled in a first parameter set elementary unit for the first of said two or more scalability layers such that a first parameter set is readable by a decoder to determine the values of the first and second set of syntax elements without decoding a scalability layer of said scalable data stream;
the first scalability layer identifier value residing in the first parameter set elementary unit;
a second scalability layer identifier value residing in a second elementary unit including data from a second of two or more scalability layers;
the first and second set of syntax elements being signaled in a second parameter set elementary unit for the second of said two or more scalability layers such that a second parameter set is readable by the decoder to determine the coding property without decoding the scalability layer of said scalable data stream;
the second scalability layer identifier value residing in the second parameter set elementary unit; and
removing, with a processor, from the received first scalable data stream the second elementary unit and the second parameter set elementary unit on the basis of the second elementary unit and the second parameter set elementary unit including the second scalability layer identifier value.

8. A method according to claim 7 wherein the first and second sets of syntax elements are included in a syntax structure of a highest layer that is present in an access unit, a coded video sequence or a bitstream.

9. A method according to claim 7 wherein the level comprises a level indicator.

10. An apparatus comprising at least one processor and at least one memory including computer program code, the memory and the computer program code configured to, with the at least one processor, cause the apparatus to:
receive a first scalable data stream comprising including scalability layers having different coding properties, wherein
each of said two or more scalability layers is associated with a scalability layer identifier and is characterized by a first set of syntax elements comprising at least a profile and a second set of syntax elements comprising at least one of a level or hypothetical reference decoder (HRD) parameters;
a first scalability layer identifier value residing in a first elementary unit including data from a first of two or more scalability layers;
the first and second set of syntax elements being signaled in a first parameter set elementary unit for the first of said two or more scalability layers such that a first parameter set is readable by a decoder to determine the values of the first and second set of syntax elements without decoding a scalability layer of said scalable data stream;
the first scalability layer identifier value residing in the first parameter set elementary unit;
a second scalability layer identifier value residing in a second elementary unit including data from a second of two or more scalability layers;
the first and second set of syntax elements being signaled in a second parameter set elementary unit for the second of said two or more scalability layers such that a second parameter set is readable by the decoder to determine the coding property without decoding the scalability layer of said scalable data stream;
the second scalability layer identifier value residing in the second parameter set elementary unit; and
remove from the received first scalable data stream the second elementary unit and the second parameter set elementary unit on the basis of the second elementary unit and the second parameter set elementary unit including the second scalability layer identifier value.

11. An apparatus according to claim 10 wherein the first and second sets of syntax elements are included in a syntax structure of a highest layer that is present in an access unit, a coded video sequence or a bitstream.

12. An apparatus according to claim 10 wherein the level comprises a level indicator.

13. A method comprising:
receiving a first scalable data stream including scalability layers having different coding properties, wherein
each of said two or more scalability layers is associated with a scalability layer identifier and is characterized by a coding property;
a first scalability layer identifier value residing in a first elementary unit including data from a first of two or more scalability layers;
the first of said two or more scalability layers with said coding property being signaled in a first parameter set elementary unit such that the coding property is readable by a decoder to determine the coding property without decoding a scalability layer of said scalable data stream;
the first scalability layer identifier value residing in the first parameter set elementary unit;
a second scalability layer identifier value residing in a second elementary unit including data from a second of two or more scalability layers;
the first and second sets of syntax elements being signaled in a second parameter set elementary unit for the second of said two or more scalability layers such that a first parameter set is readable by the decoder to determine the values of the first and second sets of syntax elements without decoding a scalability layer of said scalable data stream;
the second scalability layer identifier value residing in the second parameter set elementary unit;
receiving a set of scalability layer identifier values indicating scalability layers to be decoded, and
removing from the received first scalable data stream, with the processor, the second elementary unit and the second parameter set elementary unit on the basis of the second elementary unit and the second parameter set elementary unit including the second scalability layer identifier value not being among the set of scalability layer identifier values.

14. A method according to claim 13 wherein the first set of syntax elements comprises at least a profile and the second set of syntax elements comprises at least one of a level or hypothetical reference decoder (HRD) parameters

15. A method according to claim 14 wherein the level comprises a level indicator.

16. A method according to claim 13 wherein the first and second sets of syntax elements are included in a syntax structure of a highest layer that is present in an access unit, a coded video sequence or a bitstream.

17. An apparatus comprising at least one processor and at least one memory including computer program code, the memory and the computer program code configured to, with the at least one processor, cause the apparatus to:
receive a first scalable data stream including scalability layers having different coding properties, wherein
each of said two or more scalability layers is associated with a scalability layer identifier and is characterized by a coding property;
a first scalability layer identifier value residing in a first elementary unit including data from a first of two or more scalability layers;
the first of said two or more scalability layers with said coding property being signaled in a first parameter set elementary unit such that the coding property is readable by a decoder to determine the coding property without decoding a scalability layer of said scalable data stream;
the first scalability layer identifier value residing in the first parameter set elementary unit;
a second scalability layer identifier value residing in a second elementary unit including data from a second of two or more scalability layers;
the first and second sets of syntax elements being signaled in a second parameter set elementary unit for the second of said two or more scalability layers such that a first parameter set is readable by the decoder to determine the values of the first and second sets of syntax elements without decoding a scalability layer of said scalable data stream;
the second scalability layer identifier value residing in the second parameter set elementary unit;
receive a set of scalability layer identifier values indicating scalability layers to be decoded, and
remove from the received first scalable data stream the second elementary unit and the second parameter set elementary unit on the basis of the second elementary unit and the second parameter set elementary unit including the second scalability layer identifier value not being among the set of scalability layer identifier values.

18. An apparatus according to claim 17 wherein the first set of syntax elements comprises at least a profile and the second set of syntax elements comprises at least one of a level or hypothetical reference decoder (HRD) parameters

19. An apparatus according to claim 18 wherein the level comprises a level indicator.

20. An apparatus according to claim 17 wherein the first and second sets of syntax elements are included in a syntax structure of a highest layer that is present in an access unit, a coded video sequence or a bitstream.
